(19) United States
(12) Patent Application Publication
(10) Pub. No.: US 2009/0144157 A1
(43) Pub. Date: Jun. 4, 2009

(54) DYNAMIC DIGITAL SIGNAGE, CUSTOMER CONTENT CONTROL PORTAL & MANAGEMENT SYSTEM

(76) Inventors: Charles T. Saracino, South Hackensack, NJ (US); Ken Makow, South Hackensack, NJ (US)

Correspondence Address: WINSTON & STRAWN LLP;PATENT DEPARTMENT, 1700 K STREET, N.W., WASHINGTON, DC, 20006, US

(21) Appl. No.: 12/326,034

(22) Filed: Dec. 1, 2008

Related U.S. Application Data
(60) Provisional application No. 60/991,648, filed on Nov. 30, 2007.

(51) Int. Cl. G06Q 30/00; H04L 9/32

(52) U.S. Cl. 705/14; 726/4

(57) ABSTRACT

A system, apparatus, method, and media are directed to digital signage. Digital signage types are grouped into a digital signage channel. A template for the digital signage channel is received. The network comprises a network channel associated with the digital signage channel. A creation interface configured to create a new digital signage message based on the template is provided. A new digital signage message provides a definition for a display of a view of the new digital sign. The definition is adapted to map elements of the view to a plurality of data structure types for storing the new digital signage message. An approval interface configured to approve the new digital signage message based on a limited representational view of the new digital signage message is provided. A renderable instance of the approved new digital signage is provided for display on a interactivity limited digital signage device.

### CROSS-REFERENCE TO RELATED APPLICATIONS

This application claims the benefit of U.S. Provisional Patent Application No. 60/991,648 filed Nov. 30, 2007 entitled “Dynamic Digital Signage, Customer Content Control Portal & Management System” which is incorporated in its entirety by reference as if fully set forth herein.

### COPYRIGHT NOTICE

The present application includes material that is subject to copyright protection. The copyright owner does not object to the facsimile reproduction of the application by any person as the application appears in the records of the U.S. Patent and Trademark Office, but otherwise reserves all rights in the copyright.

### BACKGROUND

Digital signage is a form of advertising or information distribution that typically involves the use of an electronic display and allows users to modify the signage in the display device without modifying the physical signage. Users of digital signage seek to deliver targeted messages to specific locations at specific times or to control the display, content, and distribution of the content of digital signage. The display devices in digital signage systems can be LCD or plasma displays, projection screens, scrolling message boards, or other displays that can be controlled electronically using for example a computer.

An important logistical concern with digital signage is how to set and update the content to be displayed. One known method is to integrate a media player with the digital sign; content scheduling and playback can then be achieved by looped playback of digital media, such as content in AVI or MPEG-2 formats, from the media player to the display device. The difficulty with this method is that it requires the digital content to be stored on some media, such as a DVD- or CD-ROM, which needs to be manually inserted into the media player associated with each digital signage. This makes dynamic updates and changes very difficult.

Another known method is to network the digital signage such that digital content can be easily pushed or pulled from a central location. For example, a collection of networked digital signage could be connected to a central server computer, which can automatically change the digital signage content according to specific business logic. While this method offers many benefits, it is nonetheless dependent on the background business logic that controls the updating of the digital content. Known existing digital signage equipment and associated design tools are typically complicated software applications that are directed to individual clients to buy a license to the software application to serve that company's signage (e.g., signage in a company building). As stated, typically the software is complicated and companies find it difficult to use internally for their employees or for advertising and therefore, they were typically forced to hire information technology professionals and advanced “tech savvy” design/development professionals to run the signage application. As such, often times, the software created an additional overhead for the company.

### SUMMARY OF THE INVENTION

According to features of the invention, a simplified/intuitive GUI application via an Internet browser is provided where customers to the signage service can login to their account to gain access to the application. Users can choose pre-designed templates or editable templates to configure signage, download content, or establish timing of notices easily through the interface. The fixed signage equipment in an office building would then automatically be updated with the content.

A system is directed to managing a plurality of digital signage over a network. The system may include a computer component for grouping a plurality of digital signage types into at least one of a plurality of digital signage channels; a computer component for generating at least one template for at least one of the digital signage channels; a computer component for creating over the network a new digital signage message for a portion of at least a selected one of the templates, wherein the templates provide a separation between a view and a model of the new digital sign; a computer component for approving over the network the new digital signage message based on a limited representational view of the new digital signage message; and a computer component for selectively providing, over a network channel, a first renderable or rendered instance of the approved new digital signage in a first rendering format to a first digital signage device configured to display the first rendering format, and a second renderable or rendered instance in a second rendering format to a second digital signage device configured to display the second rendering format. The template can include a read-only portion that is uneditable by a user and a dynamic portion that is editable by the user based on the permission for the user, wherein the permission comprises a portion-level, template-level, playlist-level, channel-level, or customer-level permission. The view can be configured to be in a plurality of rendering formats.

The system may also include a computer component for overriding a display of a plurality of digital signage messages associated with a different template than the selected one of the templates with the new digital signage message. The new digital signage message can include an emergency message. Creating the emergency message may disable an approval requirement for the emergency message.

The component for creating can be further configured to define the portion of the selected template to deliver a graphical representation of a data stream comprising at least one of a database table, a news feed, or a weather forecast. The system may also include a computer component for providing a statistic of a proof of play of messages over the digital signage channels; a computer component for receiving a second limited representational view of a playing signage on the digital signage devices; and a computer component for determining an advertising cost for displaying an advertising message as the new digital signage message based on the proof of play and/or the second limited representational view. The computer component for creating can be further configured to restrict access of a sub-administrator to the channel; and the computer component for approving is further configured to limit access to the approval interface to the main administrator.

A computer implemented method is directed to managing a plurality of digital signage over a network. The method may include receiving a template for a digital signage channel, wherein the template is one of a plurality of digital signage types, wherein the network comprises at least one network channel associated with the digital signage channel; providing, over the network, a creation interface configured to create a new digital signage message based on the template, wherein the new digital signage message provides a definition for a display of a view of the new digital sign, and wherein the definition is adapted to map elements of the view to a plurality of data structure types for storing the new digital signage message, wherein the message comprises at least one of text content, movie content, or data stream content; providing, over the network, an approval interface configured to approve the new digital signage message based on a limited representational view of the new digital signage message; and selectively providing, over the network channel, a renderable or rendered instance of the approved new digital signage message for display on a interactivity limited digital signage device. The renderable or rendered instance can be based on applying the definition to the new digital signage message. The limited representational view of the new digital signage message comprises a thumbnail of the new digital signage message.

The method may also include receiving a play time for the new digital message, wherein the play time determines a slot position in a playlist for the new digital message or a duration of playing the new digital message. The template can be configured to provide a model-view-control for a message of at least one of the plurality of digital signage types. The creation interface can include at least one of a web interface or an application programming interface, and wherein the approval interface comprises at least one of a web interface or an application programming interface. The method may also include granting access of a sub-administrator to create a message using the creation interface to the channel; and granting access to the approval interface to the main administrator. The sub-administrator can be further granted access to managing messages for at least one of a customer, a template, or a message.

The method can also include grouping the plurality of digital signage types into the digital signage channel based on a similarity in an attribute of at least one of the grouped digital signage types, wherein the similarity in the attribute comprises a similarity in at least one of: a content type of the grouped digital signage types, an importance of the grouped digital signage types, a designated geographical location of the grouped digital signage types, or a company type of the grouped digital signage types. The method can also include scheduling the display of the approved instance of the new digital signage based on a playlist that specifies the order or length of time of a displayed message. The approval interface can be configured to perform actions comprising providing a plurality of new digital signage messages for the channel, wherein the plurality of new digital signage messages are created by a plurality of sub-administrators; and receiving an approval for a subset of the plurality of the new digital signage messages.

An apparatus is directed to managing a plurality of digital signage comprising a processor configured to perform actions. The actions may include determining a template for the digital signage channel comprising a plurality of digital signage types; creating a new digital signage message based on the template, wherein the new digital signage message provides a definition for a display of a view of the new digital sign, and wherein the definition is independent of a data structure and type of the new digital signage message; and if the new digital signage message is approved, displaying, over a network channel associated with the digital signage channel, the new digital signage based on the definition.

The actions may further include providing the new digital signage on a plurality of digital signage client devices. The data structure and type include at least one of: a markup language structure and type, a portable document format (PDF) structure and type, or a structure and type configured for a text-editing program. The network channel can include at least two of a network protocol, network address, domain name, browser type, operating system type, virtual subnet type, or security protocol.

A computer-readable media comprising instructions that are executable by a processor to perform the steps of the processes described herein.

A method is directed to managing content in a digital signage system composed of a plurality of digital signage. The method can comprise grouping one or more digital signage types into a channel; creating a plurality of templates for the channel, where each template represents a specific type of digital signage message; designating a plurality of sub-administrators for the channel; designating a main administrator for the channel; allowing the sub-administrators to create a plurality of new digital signage messages by using the templates; generating an update message for each new digital signage message created and sending said update message to the main administrator; instructing the main administrator to approve or reject the new digital messages; and displaying each approved new digital message on the digital signage in the channel.

### BRIEF DESCRIPTION OF THE DRAWINGS

Features of embodiments of the invention, its nature, and various advantages will be apparent from the following detailed description, taken in conjunction with the accompanying drawings in which:

FIGS. 1A-1C show system diagrams of devices for providing digital signage services in accordance with some embodiments of the invention;

FIGS. 2A-2B show block diagrams for devices for providing digital signage services in accordance with some embodiments of the invention;

FIGS. 3-5, 6A, 6B shows logical flow diagrams for providing digital signage services in accordance with some embodiments of the invention;

FIGS. 7A-7H show examples of data models for managing a digital signage system in accordance with some embodiments of the invention; and

FIGS. 8A-8D, 9A-9H, 10A-10M, 11A-11AG, 12A-12L, 13A-13F, and 14A-14D, 15A-15D show user interfaces embodying or implementing a process for managing a digital signage system in accordance with some embodiments of the invention.

### DETAILED DESCRIPTION OF THE PREFERRED EMBODIMENTS

Systems and methods are illustratively described that permit the dynamic and distributed updating of content in digital signage systems by non-technical customers. Customers may be such as users representing an organization. In this system, one or more digital signage types can be grouped together as a “channel.” The customer can then assign a primary administrator (“CPA”) to manage the channel. The management functionality may be provided through an easy-to-use web application which enables the CPA to update its digital signage content. The web application can be run locally over the customer's network, or as a website on the Internet which customers can access via web browsers.

The CPA can manage one or more channels and update messages within “templates” that facilitate the creation of new digital signage content. Templates are based on model-view-controller (“MVC”) principles, which is an architectural pattern used in complex systems that present a large amount of data to the user. Using MVC patterns, a developer can separate data (or model) and user interface (or view) concerns, so that changes to the user interface will not affect data handling. This allows users to reorganize the data without changing the user interface.

In the digital signage context, each template/message would represent a view. For example, one template could be an “Important Message” view that is designed to display important messages. This template could include an image of an exclamation mark, signifying to the reader that the message is important. The actual content (the data) would be different from message to message. The template would thus allow users to easily and quickly create new “Important Messages” based on a standard format.

To allow multiple individuals to create new messages in a distributed manner, the CPA and/or customer can designate additional sub-administrators (“CSA”s) who will be authorized to use one or more dynamic and editable templates. For example, a CSA could be assigned the task of creating and updating “Important Messages” and “Parking Messages,” while another CSA could be assigned the task of creating and updating “CEO Messages” and “Emergency Messages.” Each of these message types will have an associated template, managed by the CPA, which the CSA can select. The CSA can then create a new signage from the template by entering a new message or modifying an existing message. The web application can also provide editing tools, such as changing fonts, size, color, and bold, which allow the CSA to customize each message. The CSA can also upload an image or other content, such as GIF, JPEG, PDF and PPT files, whose content can be displayed inline with the message.

Administrators can be assigned in a multi-dimensional manner. In the above example, administrators are assigned by message type. In other situations, however, administrators may also need to be assigned by location. Thus, administrators could be assigned along these two dimensions, such that an administrator, for example, could be tasked to manage all emergency messages for all digital signage located in New York for a specific channel. This multi-dimensional control and management functionality becomes more important as the number of digital signage within a channel grows. Without such a feature, managing all the disparate signage, templates, and messages within one channel would become extremely difficult. Other dimensions along with administrative roles can be assigned include organization levels (such as the sales department, the customer support division, etc.), geography, compliance, time, etc.

The workflow between CPAs and CSAs can be optimized. The optimization helps resolve conflicts that could arise with multiple CSAs all making frequent updates and changes. For example, one CSA could create a new Important Message stating that the building is closed due to snow conditions while another CSA could create an Emergency Message with the same message. Such conflicts can be resolved by the managing CPA. To enable the CPA to easily resolve such conflicts, a screen shot/screen grab of each pending message can be provided to the CPA. This can be an image file, for example, that can be attached to an automated email. The CPA can then easily review each CSA message and approve or reject them as appropriate. With this preview functionality, CPAs can easily review, edit, and approve new content, leading finally to the “publish” option for the channel owner.

With the above features, a customer's channel could become extremely dynamic as new messages are constantly created and updated by the CPA and CSAs. To easily schedule these various messages for display, the CPA or any assigned CSAs can create “playlists” that specify the order in which approved messages will be displayed, the length of time each message will be shown, and other similar instructions. Playlists can be created and managed through an html form, Flash application, Java applet, Javascript code, or other similar types of user interface methods.

The administrative web application can be further extended to allow administrators to manage the overall system across multiple channels and customers. For example, the digital signage system can designate primary system administrators (“PSA”) who can be in charge of all channels and customers. The PSAs can in turn designate multiple sub-administrators (“SSA”) who can be assigned specific customers, channels, templates and messages to manage. In managing channels, PSAs and SSAs can manage access to channels, the content uploaded to a channel, and the up-to-date status information on each digital signage in the channel. Administrators can also be given the ability to create global emergency messages that can be broadcast over the entire digital signage network.

Further by way of example, the content owner or the owner of the signage would obtain the services of a third party signage service provider to use the third party's signage management and control capability to manage their signage and the content therein. The third party signage service provider would for example have servers running on the Internet having storage capacity for serving various clients that wish to control signage (their company's signage using the third party service, e.g., a courthouse, a hospital, a company office complex, etc.) such as by configuring and pushing content to the signage. The servers of the third party service provider could store objects and configuration from client such as by using the browser interface, which clients would have to login to authorize and authenticate the management and control of the signage by the client within the interface. The service provider would store content and configuration information and would update signage of clients according to the content and configuration stored by that client. The signage could be updated “live” such as in real time in close correspondence to when the information is inputted.

In one embodiment, an application programming interface (“API”) is provided which exposes the system's processes to different third party software and hardware components. The API is an interface that the invention provides to support requests for the digital signage and content management services by other computer programs and digital signage hardware. The API essentially functions as a middle-tier that allows it to be used in combination with a variety of other components. For example, a digital signage hardware provider can use the API to layer the content management services on top of its currently existing hardware infrastructure because the API can interface with a variety of hardware components such as different media players, digital signage, etc. The API can also be used by other software components to incorporate the processes. For example, a third party software component could include image editing functionality for digital signage, but lacks content management functionality of the current invention. This software can thus beneficially use the API to access and incorporate these content management functions into its own software to produce a unique combination of features.

The hardware player can be connected to each digital signage monitor; the hardware player can be monitored and the images that it displays can be captured. These captured images can be streamed for administrators to provide real-time information on the status of each digital signage in the channel. This real-time information enables administrators to quickly identify hardware failures, signage content errors, incorrect configurations, and other similar problems that may be otherwise difficult to identify given a multitude of digital signage within a single channel. For example, even though access to each digital signage and the system in general can be restricted and password protected, it is nevertheless possible for hackers or intruders to improperly infiltrate the system and display content that the channel owners did not authorize. The real-time streaming information of each digital signage could be used to easily spot these problems such that the prohibited content can be quickly removed.

Real-time information for administrator monitoring can also include other information on the hardware such as the players and digital signage. For example, alerts can be provided if a player or display is malfunctioning, or if a player is missing content to display for any period of time. Other alerts can include power, volume, or other similar items. This status information and “health” indicators can help administrators manage channels with many different pieces of hardware and equipment.

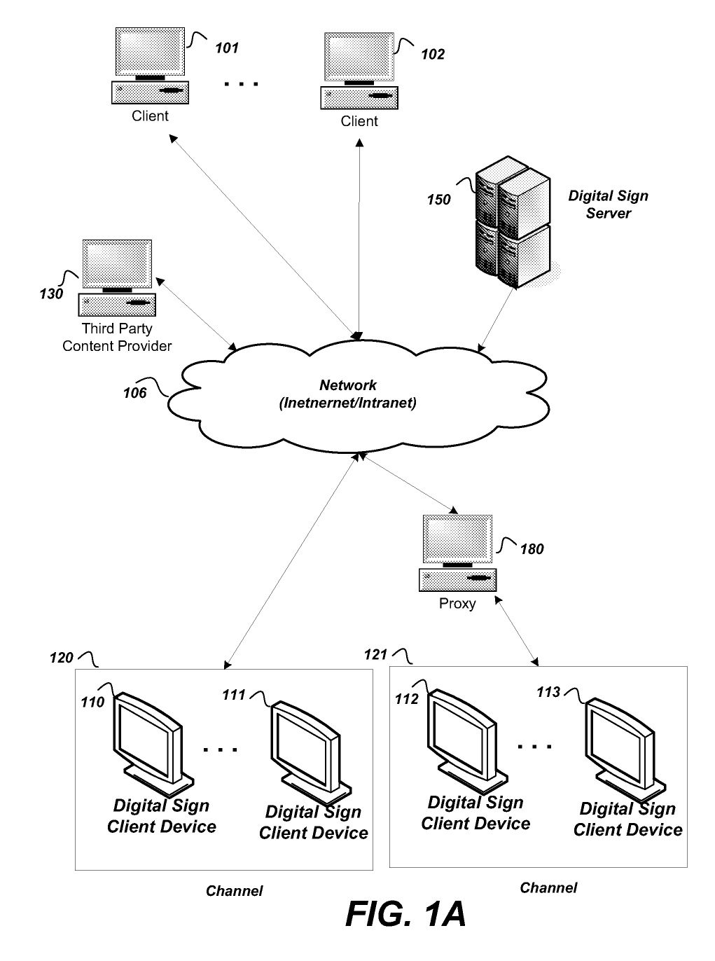

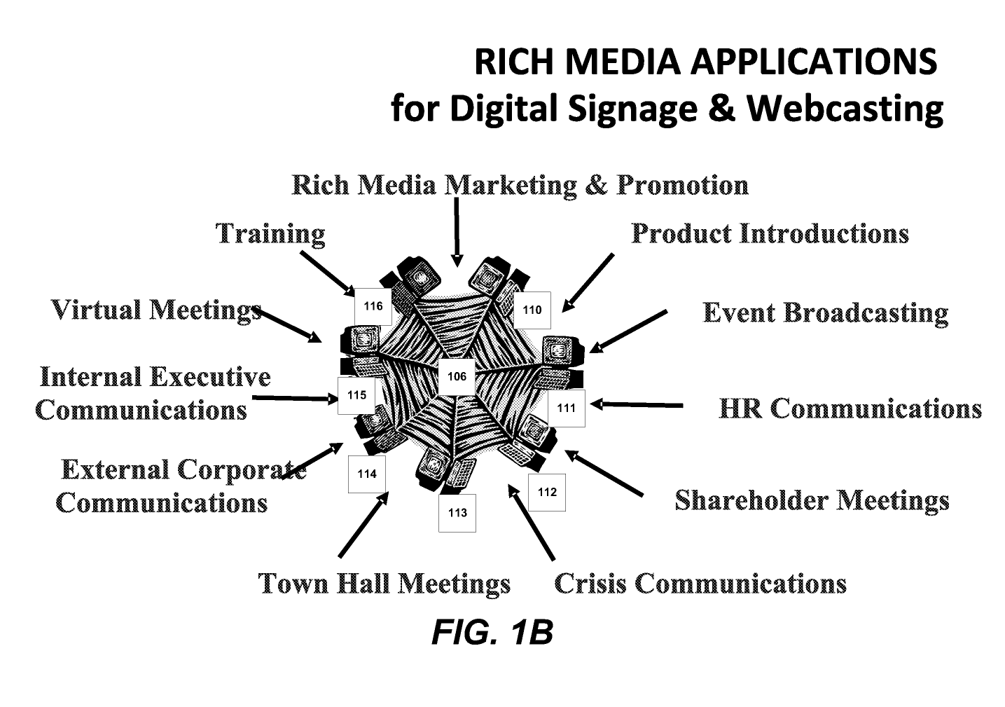

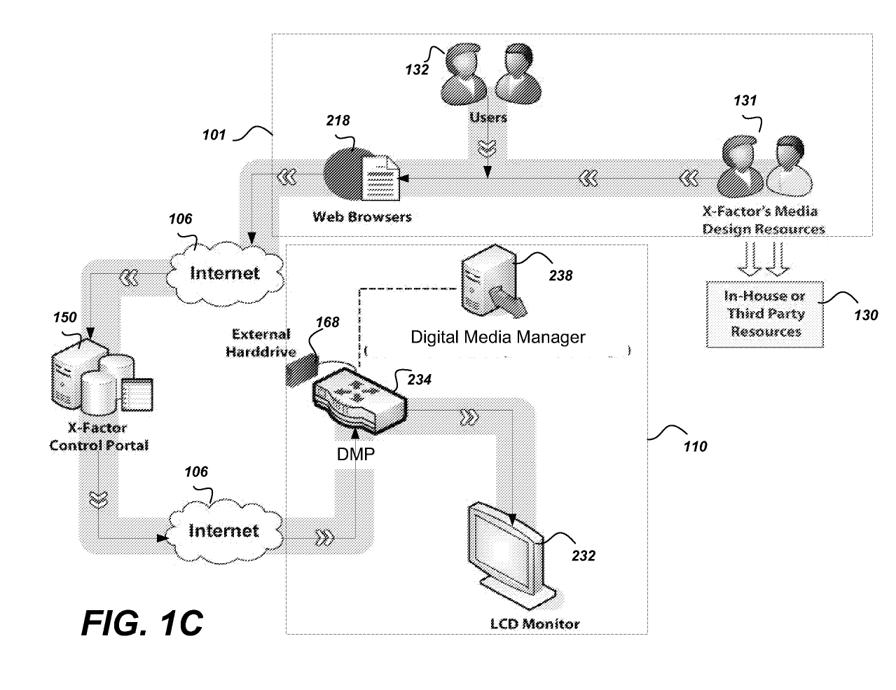

FIG. 1A shows a system diagram of devices for providing digital signage services. As shown, client device 101-102, digital signage server (control portal) 150, third party content provider 130, and digital signage client device 110-113 are in communication via network 106. Network 105 may be an LAN, WAN, intranet, or even the Internet. Digital signage client devices 110-111 are grouped together and are configured to deliver digital signage messages for a channel 120. Digital signage client devices 112-113 are grouped together and are configured to deliver digital signage messages for a channel 121. Other channels and/or devices may also be included without departing from the scope of the invention. Digital signage client devices 112-113 may be general purpose computing devices configured to receive input from keyboard or control to interact with the signage, or the devices can be interactivity limited digital devices that are configured to receive a limited range of commands (e.g., display, repeat display, display at particular times, etc.), and/or include dedicated hardware for displaying graphics and providing sound. Digital signage are typically standalone monitors positioned for viewing in high traffic areas or areas of congregation to provide information to all passers by. Signage is generally a passive device to viewers or its audience, but it may provide interactivity to administrators, technicians, or operators who can gain access to interact with the signage equipment through locked cabinets, passwords, or other protection against the public or viewers. If desired, in some embodiments, some level of interactivity may, for example, be included in the signage equipment or combined with passive signage on the equipment. For example, there can also be an externally available keyboard or control provided to the viewers to be able to interact or control the sign.

A plurality of digital signage types may be grouped using client devices 101-102 into at least one of a plurality of digital signage channels. A channel may be associated with an organization (worldwide, nationwide, regional, office based, building based, or even room based). The channels' definitions may be stored via digital signage server 150. Digital signage server 150 may also receive a template for a digital signage channel. The network 106 can comprise at least one network channel associated with the digital signage channel.

Digital signage server 150 may provide, over the network 106, to for example, client devices 101-102, a creation interface configured to create a new digital signage message based on the template. A new digital signage message can provide a definition for a display of a view of the new digital sign, wherein the definition is adapted to map elements of the view to a plurality of data structure types for storing the new digital signage message. In other words, the definition may define a model-view-control (MVC) that creates an abstraction between model or data, view/display, and/or any control of the view. In one embodiment, there may be no control. For example, a digital signage may be display-only and may receive no input or disable input that can control its operation. In other embodiments, there may be a control. For example, the digital signage display can be connected to a PC that would have a keyboard (e.g., in a nearby closet or remote location).

Third party content provider 130 may include data sources, including databases, streaming data, real-time data, geo-location data, news feeds, or the like. The data may be sent over network 106 and combined by digital signage server 150 and/or client devices 101-102 with the new digital signage message (and associated template). The combined new digital signage message may be rendered in client devices 101-102 such that the data may be updated in real-time or close to real-time (e.g., once every cycle of a message appearing such as once every hour(s), minute(s), second(s), etc.).

The digital signage server 150 may provide, over the network 106, to client devices 101-102, an approval interface configured to approve the new digital signage message based on a limited representational view of the new digital signage message. The limited representational view may be a thumbnail of the new message displayed on client devices 101-102. In one embodiment, a plurality of thumbnails may be generated for a template and/or a populated template (a message). The thumbnails may have low resolution, medium, or high enough resolution. A user may click on a lower resolution thumbnail to bring up a higher resolution thumbnail.

Digital signage server 150 selects whether to provide the approved instance based on whether the instance is approved, permission level of the user approving the instance, audits of the organization (whether accounts payments are up to date, etc.) and/or networking condition. If selected to be provided, digital signage server 150 provides, over the network channel, a renderable or rendered instance of the approved new digital signage message for display on an client device or a interactivity limited digital signage device such as at least one of client devices 110-113, the approved instance based on the definition. The approved instance may be sent to devices based on a channel definition. For example, a channel for a particular building 1 is sent to channel 120, wherein the devices 110-111 may be located at building 1.

A digital signage message may be sent through a proxy server 180, and proxy server 180 may send the message to at least one digital signage client devices. In one embodiment, the message may be converted into a renderable instance by proxy server 180.

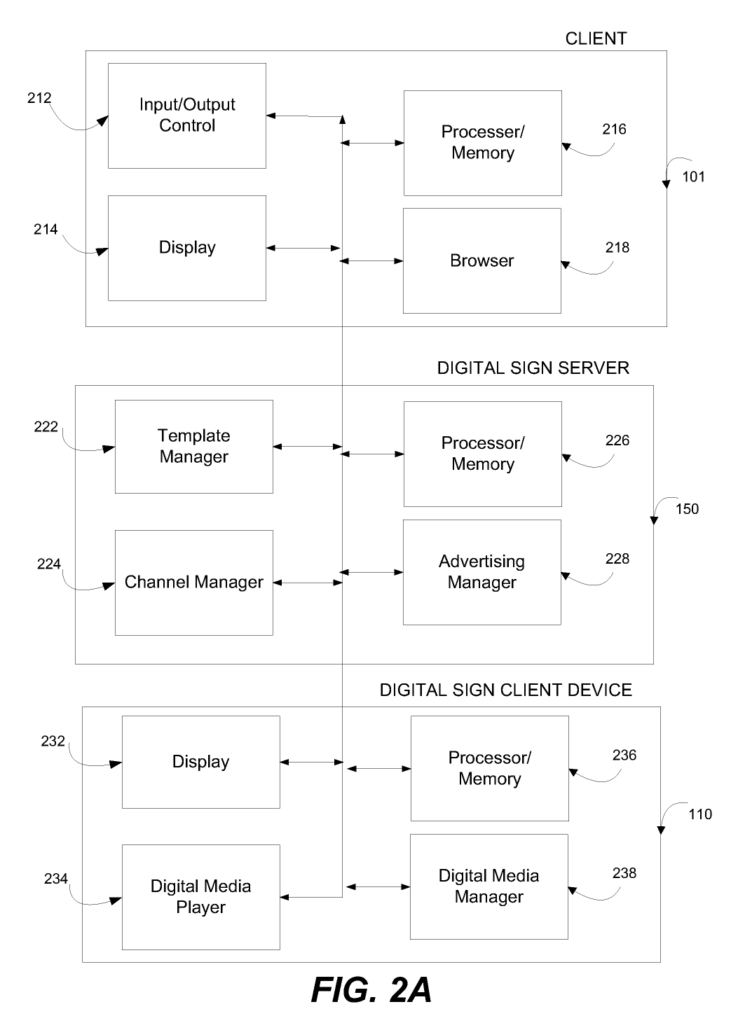

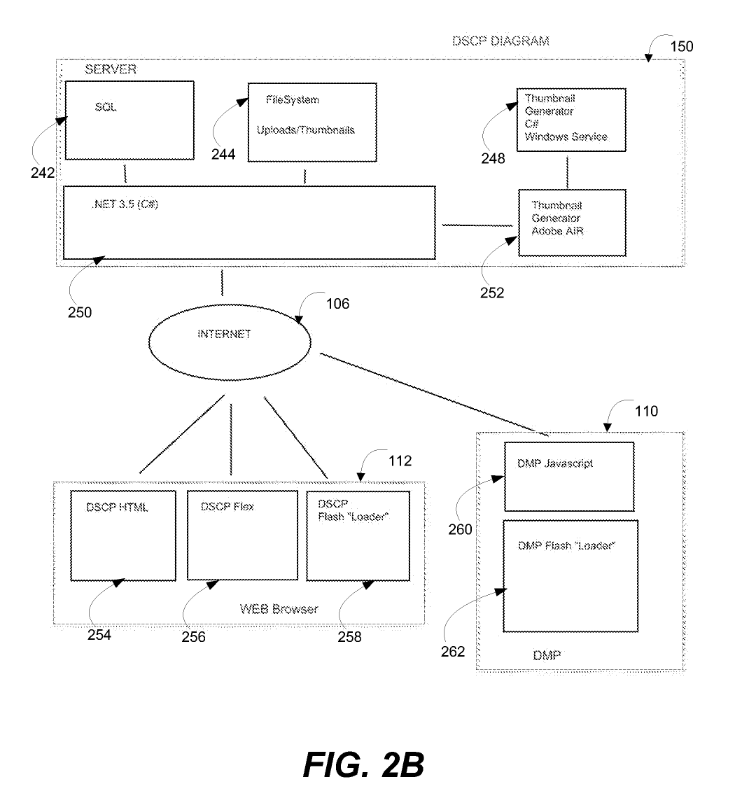

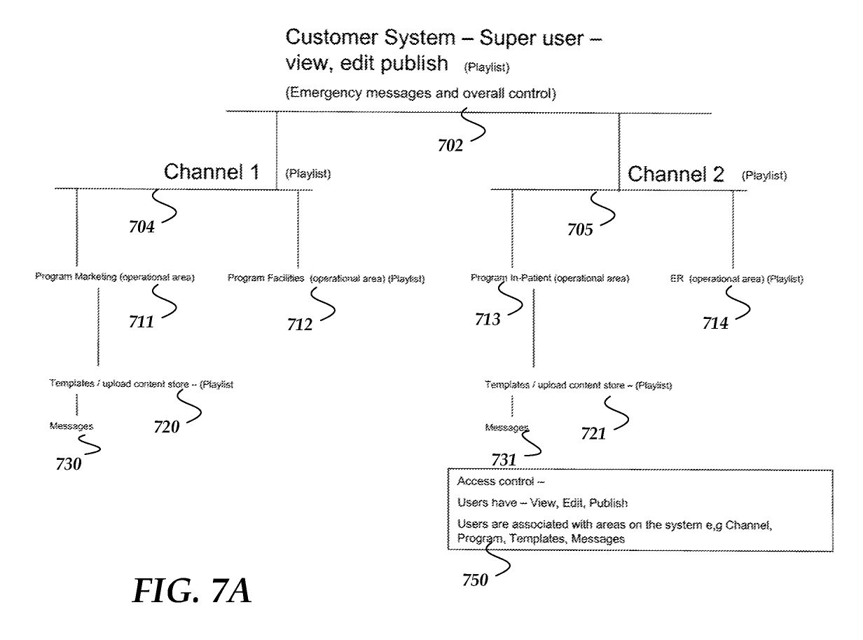

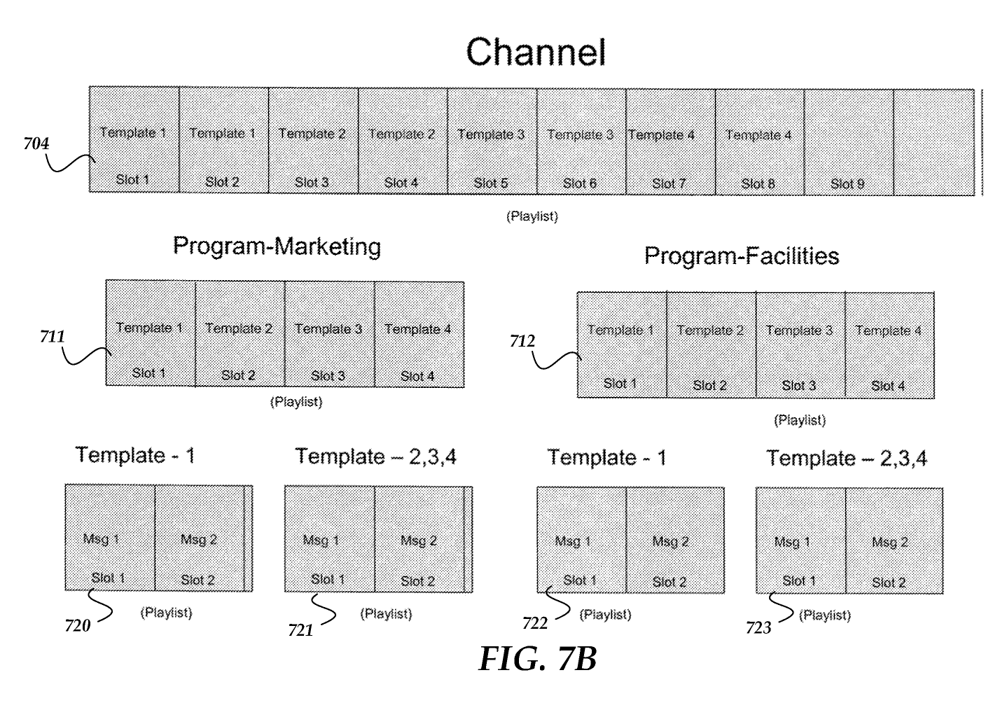

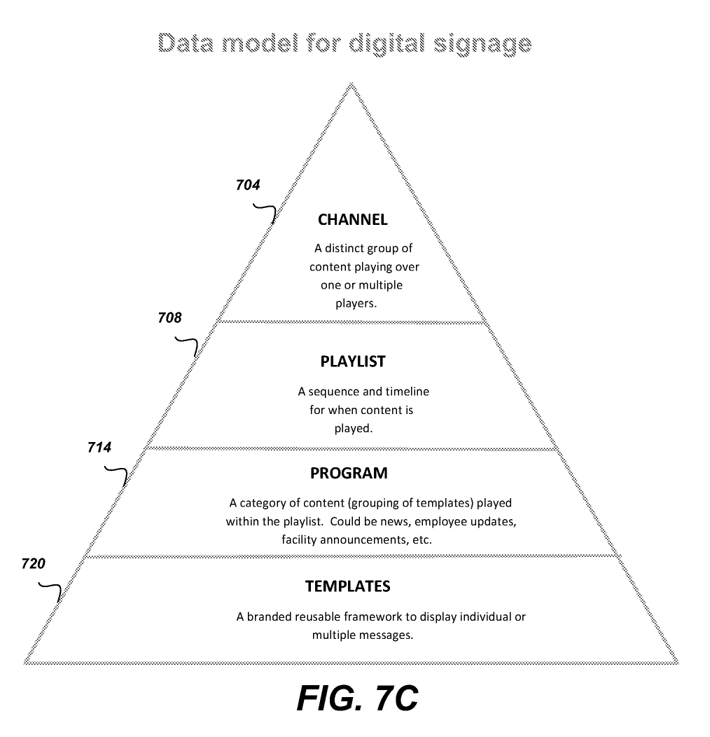

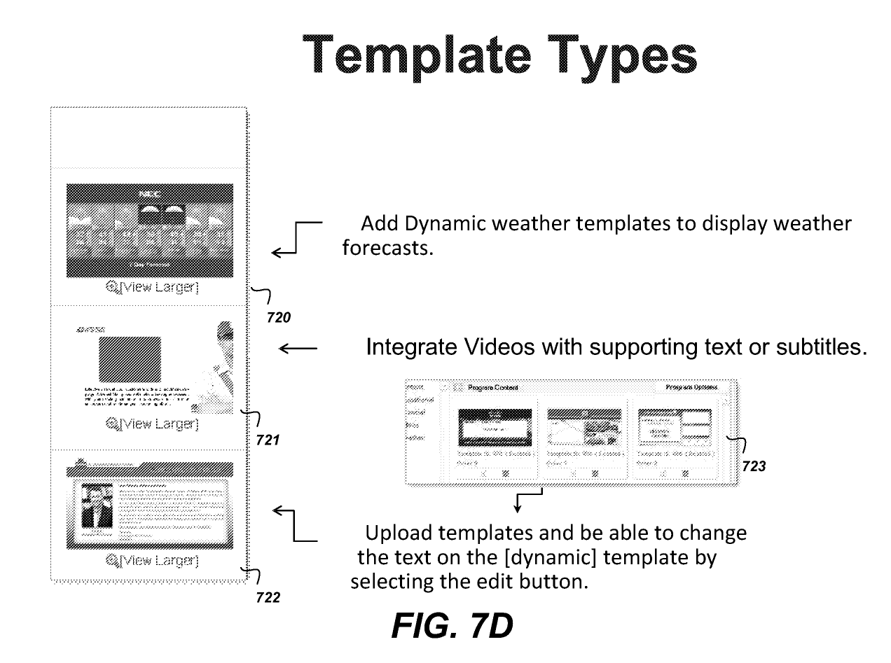

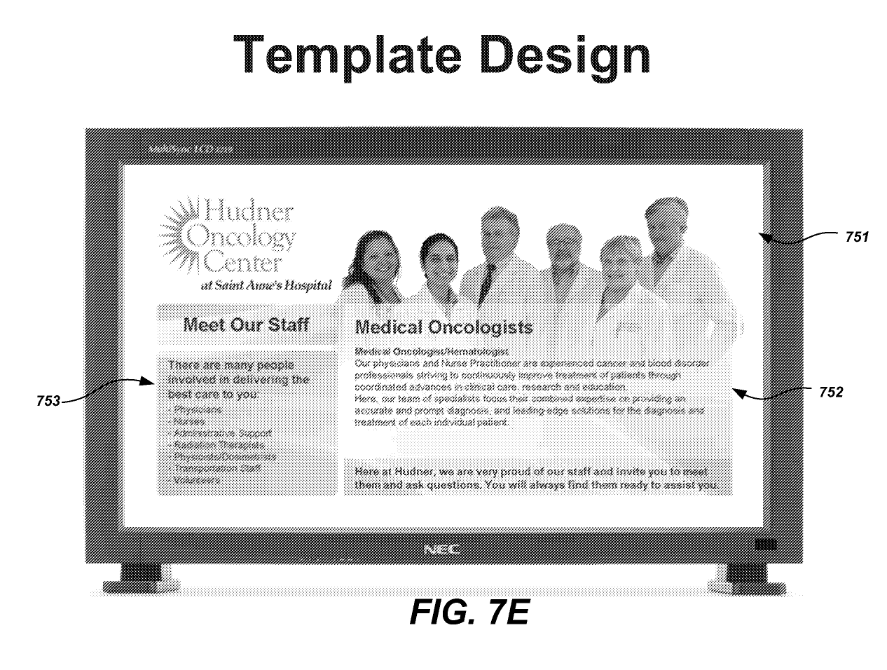

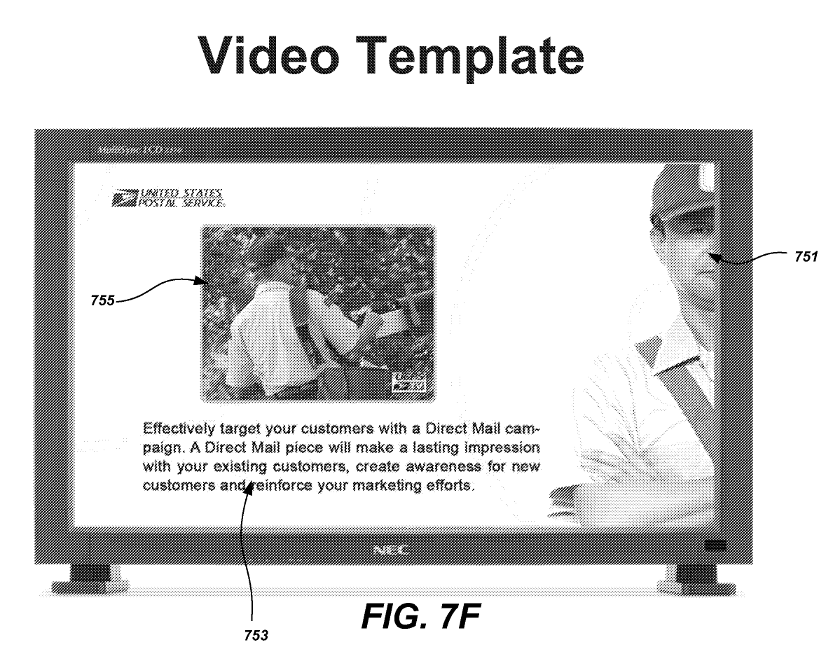

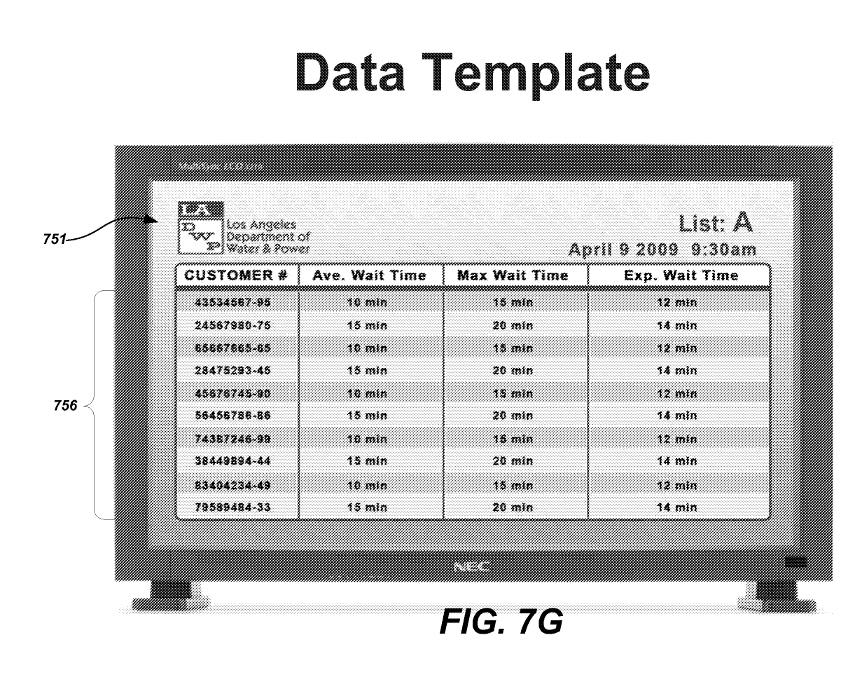

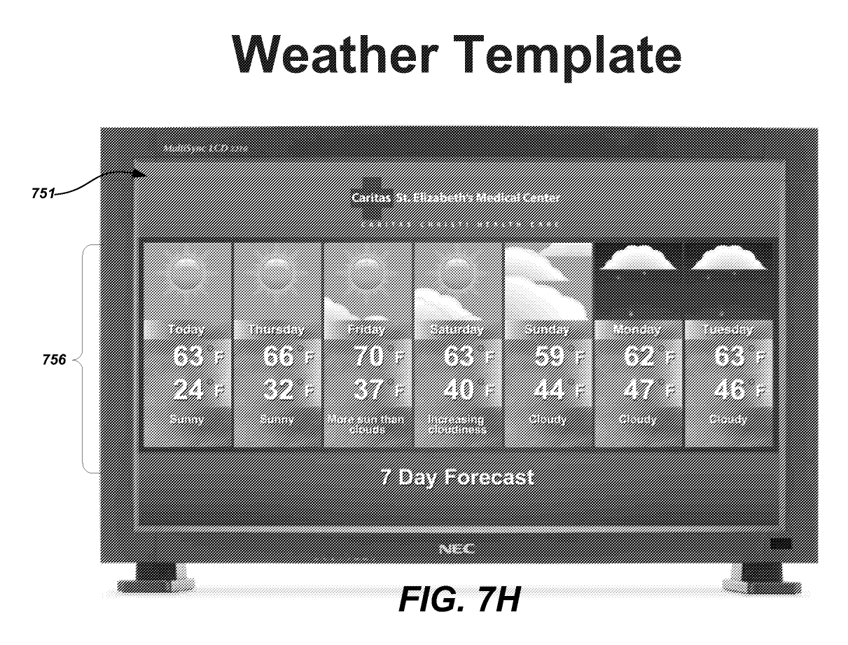

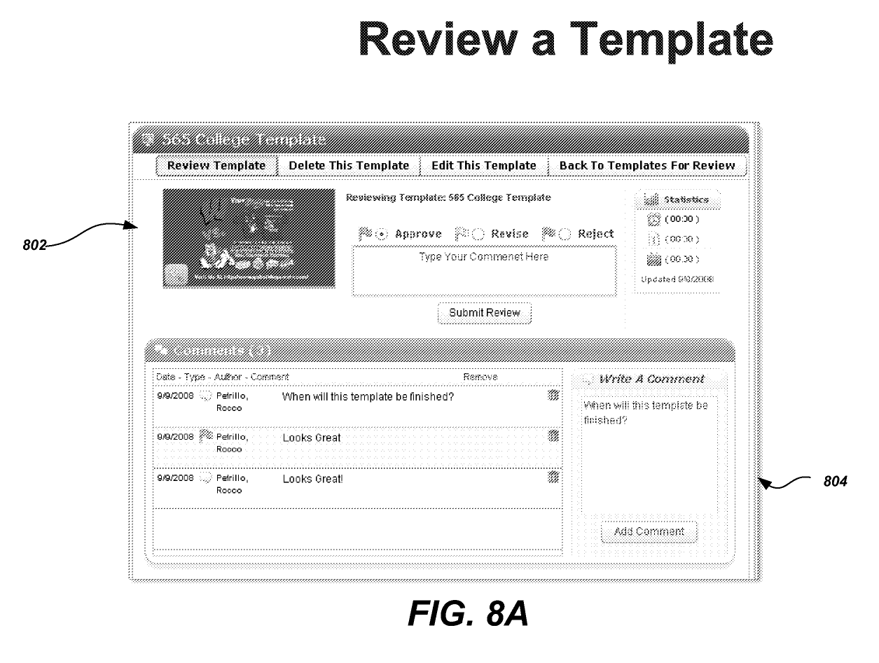

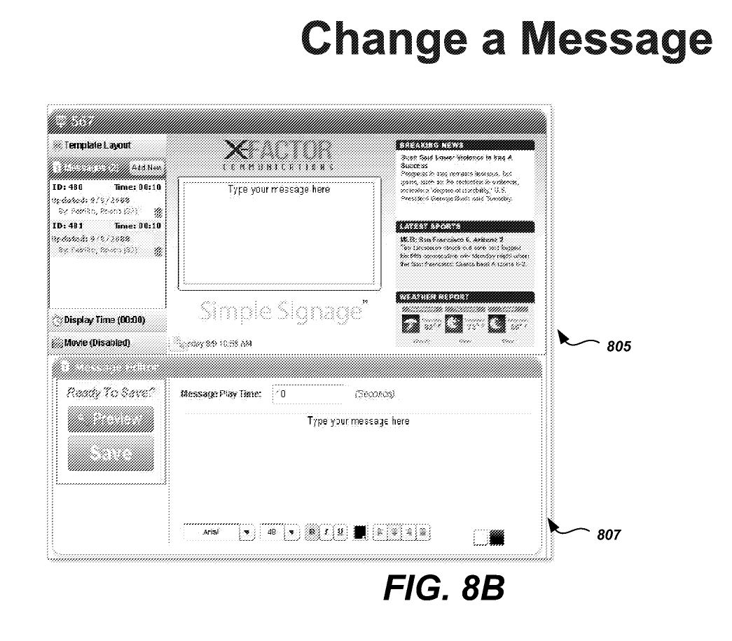

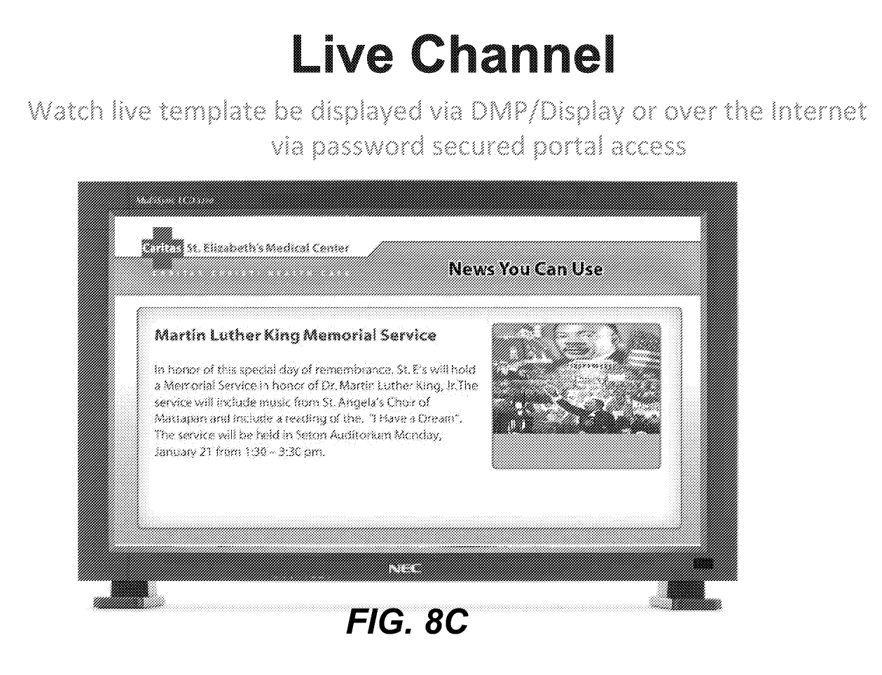

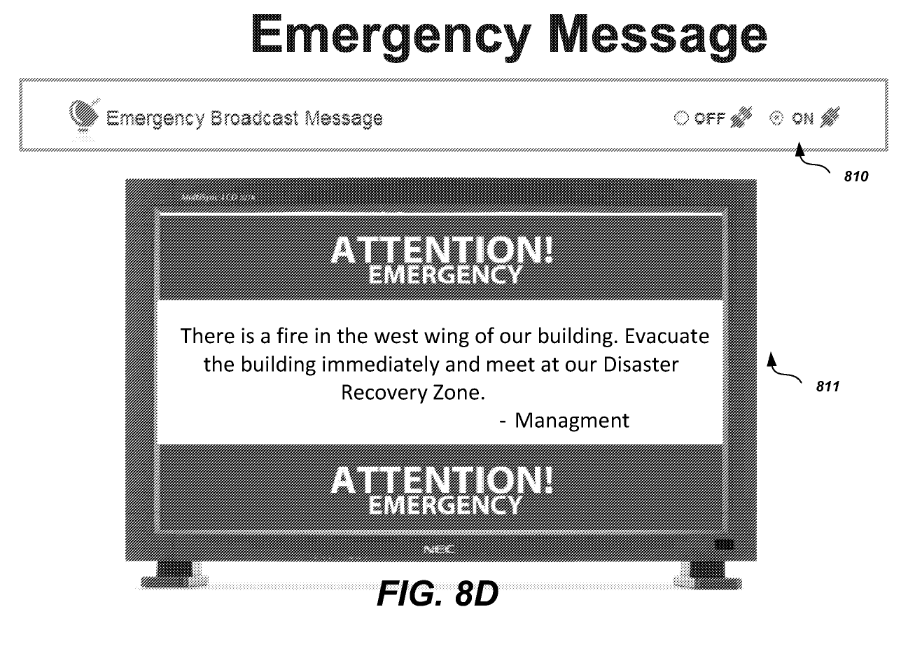

Components of FIGS. 1A-1C and 2A, 2B may implement a process for managing a digital signage system. The user interface controls for managing the digital signage system provided by the components of FIGS. 1A-1C, and 2A, 2B may be those shown in of FIGS. 8A-8D, 9A-9H, 10A-10N, 11A-11AF, 12A-12L. Data models for managing a the digital signage system such as those shown in FIGS. 7A-77H may be embodied in processor readable media stored on components of FIGS. 1A-1C, and 2A, 2B

FIG. 1B shows a system for deploying rich media applications for digital signage and webcasting. As shown, signage client devices 110-116 are interconnected via network 106. Digital signage messages may be sent to a selected portion or even all of client devices 110-116 from a server device. In one embodiment, at least some of client devices 110-116 may be restricted to managing certain channels, based on for example, the permissioning of the users of client devices 110-116.

FIG. 1C shows a system, and work and data flow for deploying digital signage over a network. As shown, the messages, templates, or other data associated with the digital signage system may flow over a network, including, a WAN, LAN, Secured LAN, or even the Internet 106.

Media design resources 131, such as image or video design applications may generate multimedia content. The multimedia content may be retrieved and/or combined with in-house or third-party resources 130. In-house or third-party resources 130 may be received over a network, or stored on processor readable media.

In any case, a template may be created based on the multimedia content and sent to a device for user update 132. As described in the processes herein, users may create/edit a template, review a template, approve a template, create a message from a template, or the like, at device 132. In one embodiment, the created message may be displayed for review, viewing, and/or updating at web browser(s) 108.

The digital signage data, including a new digital signage message, may be sent over Internet 106 to a control portal 150. The control portal 150 may be a device configured to further update and/or manage, store, audit, and/or transform the messages, templates, etc.

A new digital signage message created by the system then is sent over a network such as Internet 106 to a digital signage client device 110. In one embodiment, the device 110 may comprise a plurality of sub devices, including a digital media manager 238 (e.g., Cisco Edge Network, Cisco Application and Content Networking System (ACNS), or Cisco Digital Media Manager), Digital Media Player (DMP) 234, external hardrive 168, and LCD Monitor 232. Device 150 may be a dedicated device configured with a low memory and/or CPU usage operating system, such as an embedded operating system (e.g., Windows CE, Embedded Linux, etc). The hardware and/or software may be configured to provide multimedia display at high speeds and high reliability. Digital media manager 238 may receive the digital signage message. Hardrive 168 may store the digital signage messages received over the network(s). DMP 234 may comprise dedicated video processing hardware, such as video processing chips. DMP 234 may be a Cisco DMP. DMP 234 renders multimedia content included within the digital signage message on LCD monitor 232. DMP 234 may schedule the digital signage message to play within a playlist over time, or on a schedule (e.g., display message as every third sign; once every hour for 10 minutes, etc).

FIG. 2A shows a block diagram for devices for providing digital signage services. As shown, client device 101 is in communication with digital signage server 150, which is in communication with digital signage client device 110. Other communication configurations may also be used. The network communications may be via network interfaces.

Client device 101 comprises components in communication with each other, including input/output control 212, processor/memory 216, display 214 and browser 218. Input/output control 212 provides an interface for entering user commands and/or receiving feedback from the device. The control 212 may comprise a keyboard, mouse, sound output, haptic output, visual output, etc. Processor/memory 226 includes any computing component and/or computer memory component. For example, the processor includes any device for performing computerized operations, such as running a program based on processor-readable instructions stored within a memory such as RAM, ROM, EEPROM, hard-disk drive, etc. Browser 218 includes any component for providing a user interface. Browser 218 may provide interfaces for managing the digital signage system as described herein. Browser 218 may display template management, user management, and/or message creation mechanisms sent from digital signage servers. A user may manage the digital signage system displayed in the browser and over display 214 using input/output control 212.

Digital signage server 150 comprises components in communication with each other, including template manager 222, processor/memory 226, channel manager 224, and advertising manager 228. Processor/memory 226 includes a computing component and/or computer memory component suitable or sufficient for performing processing (e.g., processing for digital signage management).

Template manager 222 includes a component for managing creation of templates, defining read-only and dynamic areas of a template, a template's organization, a template and/or area's permission levels, or the like. Template manager 222 may provide a GUI for creating new templates and editing new signs created for those templates. Template manager 222 provides creation mechanisms, such as formatting, selecting dynamic and read-only areas, graphics processing, word processing, or the like, to design and save a template. The templates may be created not for only a particular customer, but may be stored in a shared library of templates, shared between customers, or the like. Such templates may be shared using permissioning (only sub-organizations within an organization may share, creator may permit certain users to share, etc.) In any case, a template may be associated with at least one customer. A user for the customer may then create a message for the template as described herein.

Channel manager 224 includes any component for managing aggregation of different types of messages, wherein such aggregation may include a grouping of different templates provided by template manager 222. Advertising manager 228 includes any component for recording proof-of-play or other inventories of content display (e.g., messages displayed within a channel), signing up advertisers, managing advertising campaigns, accounts, creating advertisement within templates/new digital signage messages, etc. Definitions of templates, channels, advertiser/advertising may be stored in a memory such as memory 226.

Digital signage client device 110 comprises components in communication with each other, including display 232, processor/memory 236, digital media player 234, and digital media manager 238. Processor/memory 236 includes any computing component and/or computer memory component. Processor/memory 236 may be a dedicated processor for managing digital media. For example, processor/memory 236 may comprise an Application Specific Integrated Circuit (ASIC) and/or Digital Signal Processing (DSP) component configured to provide digital media. As described in the process herein, digital media manager 238 may receive a new digital media message, generate a renderable or rendered digital signage message based on the new digital media message, receive commands for displaying the digital signage organized by time, grouping, or the like. Digital media player 234 may receive the digital signage from digital media manager 238 and may display the digital signage over display 232.

FIG. 2B shows a block diagram shows one example for devices for providing digital signage services. As shown, server 150 may comprise various components, including SQL server 242, File System 244, thumbnail generator 252 in communication with application service component 250. Application service component 250 may be implemented using, for example, .NET 3.5 using C#.

File System 244 is configured for uploading data and providing thumbnails and may send data to application service component 250. Thumbnail generator 248 is configured to provide a windows service for providing thumbnails. Thumbnail generator 248 may send thumbnail requests or other data to thumbnail generator 252. Thumbnail generator 252 may use Adobe AIR or other runtimes that lets developers use web technologies to build rich Internet applications that run outside the browser on multiple operating systems. Thumbnail generator 252 may generate a webpage display of the template and may save away the image of the webpage in at least one resolution, and in some embodiments, in various resolutions. For example, a high resolution thumbnail may have legible text, whereas a low resolution thumbnail may have non-legible text. The thumbnails may be stored on SQL 242 by application service component 250. Server 150 can provide a streamlined, cheap, and more efficient digital signage systems because the application logic may be stored on the server, while the clients may be simpler, non-application specific, and standardized.

As shown, server 150 may be in communication with clients 110 and 112. Clients 110 and 112 may include computer players, Cisco digital media players (DMP) and certain set top boxes that have resident Adobe's Flash player installed and can launch internet browsers. Cisco currently has 2 set top box style DMP's: the 4300 & 4400 series. The system can work with both Cisco DMP players. A key strategic architectural feature of the system is that it leverages the Adobe flash plug-in as it's player software which is currently a free download to consumers. Thus the server can work with free client devices that may not require proprietary software from the signage company. Such embodiments, for example provide ease of integration and implementation. If desired, other configurations can also be implemented.

Client 112 may include HTML component 254 for rendering HTML, Adobe Flex component 256 for providing dynamic applications (video, sound, etc), and Flash loader component 258 for loading Adobe Flash files. These components may be executed or activated within a web browser. These components may be downloaded and installed over network 106. Digital signage sent from server 150 may be adapted to be played with the components of client 112 based on a type of client (web client) and/or operating system of client 112.

Client 110 shows a different type of client. Client 110 includes a Javascript component 260 for executing Javascript code, and Flash loader component 262 for loading Adobe Flash files. As shown, the components of client 110 need not be embedded within a web browser. Instead, digital signage (including sent Javascript code and/or Flash data) sent from server 150 may be directly run through the components 260 and 262.

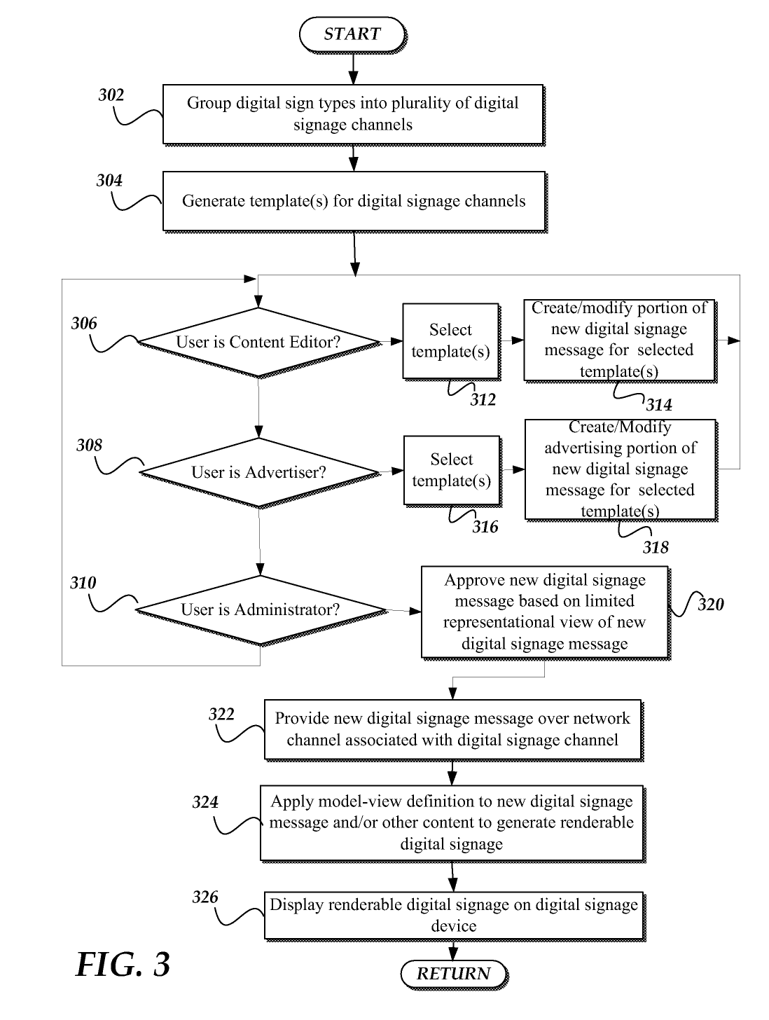

FIG. 3 shows a logical flow diagram for providing digital signage services. FIG. 3 shows that at step 302, digital signage types are grouped into a plurality of digital signage channels. Digital signage types may include emergency messages, alert messages, daily weather messages, news messages, or the like. The digital signage types may be specific to any level of an organization, such as at the corporate level, a building level, a conference room level, or the like. Accordingly, a channel may have types of messages (e.g., weather, alerts, etc.), for a regional office, a building, or even a room. In one embodiment, a plurality of digital signage types may be grouped into the digital signage channel based on a similarity in an attribute of at least one of the grouped digital signage types, wherein the similarity in the attribute comprises a similarity in at least one of: a content type of the grouped digital signage types, an importance of the grouped digital signage types, a designated geographical location of the grouped digital signage types, or a company type of the grouped digital signage types. The type of the digital signage may be a label, such as a field in a database. Examples of groupings include: video signage may be in one channel, important alert messages may be in another channel, video of California may be grouped into yet another channel, or video of California activities of a company, such as Cisco may be grouped in yet another channel.

At step 304, at least one template may be generated for at least one digital signage channel. A user, such as a CPA, CSA, PSA, or another type of user, may create the digital signage template. The template may be stored and/or defined as a data structure, using for example a markup language document, such as HTML, XML, or the like, or in Adobe Flash, Flex, or the like. The template may have certain defined portions/areas that are uneditable (read-only), and defined certain portions/areas that are editable based on permissions of types of a user, and/or certain portions/areas updated automatically from data feeds, based on triggers, such as time triggers, data availability triggers (either using pushing or pulling of data protocols), or the like.

Steps 306-310 are determination steps for determining permissions or types of users. Such determinations may be performed based on data store in processor readable medium, such as a database, for example. For example, access of a sub-administrator may be granted to creating message using the creation interface for the channel.

At step 306, it is determined whether a user of the system has the permission to edit content or is otherwise a content editor. A content editor may comprise a CPA, CSA, PSA, an administrator, or other type of user. For example, a sub-administrator may be granted access to managing messages for at least one of a customer, a template, a message, or the like. In one embodiment, it may be determined if the user has permission to edit content of a message for an organization, channel, template, or the like. The permission may be determined for a portion/area of a message. A user may have permission to edit a portion/area of a message for a particular building, but not the portion/area that is shared throughout the organization. Another user may have permission to edit both the building level portion/area and the organization level portion/area. If it is determined that the user is not a type of content editor, processing continues to step 308.

Otherwise, processing continues to step 312 where a template is selected for editing. The selection may be made by the user, pre-determined based on the user's permission, determined by an administrator, algorithmically chosen based on time of day, geo-location, or the like.

Processing then continues to step 314, where the user is enabled to edit and/or modify at least a portion/area of a new digital signage message for the selected template. In one embodiment, a creation interface is provided, over the network, wherein the interface is configured to create a new digital signage message based on the template, wherein the new digital signage message provides a definition for a display of a view of the new digital sign, and wherein the definition is adapted to map elements of the view to a plurality of data structure types for storing the new digital signage message. In one embodiment, the creation interface comprises at least one of a web interface or an application programming interface, and wherein the approval interface comprises at least one of a web interface or an application programming interface.

The user may use a user interface, for example, to enter the information, images, multimedia, etc., for the portion/area. The user may modify a previously edited portion/area. In one embodiment, a play time for the new message may also be received, wherein the play time determines a slot position in a playlist for the new digital message or a duration of playing the new digital message. The user may preview the changes, save and/or discard the changes. Processing then loops back to step 306.

In one embodiment, the message created or updated may be an emergency message, and an approval requirement for the emergency message may be disabled when the message is created. Accordingly, for emergency messages, processing does not loop back to step 306; processing skips, steps 310 and 320 and instead proceeds to step 322.

At step 308, it is determined if the user is an advertiser. An advertiser may be a third-party user that is not associated with an organization(s) deploying a channel (e.g., the customer). Instead, an advertiser may have a relationship with the organization(s) or otherwise has permission to provide content within the channel, wherein such relationship or permission is stored in processor readable media and confirmable by computer processing. In one embodiment, the user may have permission to edit a type of portion/area of a message across templates, or even across organizations. For example, such type of portion/area may be designated as an advertisement, banner ad area, (e.g., associated with a particular ad campaign such sports, seasonal sales, etc.), or the like. If it is determined that the user is not an advertiser, processing continues to step 310. Otherwise, processing continues to step 316.

At step 316, at least one template or even a group of templates is selected by the advertiser, algorithmically, or the like. For example, the advertiser may bid on an advertisement portion/area associated with a certain demographics (e.g., age, gender, race, social economic class, etc.). The association between advertisement and demographics may be determined by algorithmic clustering, recording statistics of proof-of-play for the channels, or the like. If the bidding is successful, the templates are selected for editing. The advertiser may further select particular groups of templates, such as those templates for a particular ad campaign. For example, the advertiser may filter the templates to select templates associated with a particular target market. Processing then continues to step 318 where the advertiser creates and/or modifies at least a portion/area of a new digital signage message that is designated as advertising. Processing for step 318 may be substantially similar to step 314. Processing then continues to step 306.

At step 310, it is determined whether the user is an administrator. The administrator may have permissions to manage a template, a channel, an organization, or even a plurality of organizations. The administrator may have permissions to manage new messages created by a particular type of user, such as a content editor and/or an advertiser. If at step 310 it is determined that the user is not an administrator, processing loops back to step 306. Otherwise, processing continues to step 320 where the new digital signage message (e.g., created and/or modified by other users) can be approved based on a limited representational view of the new digital signage message. The limited representational view may be a bitmap, screen shot, a compressed HTML page, an animated icon, or the like.

In one embodiment, an approval interface is provided, over the network, wherein the interface configured to enable approval of the new digital signage message based on a limited representational view of the new digital signage message. In one embodiment, access to an approval interface is granted to the main administrator. The administrator may approve the message for publishing, may make notations associated with the message (such as requesting further changes), may reject the message, make edits to the messages, or the like. If the message is rejected (not shown), processing may loop back to step 306. Otherwise, processing continues to step 322.

At step 322, the new digital signage message is provided over a network channel associated with the digital signage channel. The network channel may be associated with a protocol, within one of the Open Systems Interconnection (OSI) networking levels, such as TCP/IP, UDP, Hyper Text Transfer Protocol (HTTP), HTTP Streaming, HTTPS, SSL, Real Time Streaming Protocol (RTP/RTSP), etc. The network channel may be associated with a port. The network channel may be configured for an origination (e.g., the customer associated with the digital signage channel). The network channel may be associated with at least one digital signage channel. The digital signage channel may be associated with at least one network channel. That is, there may be a many-to-many relationship between network channel and digital signage channel. In any case, the new digital signage message is sent over the network channel using the appropriate protocol/port (e.g., using a data push or pull mechanism).

At step 324, a model-view or model-view-controller (collectively “MVC”) definition is applied to the digital signage message. In one embodiment, the MVC definition may be associated with a particular digital signage client device and/or media player configured to provide the new digital signage message. In one embodiment, the MVC definition may be in a markup language, in a non-markup configuration language, such as YAML, a text file, a database, or the like. The MVC definition is configured to separate the data model (e.g., the content for the portions/areas, and the content for the template) from the rendering thereof on a display (e.g., actual view processing, such as layout flow, sizing, etc). The application of the MVC definition to the new digital signage message generates a renderable or rendered digital signage message. The generation may create a plurality of renderable or rendered digital signage messages, wherein the renderable/rendered messages is configured to be in a format specific to different types of DMPs. The renderable or rendered digital signage message may be in a rendering format such as an graphical/video/audio multimedia format (e.g., JPEG, GIF, animated GIF, etc.), including streaming media format such as Flash, MPEG, MEPG-2, etc. In one embodiment, step 324 may be performed before step 322, concurrent with step 322 or after step 322. For example, the application of the MVC and/or the generation of the digital signage may be performed before sending (in which case the digital signage message is sent). In another embodiment, the application/generation may be performed by an intermediate device that is relaying the new digital signage message from a server to a client device, and the generated digital signage is inserted into network information (e.g., packets) for the new digital signage message (e.g., the body of the message may be modified to include the renderable digital sign). In yet another embodiment, the receiving digital signage client device may perform step 324.

At step 326, the digital signage is displayed on a digital signage client device, based on a schedule, a playlist, a duration of play, or the like. If the digital signage is an emergency message, a display of a plurality of digital signage messages associated with a different template than the selected one of the templates with the new digital signage message may be overridden, and the emergency message may be played. Processing then returns to other operations. In one embodiment, the display of the approved instance of the new digital signage may be scheduled based on a playlist that specifies the order or length of time of a displayed message.

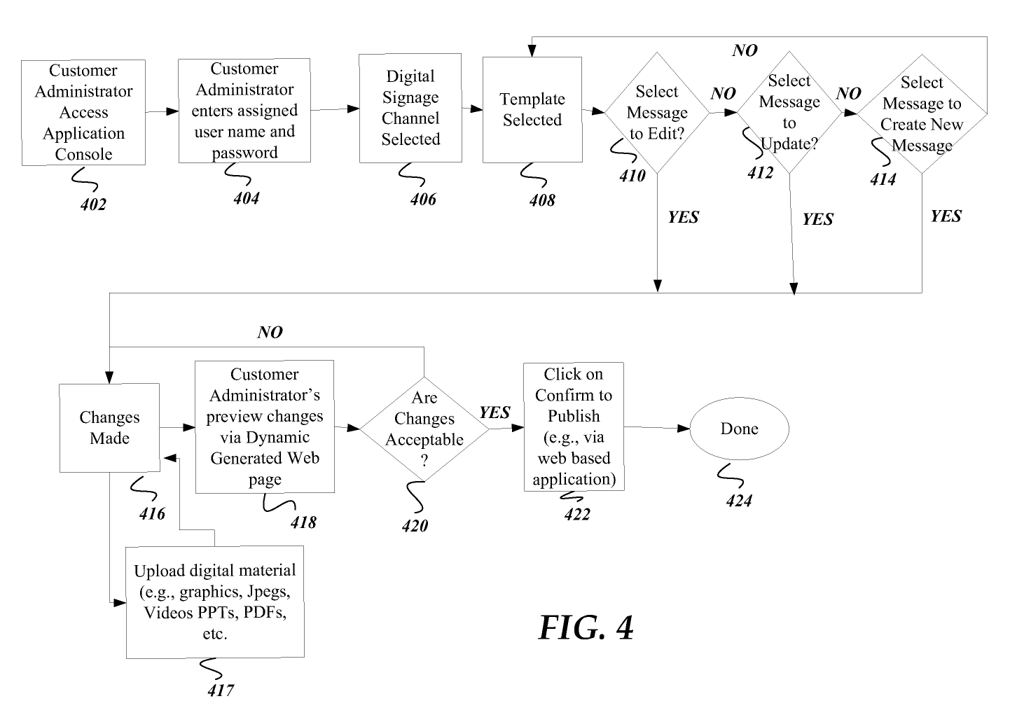

FIG. 4 shows a logical flow diagram of a process for managing a digital signage system. As shown in FIG. 4, at step 402, a user designated by the customer accesses the system. At step 404, the user enters their assigned user name and password. At step 406, the user customer chooses a channel. At step 408, the user customer selects a template. At step 410, it is determined if the user customer has selected a message within the template to text edit. If so, processing continues to step 416. Otherwise, at step 412, it is determined if the user has selected to update the message. If so, processing continues to step 416. Otherwise, at step 414, it is determined if the user has selected to create a new message. If so processing continues to step 416. Otherwise, processing loops back to step 410.

At step 416, a text edit, update, or creation of a new message is completed, for example by using the editing tools (tools may be similar to Microsoft word). The tools may enable changing fonts, size, color, and bold and provide spell check as well. Optionally, at step 417, an upload of the updated digital material (channel, template, messages) may be enabled. In one embodiment, the updated digital material may comprise graphics, JPEGs, videos, PPT's, PDF's, etc. processing then continues to step 418.

At step 418, an administrator such as a CPA then previews the edit changes within the designated template via a dynamic generated webpage. At step 420, it is determined if the edit is acceptable. If so, processing continues to step 422. Otherwise, processing loops back to step 416. At step 422, an administrator can confirm (e.g., click on a button) and publish the message to the digital signage channel, for example, via a web based update application. Processing then returns to other computation.

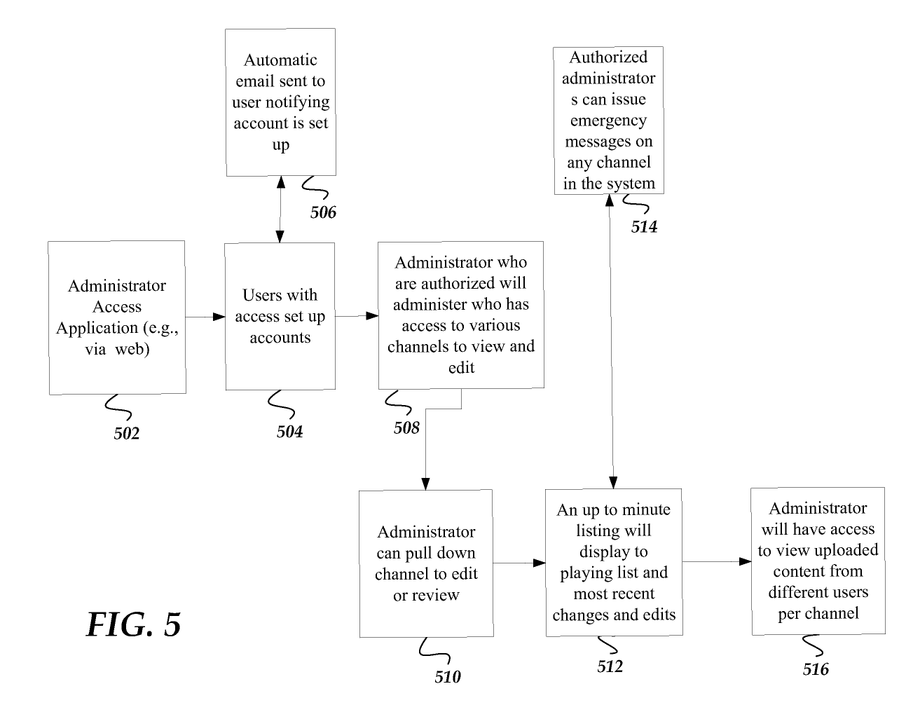

FIG. 5 shows a logical flow diagram of a process for managing users and a digital signage system. At step 502, an administrator user accesses the system (e.g., through a web application). At step 504, the administrator user who is determined to have adequate access is enabled to set up accounts for other users. At step 506, an email is sent to a user notifying the user that their account is set up. At step 508, the administrator user who is determined to be authorized is enabled to administer who has access to various channels, including view and edit permissions for the channels. At step 510, the administrator user can pull down or otherwise retrieve channel information for editing and/or viewing (e.g., via a web page). At step 512, an up to the minute listing of the playlist, including any changes, edits, updates of channels are provided, or otherwise displayed. At step 514, the administrator user who is determined to be authorized is enabled to issue an emergency message(s) on any or even all channels in the system. At step 516, the administrator user is provided access to view uploaded content from different users per channel. In one embodiment, an administrator may be enabled to manage channels for a plurality of users associated with a plurality of organizations. In this case, the administrator may manage templates and messages for the different channels/organizations using the same interface as described herein.

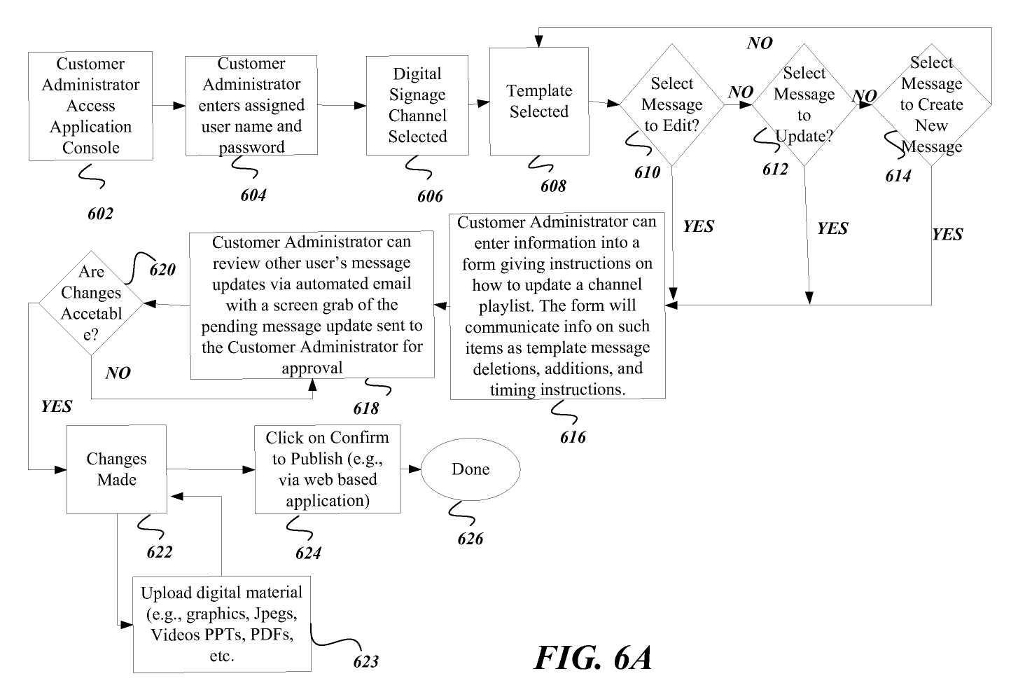

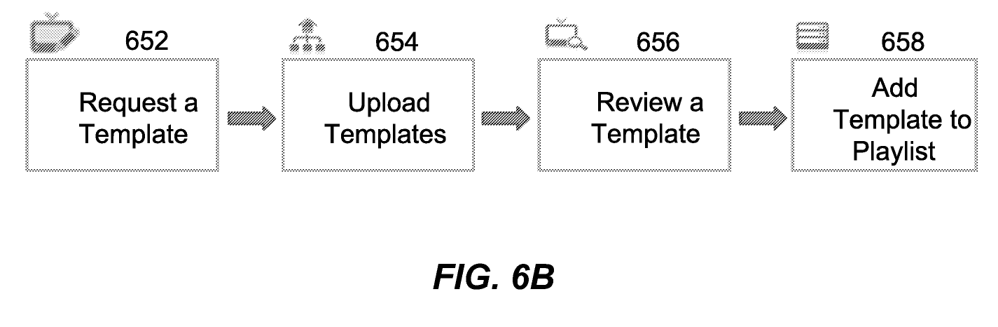

FIG. 6A shows another embodiment of a process for managing a digital signage system. At step 602, a customer user accesses the system (e.g., through a web application). At step 604, the customer user enters their username and password. At step 606, the user customer navigates to the digital signage channel they desire to update. At step 608, the user customer selects a template. At step 610, it is determined if the user customer has selected a message within the template to text edit. If so, processing continues to step 616. Otherwise, at step 612, it is determined if the user has selected to update the message. If so, processing continues to step 616. Otherwise, at step 614, it is determined if the user has selected to create a new message. If so processing continues to step 616. Otherwise, processing loops back to step 610.

At step 616, the administrator enters information into an online form to give instructions on how to update a channel/playlist. The online form will communicate information on items such as template message deletions, additions, and/or timing instructions. At step 618, the administrator reviews message updates via an automated email that includes a limited representational view such as a screen grab of a pending message update sent to the administrator for approval. At step 620, it is determined if the changes to the message are acceptable. If the administrator approves the changes to the message, processing continues to step 622. Otherwise, processing loops back to step 618.

At step 622, a text edit, update, or creation of a new message is completed, by using, for example, editing tools (tools may be similar to Microsoft word). The tools may enable changing fonts, size, color, and bold and provide spell check as well. Optionally, at step 623, an upload of the updated digital material (channel, template, messages) may be enabled. In one embodiment, the updated digital material may comprise graphics, JPEGs, videos, PPT's, PDF's, etc. Processing then continues to step 624.

At step 624, an administrator can confirm (e.g., click on a button) and publish the message to the digital signage channel via, for example, a web based update application. Processing then returns to other computation.

FIG. 6B shows a process for managing a digital signage system. At step 652, a request is made for a template. A user may design a template via an online layout, design, and graphics tool. A user may create content (e.g., graphics, text) for certain read-only areas/portions, and may assign certain dynamic areas (rectangles, circles, non-geometric shape) on the screen for displaying particular types of template data (e.g., text content, movie content, data content, data feed content). The user may assign certain permissions to those certain dynamic areas (e.g., editable by administrators, sub-administrators, etc.; editable by organization wide administrators, room level administrators, etc.; editable by advertisers, the public, etc.). At step 654, the template(s) may be uploaded or otherwise sent to a system for sharing with other users and for creating messages for an organization. The template is associated with a certain organization and the permissions, and data definitions (certain read-only and certain dynamic regions, images, etc.) are stored in a database associated with the organization. At step 656, a user may review the template. If the template is approved, a flag may be set within a database record for the template, indicating that the template is usable to create messages. At step 658, the template is added to a playlist or other types of organizational schemes for displaying digital signage messages.

FIGS. 7A-7H show examples of data models for managing a digital signage system, which may be embodied in processor readable media, and which when read and executed by a processor causes the processor to perform the steps of the processes described herein. FIGS. 7A-7H also show overall hierarchical structures of the digital signage system and the detailed implementation of the administrative web application.

FIG. 7A shows a data hierarchy of data structures and data types configured to control digital signage stored in a processor readable media and usable to manage digital signage. User permissions definition 750, for example, shows the granularity of control and access for a user. The users may have permission to use at least one part on the system (e.g., channel control, program control, template control, message control etc). The permission may be defined at a level of the hierarchy of FIG. 7A.

A user may be have permission to super user level 702. Level 702 enables control and access, viewing, editing, publishing, or playlists, emergency messages and/or overall control. Super user level 702 comprises channels 704-705. A user may, be have permission to channels 704-705. A channel comprises a plurality of programs 711-714. For example, FIG. 7A includes program for marketing 711, program for facilities 712, program for in-patient care 713, or program for ER. A program may comprise a plurality of template 720-721. A user may be have permission to template 720-721. The permission at template levels may enable access to upload content. A template may comprise a plurality of messages 730-731. A user may have permission to manage a particular message. A user may have permission to edit at least a portion of a message and have the message published without requiring approval from an administrator/sub-administrator. That is, the user may be provided discretion to publish particular message portions (defined as portions of a template). Such portions may be emergency message portions, but may also be other portions, such as miscellaneous portions.

FIG. 7B shows a data model for playing digital signage—e.g., a playlist. Channel 704 comprises a plurality of templates having live populated templates played in a plurality of slots. A live template is played for each time slot shown. A live template may be played over more than one slot. For example, live Template 1 may be played in Slot 1 and Slot 2. Programs 711-712 also include templates played in a plurality of play slots. Templates 720-723 comprises a plurality of messages for a plurality of play slots.

FIG. 7C shows a data model for digital signage permissioning, management, creation, and/or deployment. There can be selective permissioning at each level of the pyramid (FIG. 7C). Meaning that for example an admin or super admin (or possibly a user) can assign rights in connection with all or some actions at each level (channel, playlist, program, templates). This granularity and selective permissioning enables certain entities to be allowed to edit a playlist, certain entities to be able to edit a program within a playlist, or the like. As shown, channel 704 comprises a data-type defining a distinct group of content playing or playable over one or multiple media players. A Channel owner may be able to give access to a part of a channel such as to an advertiser (an external entity) or can enable individuals with the company owner specific rights (such as the gift shop manager in a hospital). Channel 704 may be associated to one or more playlist(s) 708. Playlist(s) 708 comprises a sequence and timeline for when content (e.g., a digital signage message) is played. A playlist may be associated with one or more program(s) 714. Program(s) 714 comprises a category of content (e.g., grouping of templates) played or playable within the playlist. Program(s) 714 may include, for example, content for news, employee updates, facility announcements, etc. A program may comprise one or more template(s) 720. Programs can be made of one or more templates. Some entities could have edit rights to two of the templates in the program and not the others. This also gives advertisers ability to have their own program or might manage a (total) playlist.

These controls can be at a playlist level and go down to templates. Template(s) 720 comprises a branded reusable framework (e.g., includes content such as images/text specific to organizations/customers) to display individual or multiple messages, such messages editable by users. A new digital signage message configured for display on a digital signage client comprises the template framework of, for example, template(s) 720 and the associated user edited or assigned message content. In other words, live templates (e.g., templates instantiated as a new digital signage message) are displayed via a DMP to a monitor. For example, the DMP will play template after template ordered by the playlist and repeat the playlist. If an entity logs in using password and ID, only those capabilities that match their rights (e.g. based on the password/ID or account of the entity) will be made available to them. i.e., dynamic generation of user interface that correspond to password rights.

Managing permissioning of FIG. 7C may be enabled by an option of specifying a role for an individual, group, company, etc. For example, when adding a user or entity, the software will give a person an option to select a role to associate with that entity. The role can be used to automatically preset corresponding permissions. The roles can also be used as a substitute for identifying individuals and their respective permissions. For example, onecan select to add the role of advertiser to my channel and this would give access to all on the system who have the role of advertiser on the system. This functionality (the granularity in general) can allow people to engage different sources of content to be part of their signage experience, which enables them to delegate the responsibility. The solution can address workflow in a complex environment.

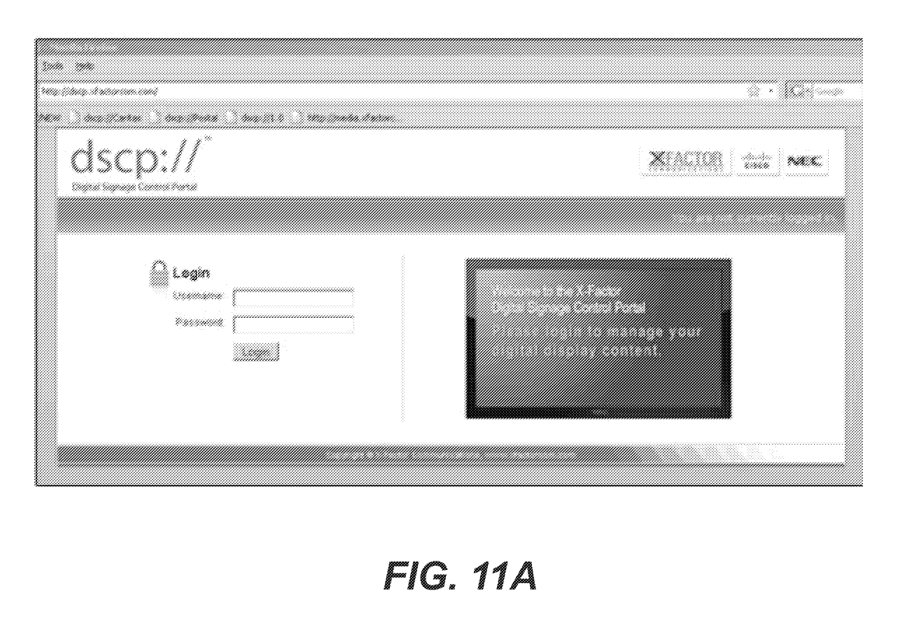

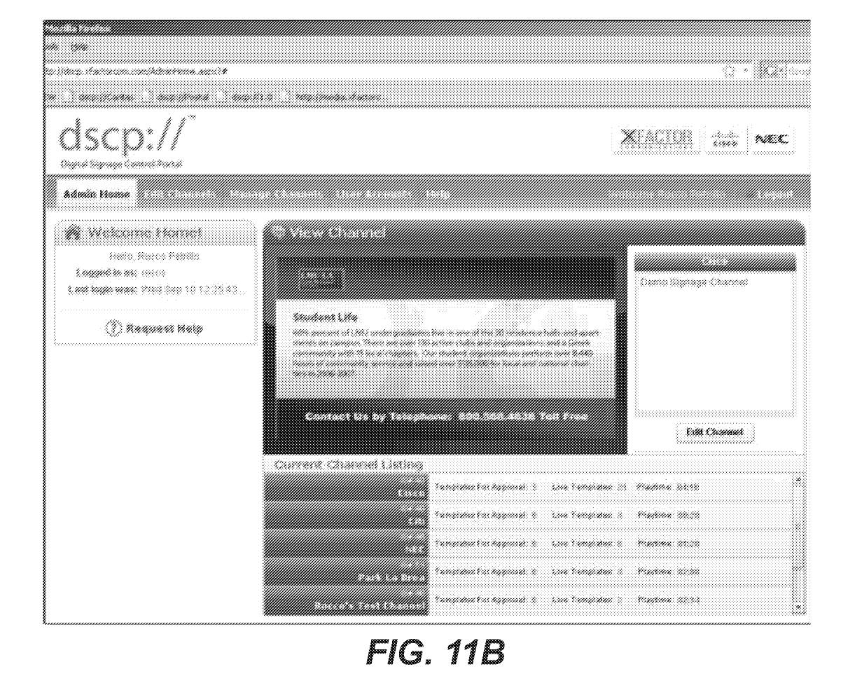

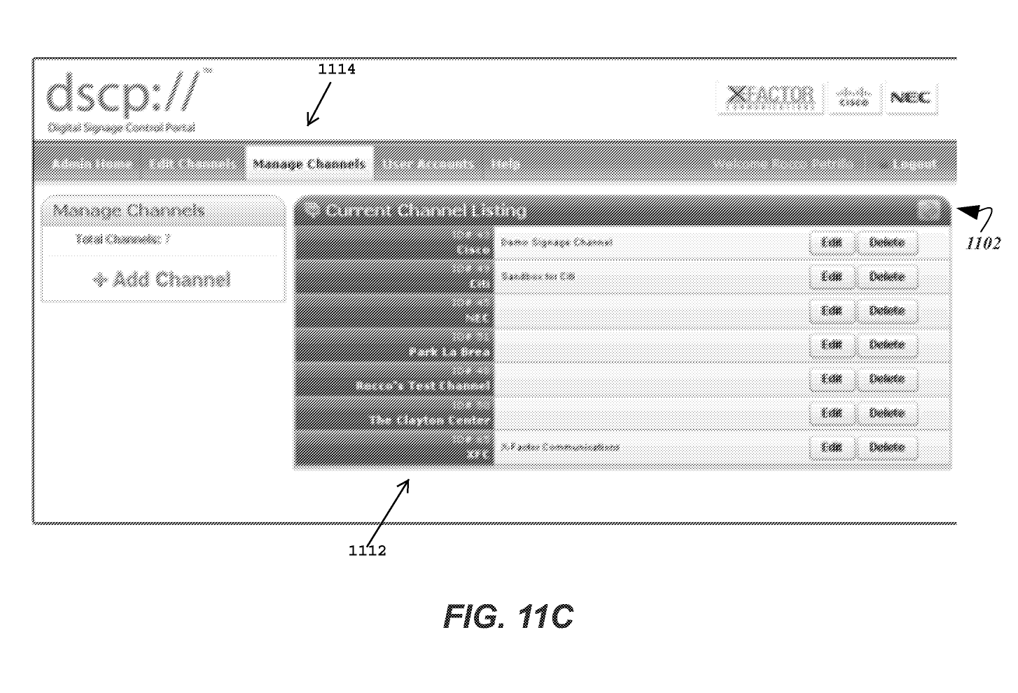

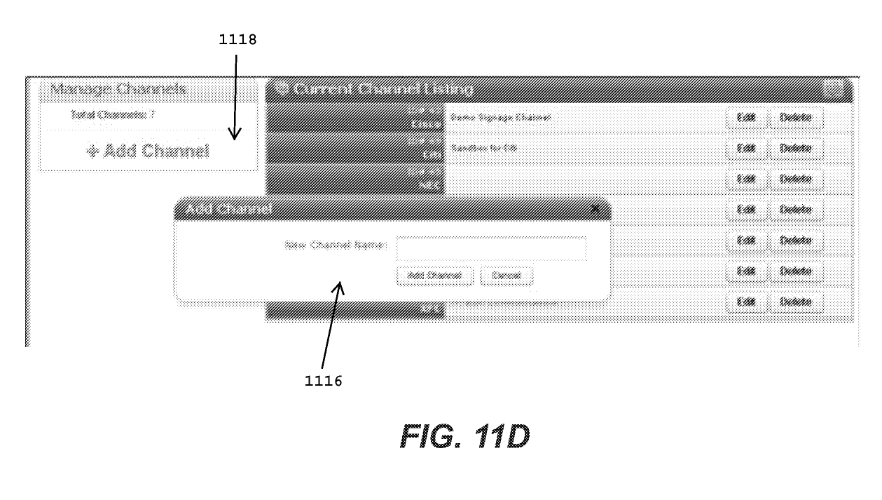

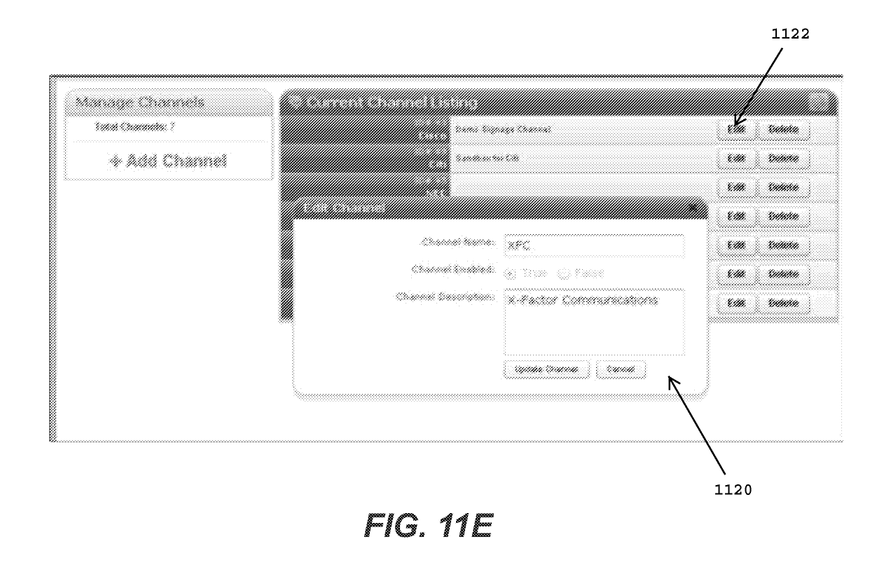

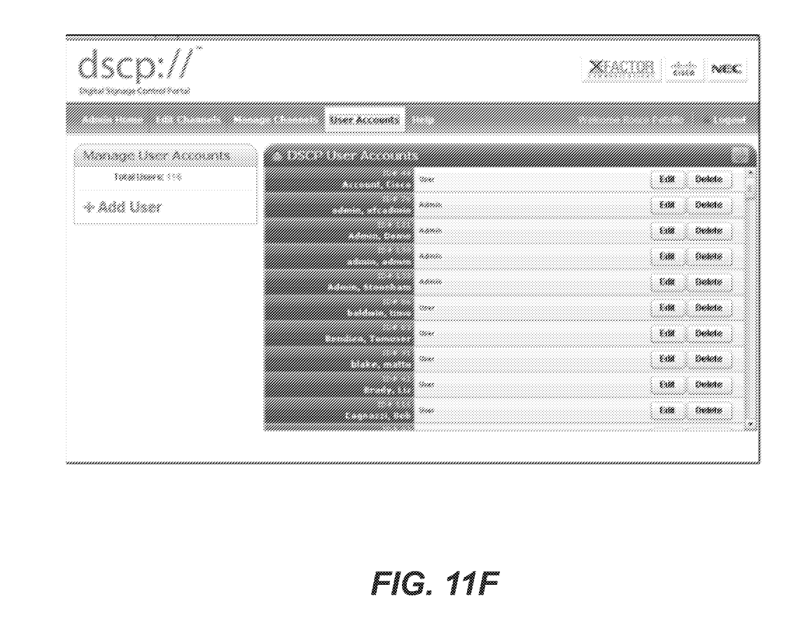

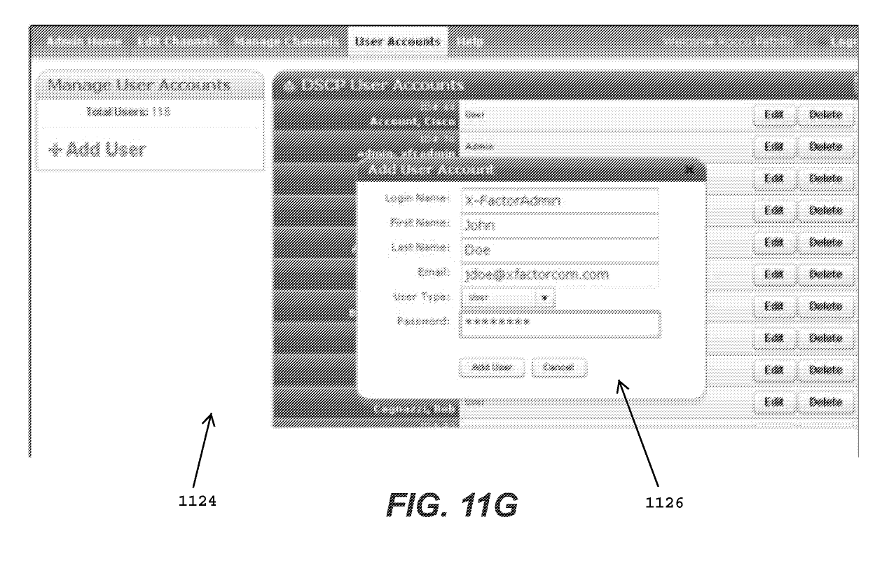

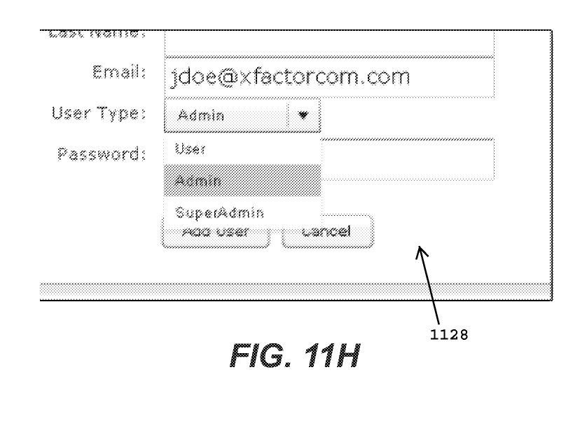

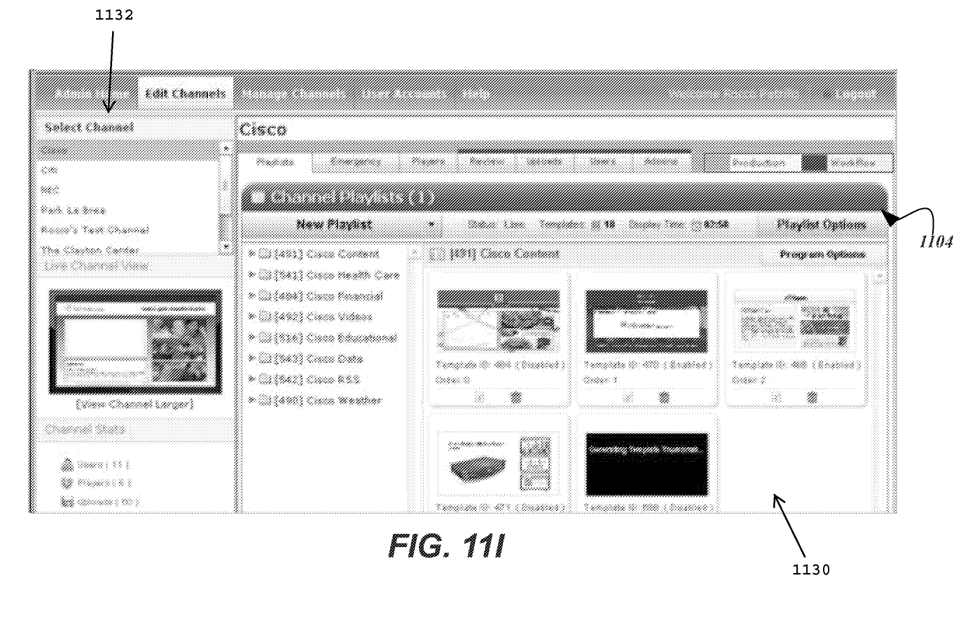

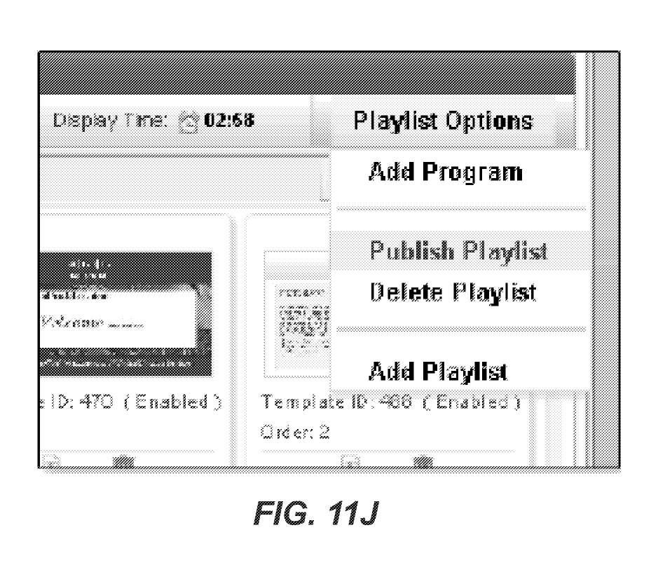

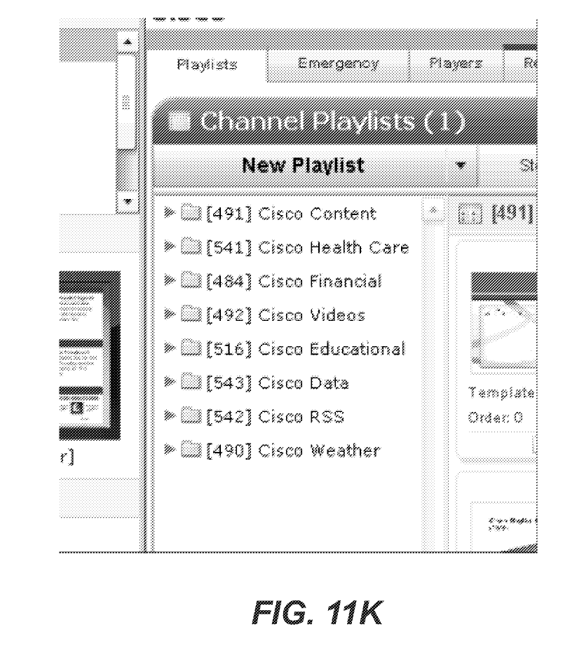

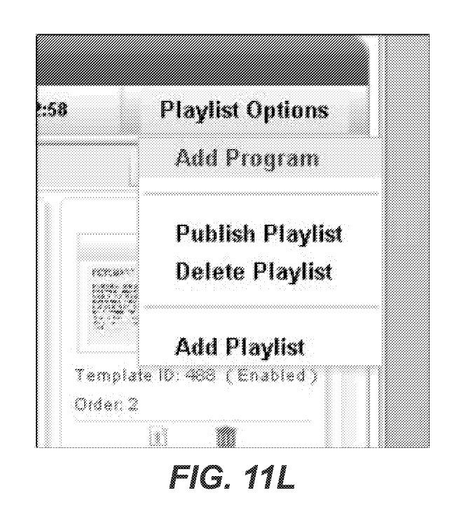

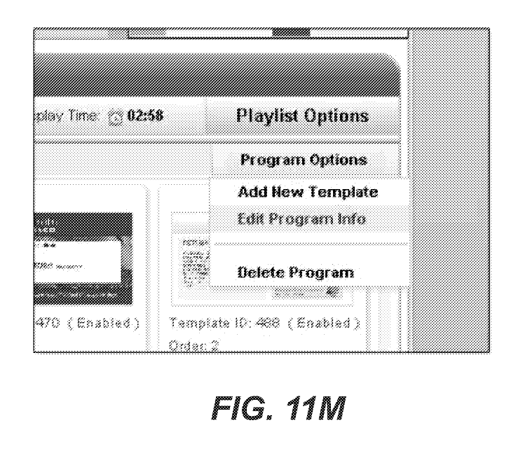

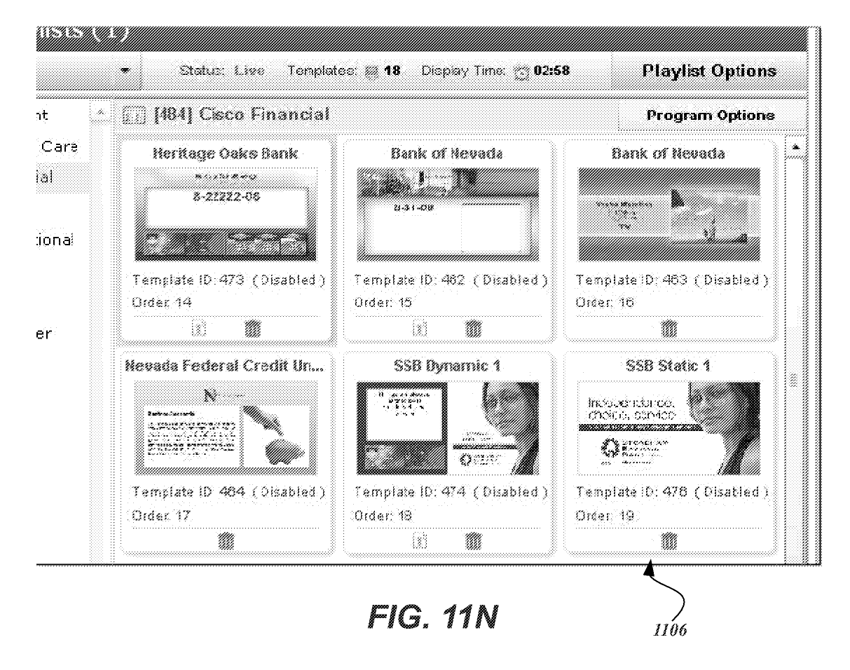

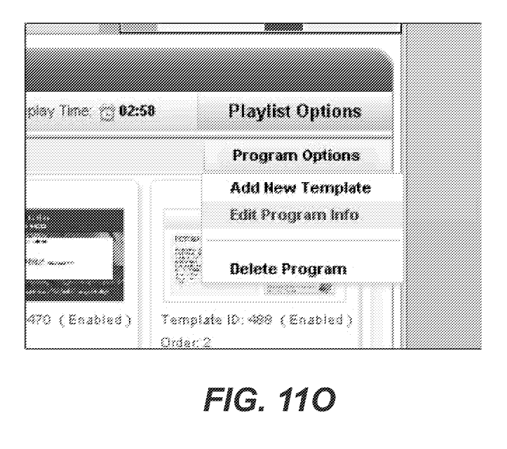

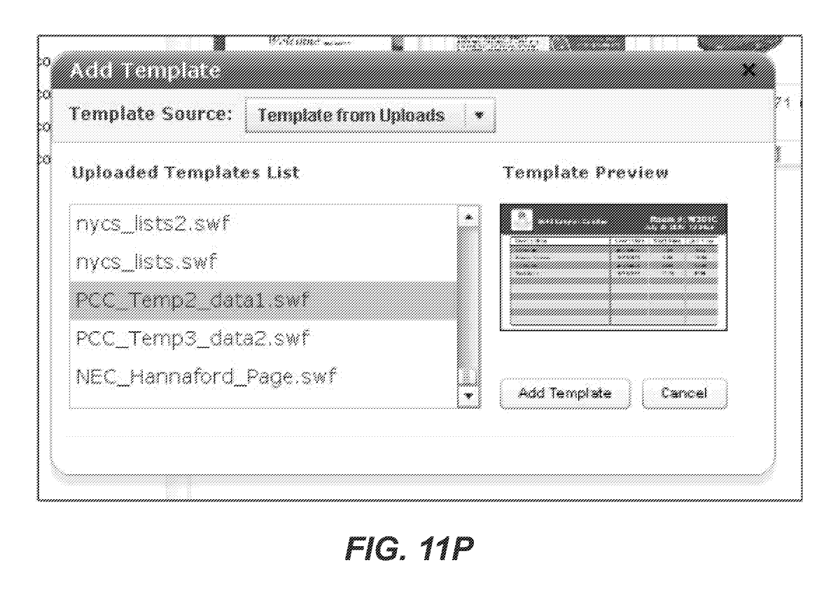

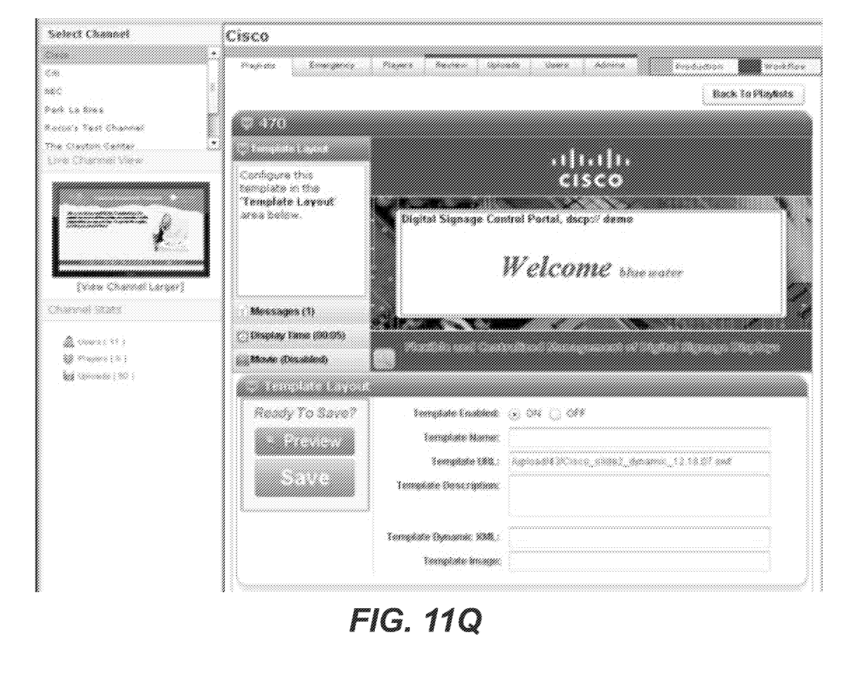

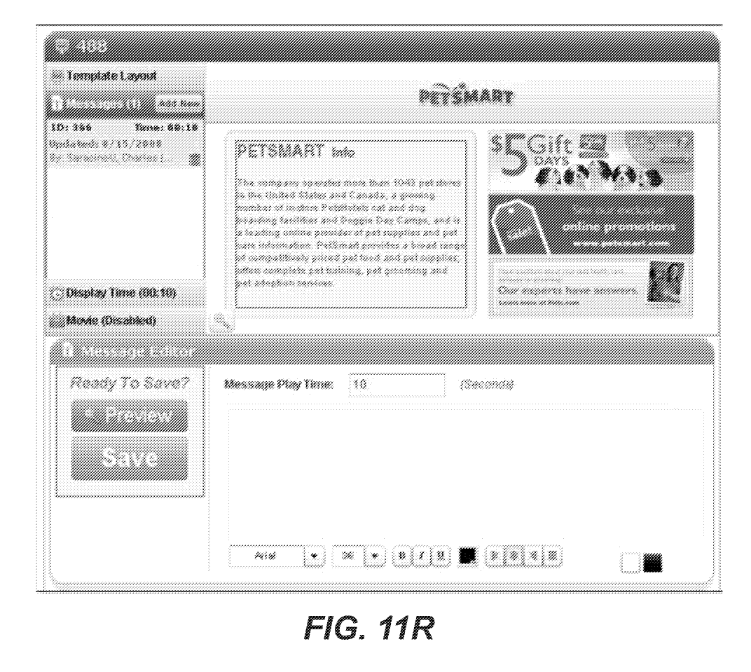

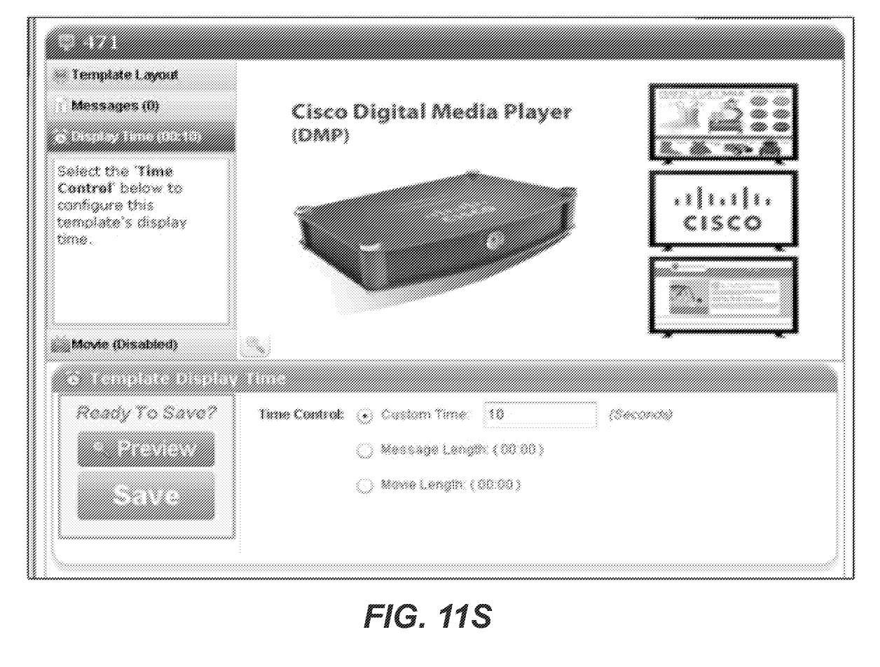

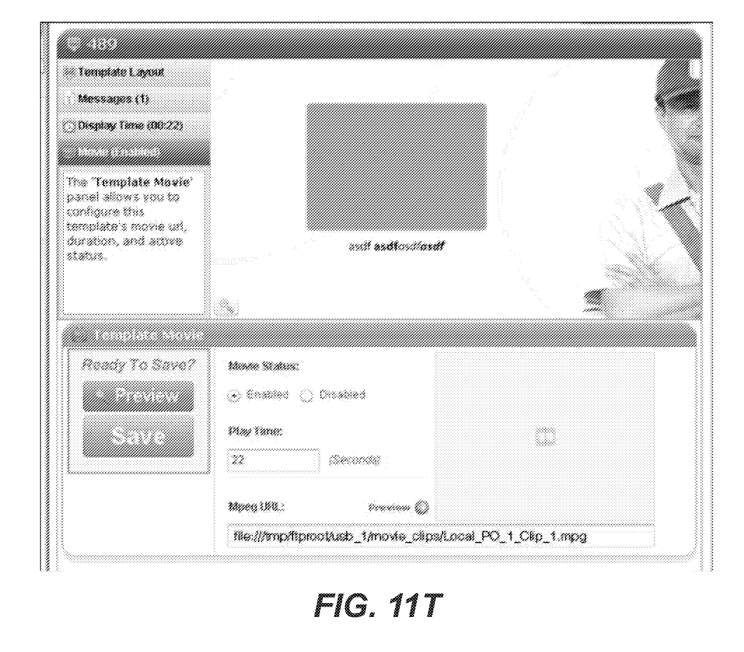

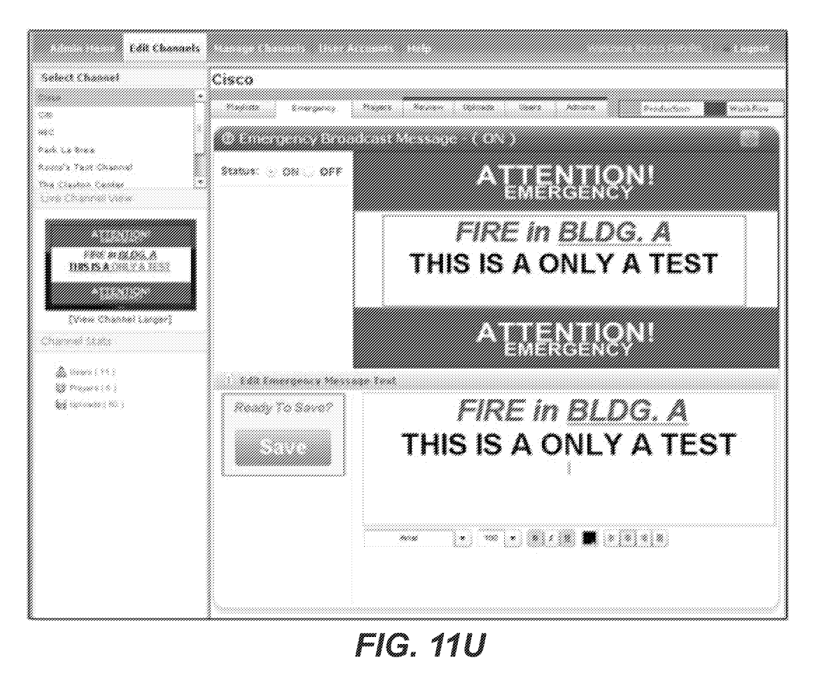

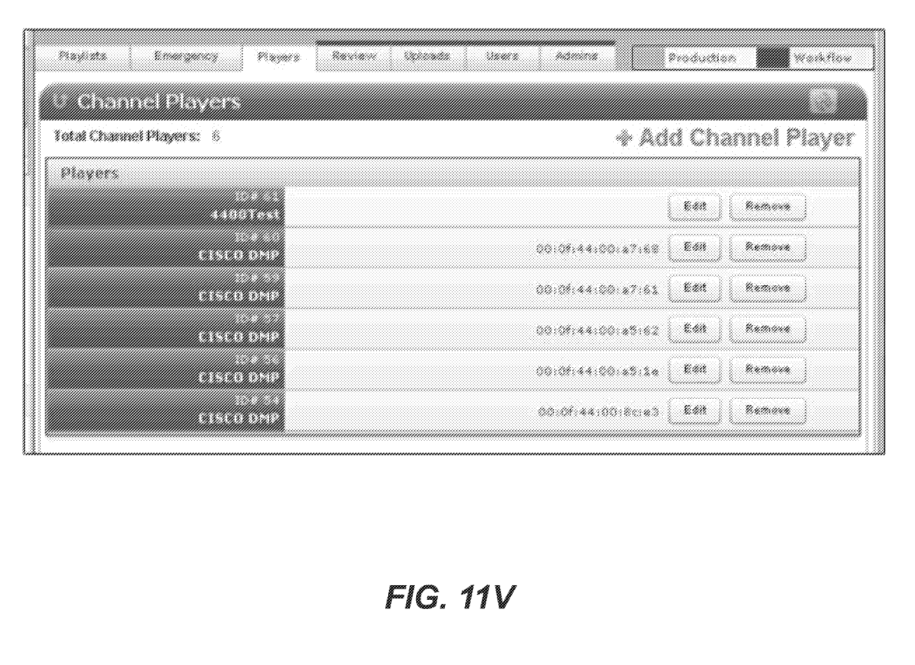

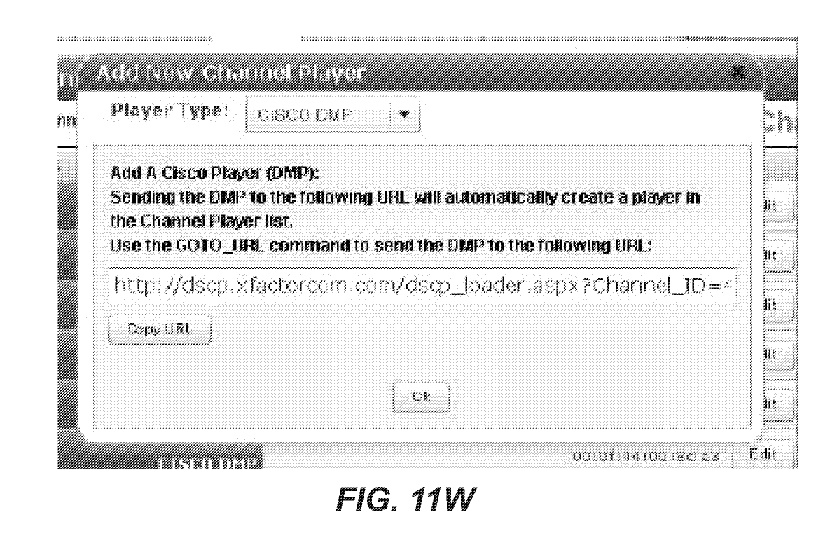

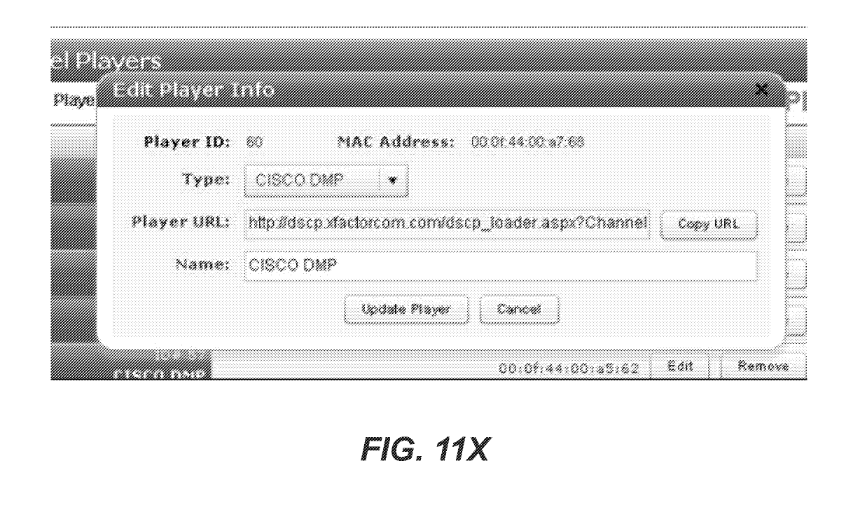

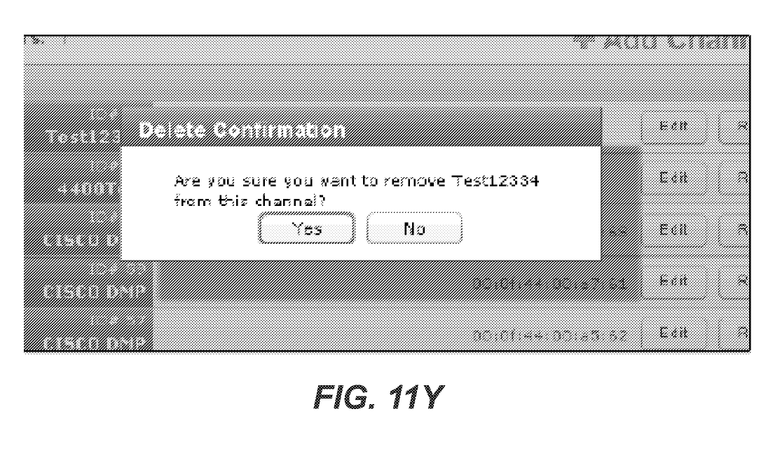

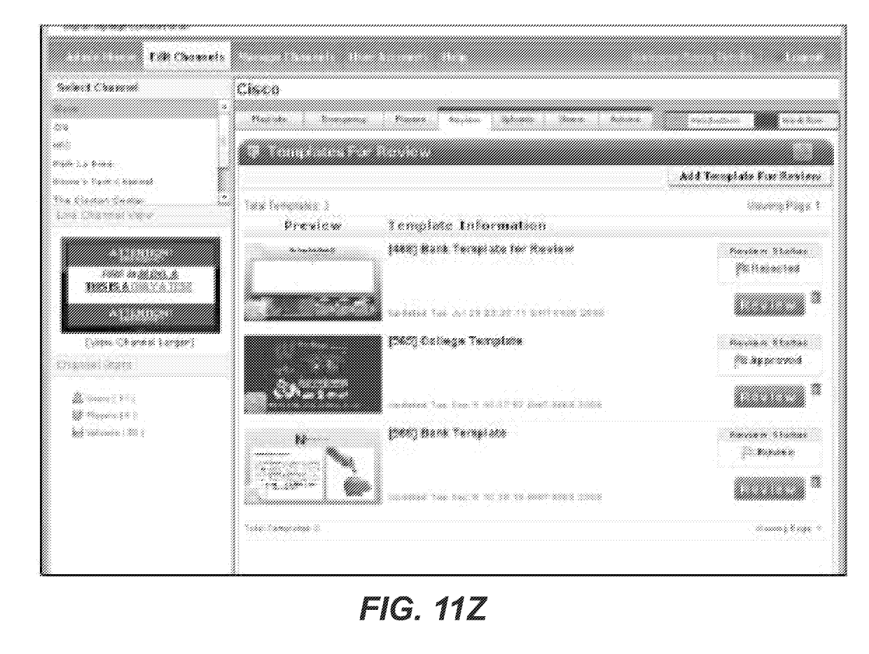

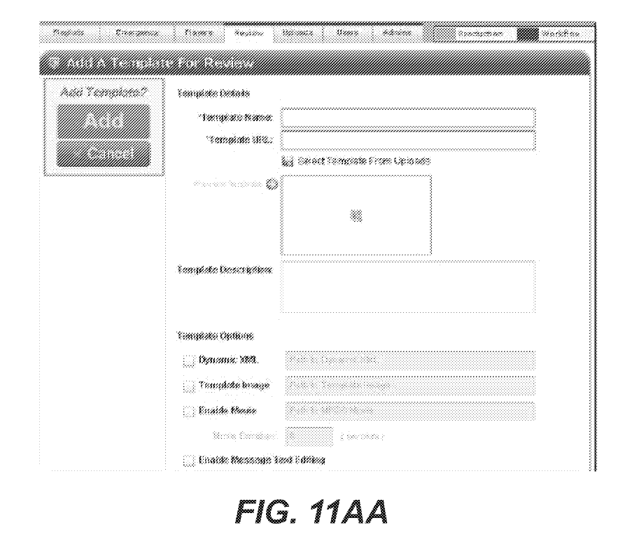

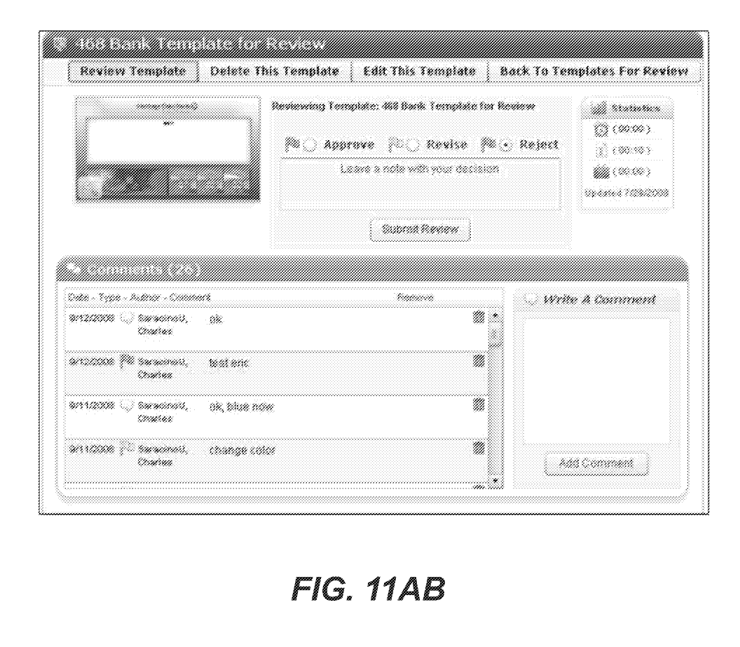

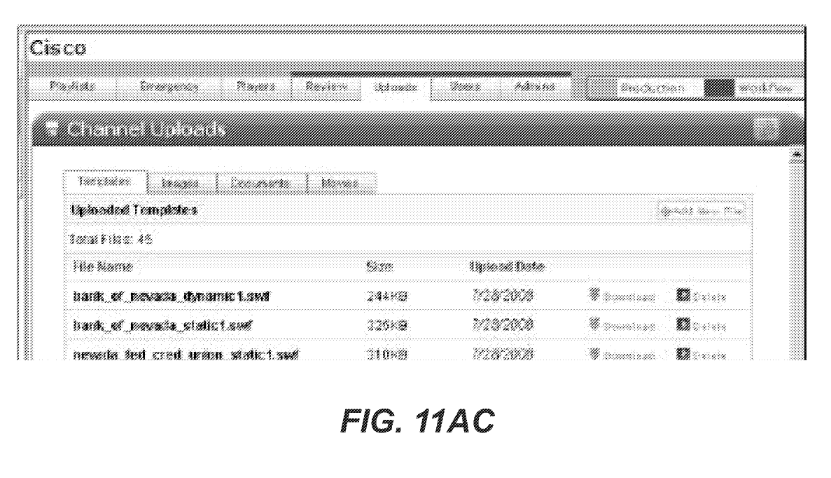

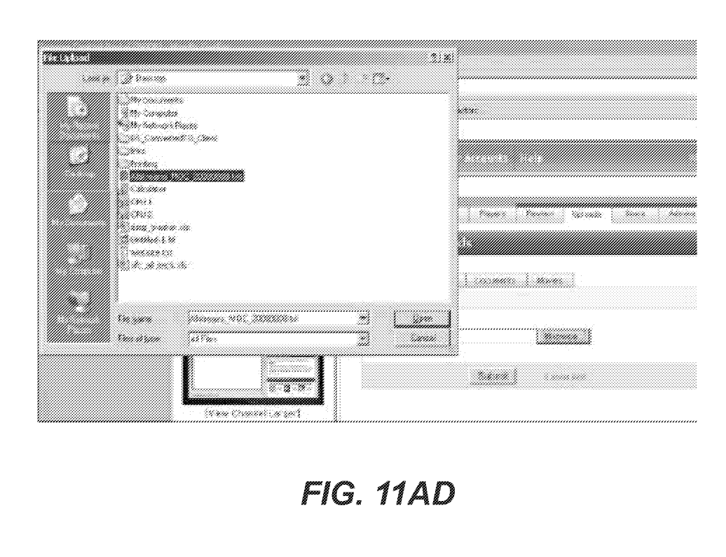

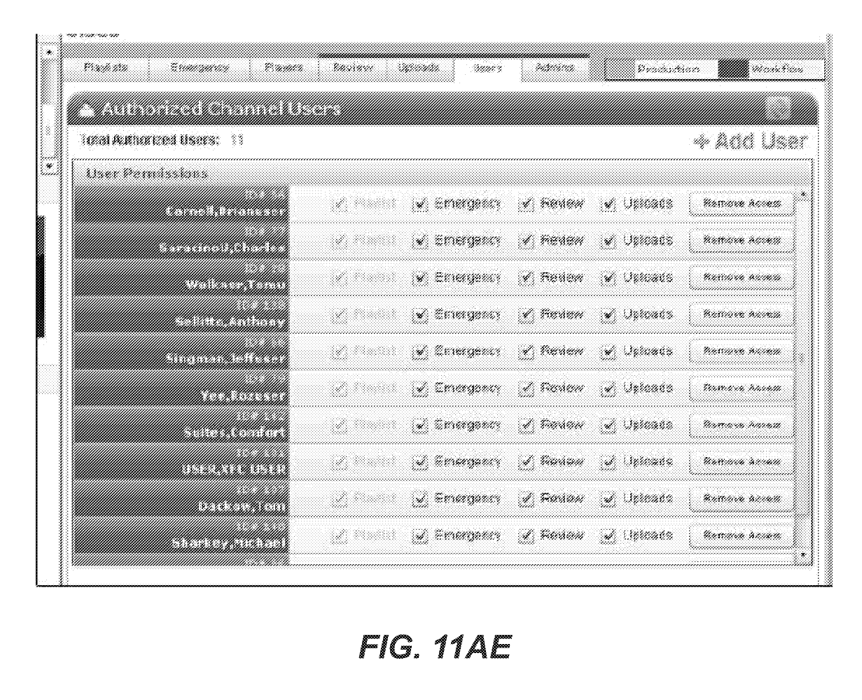

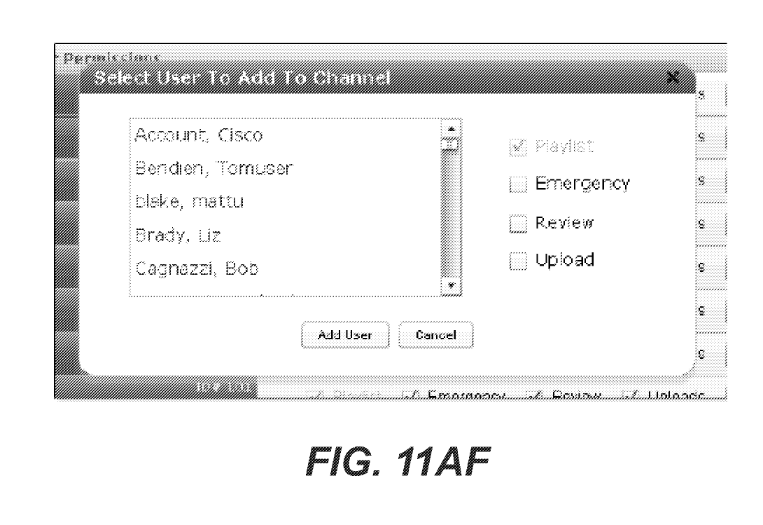

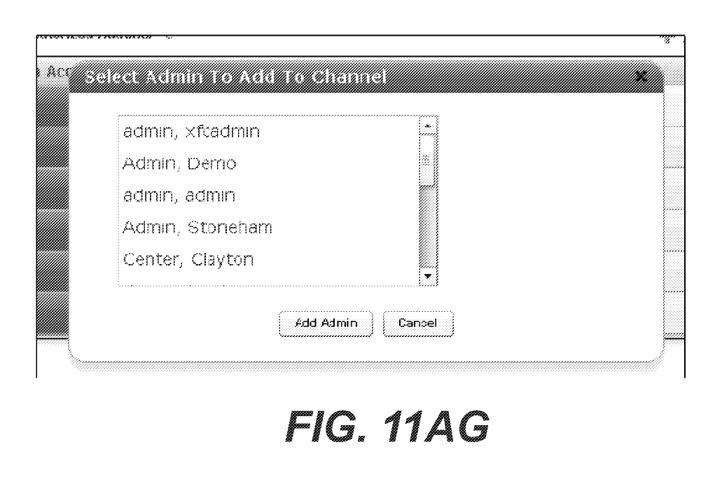

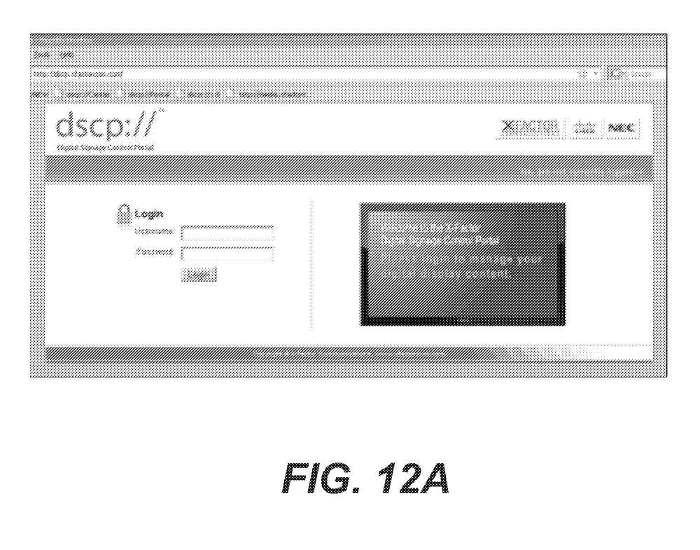

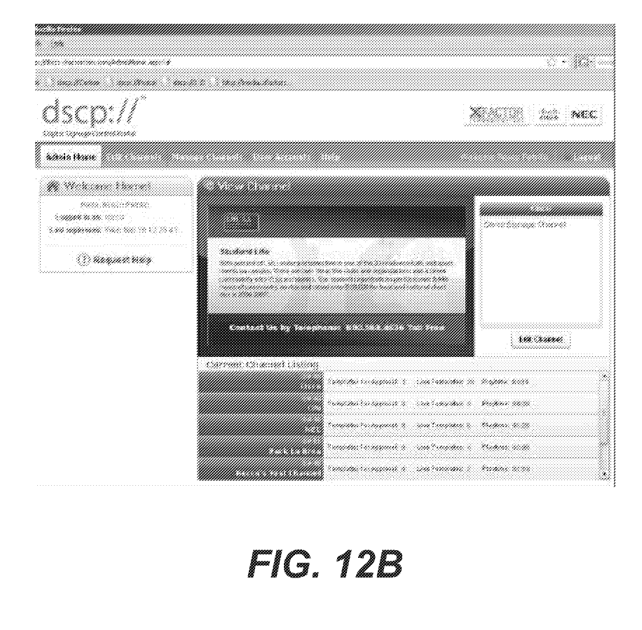

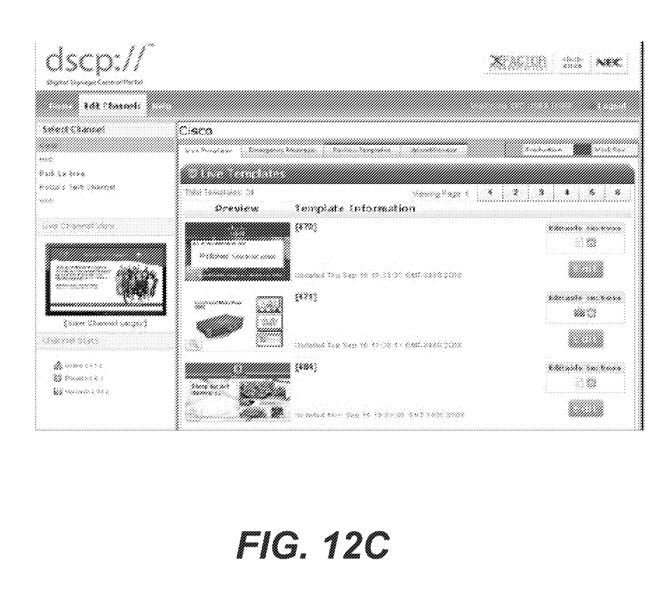

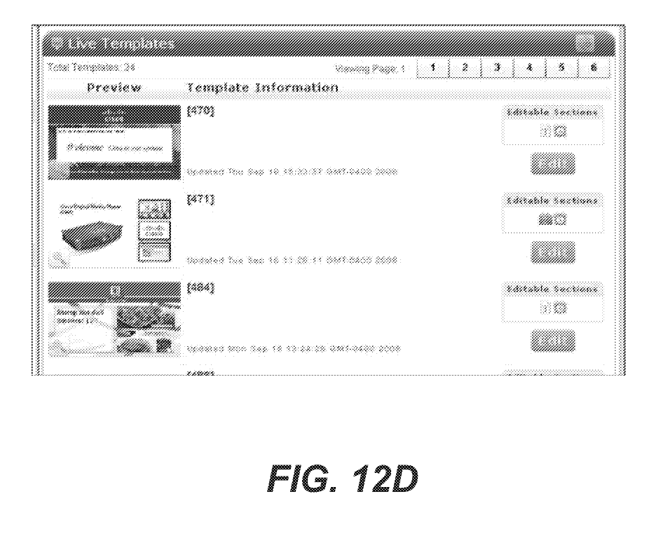

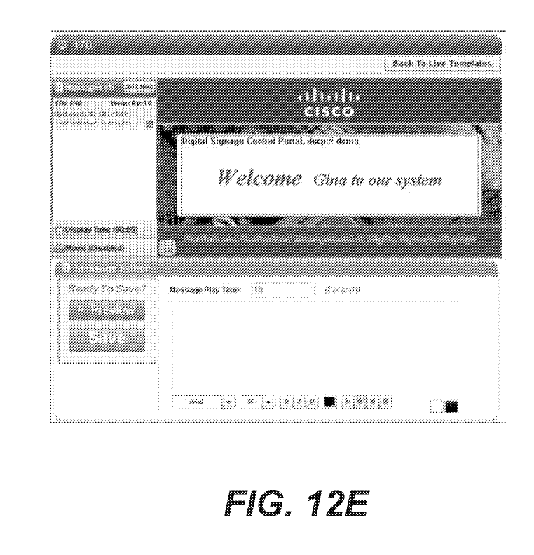

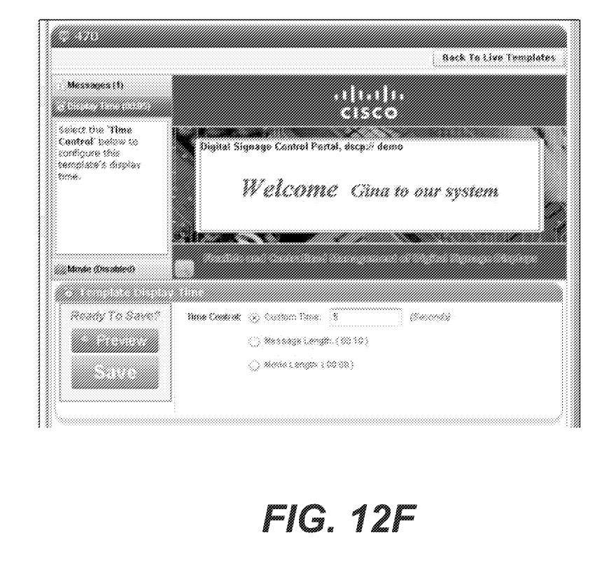

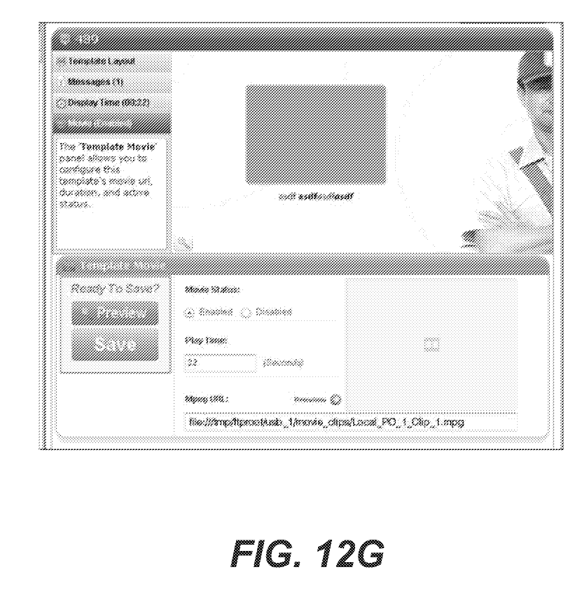

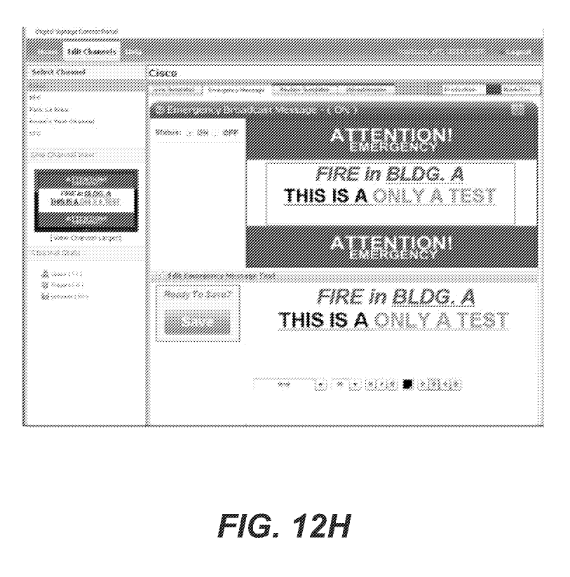

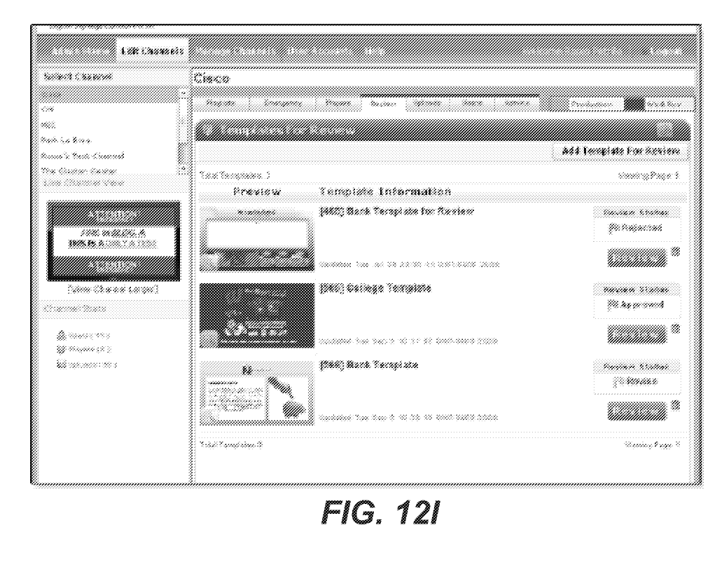

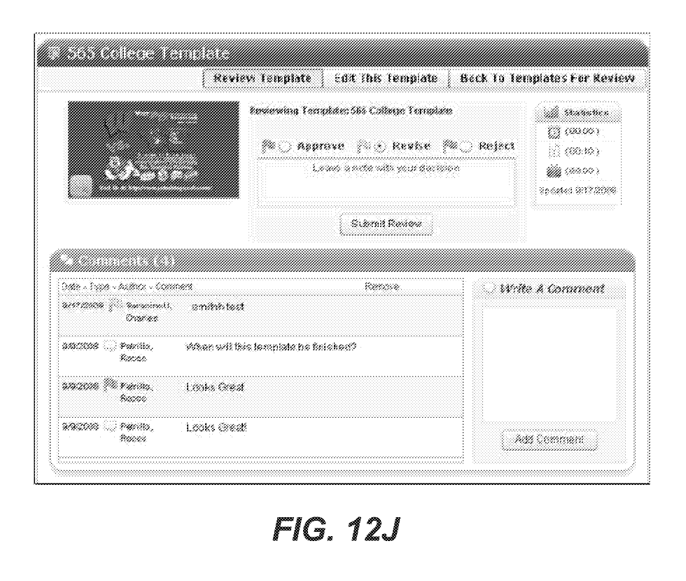

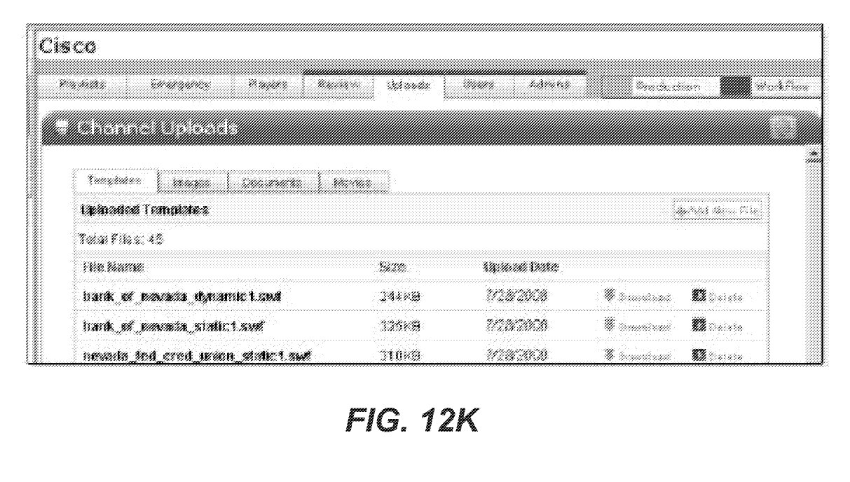

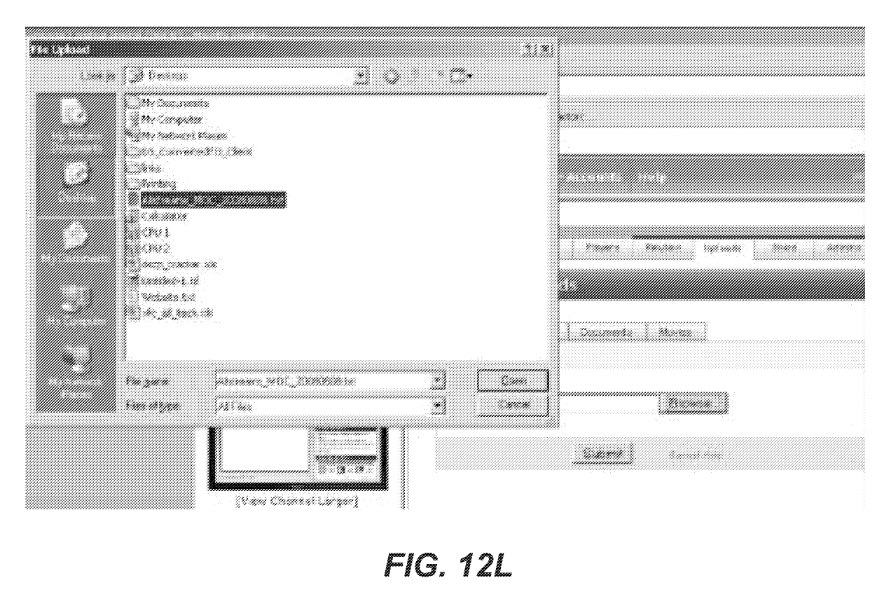

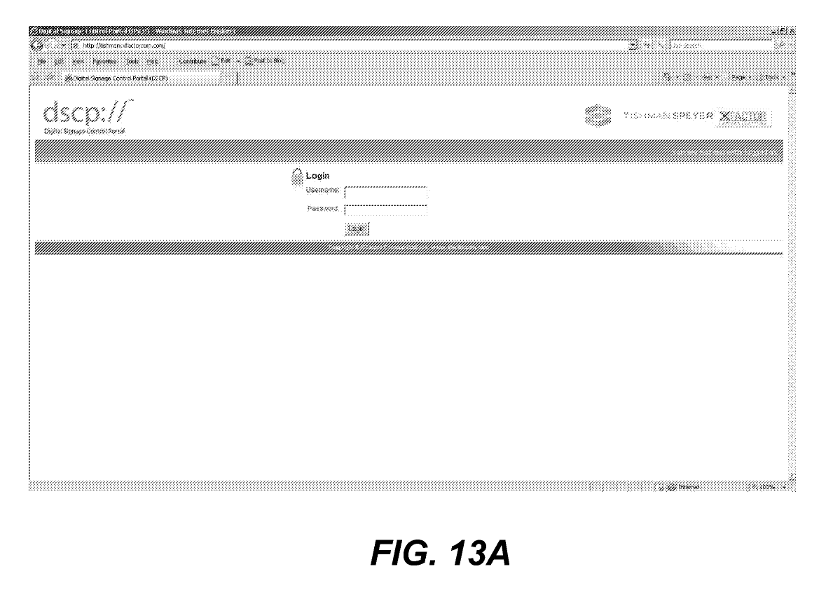

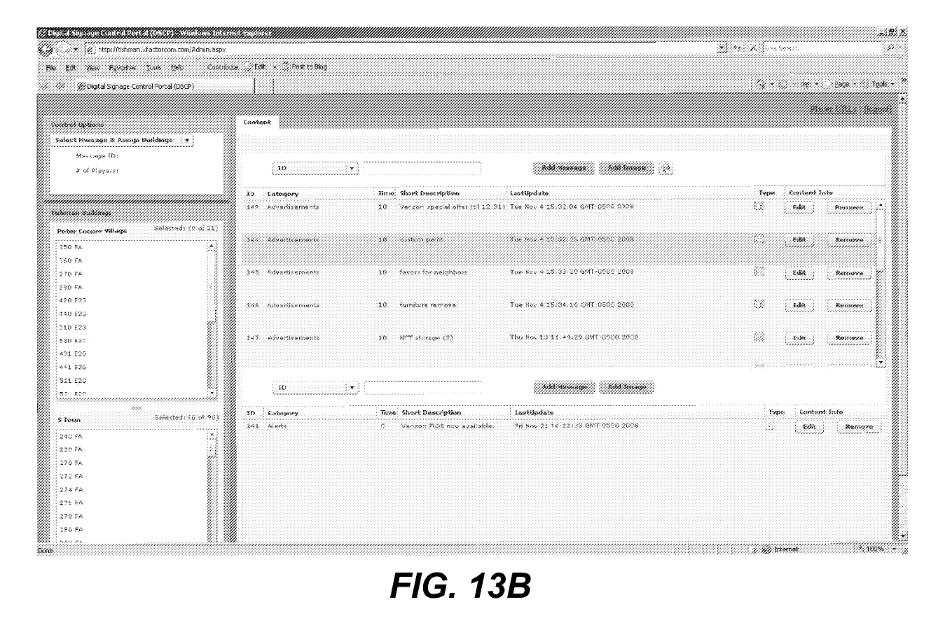

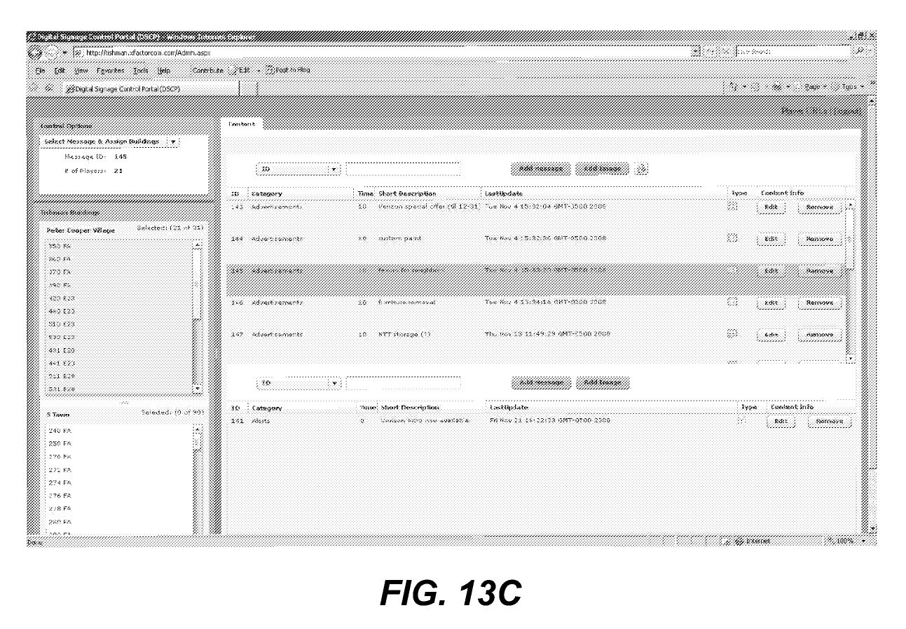

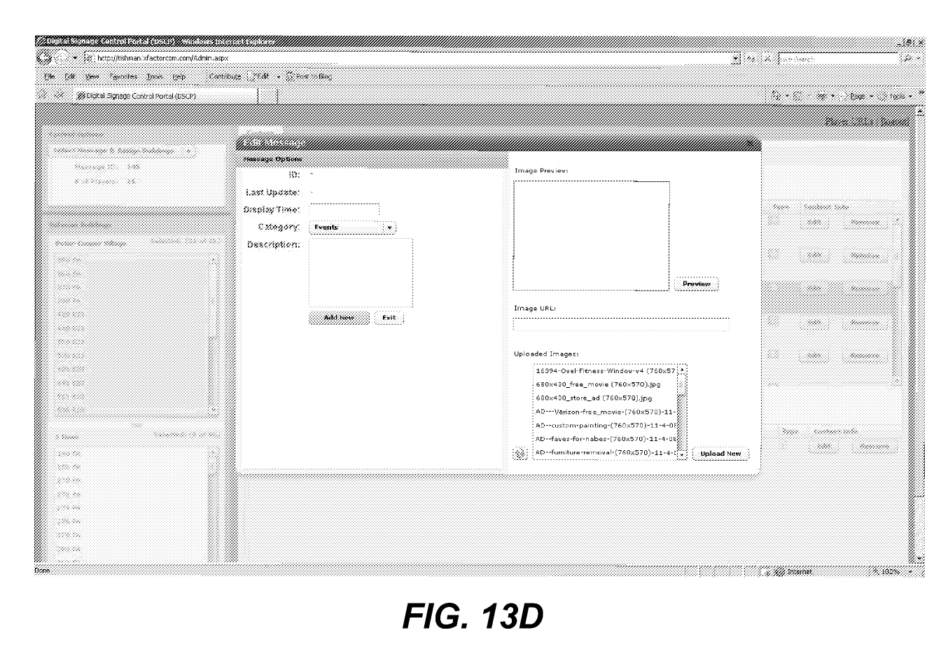

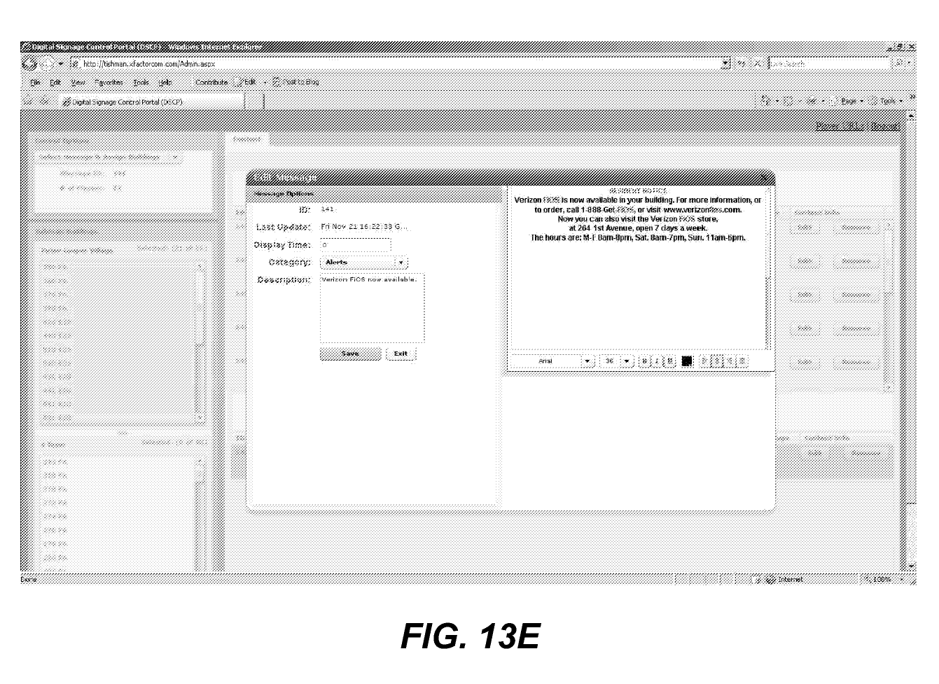

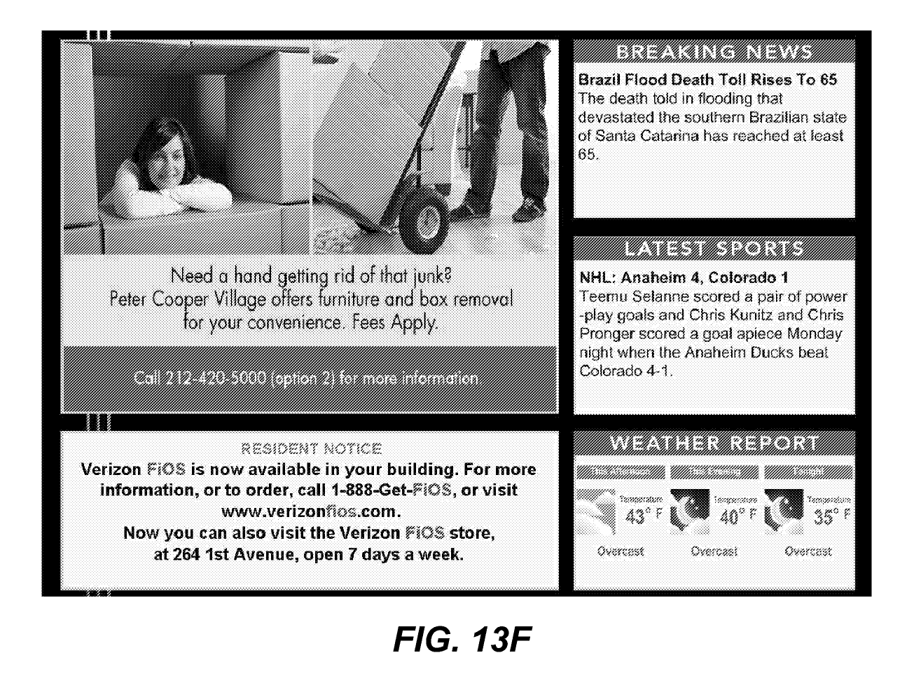

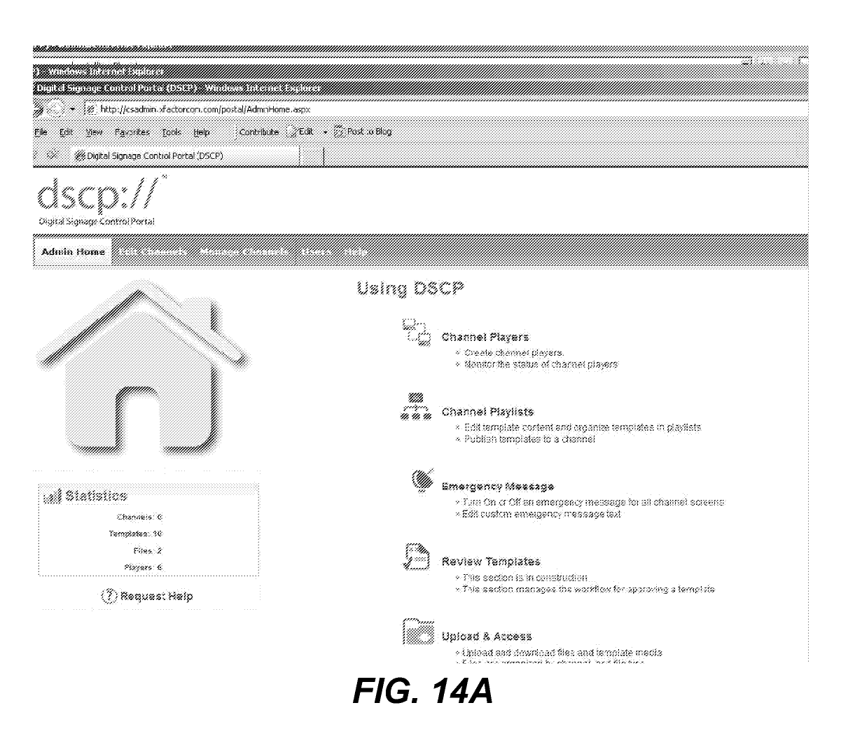

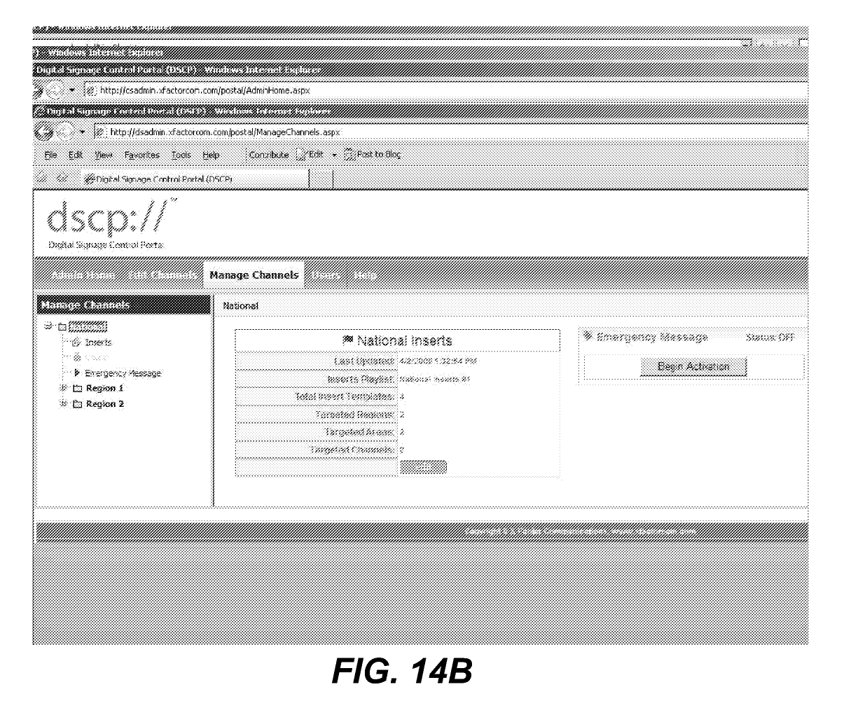

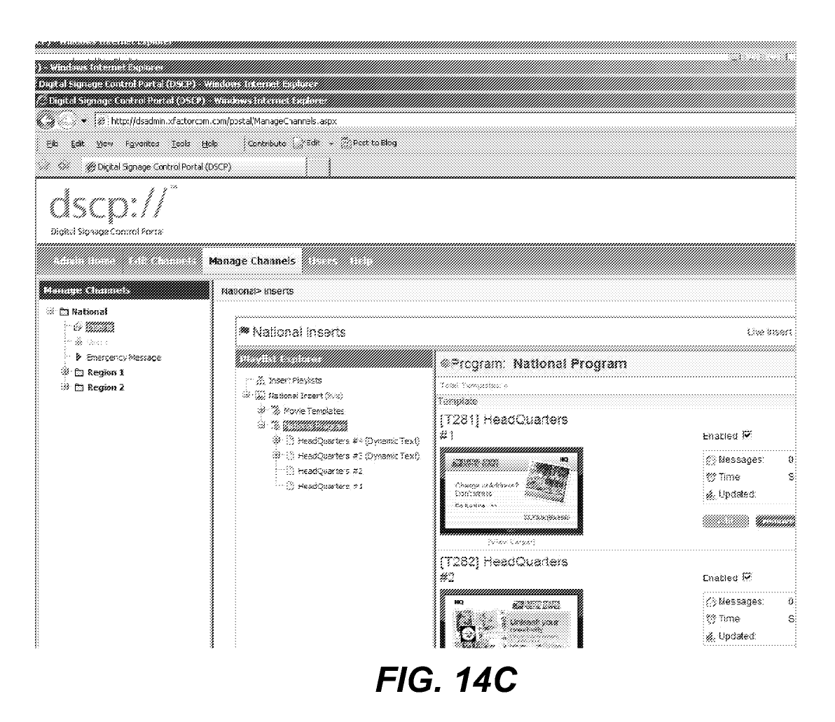

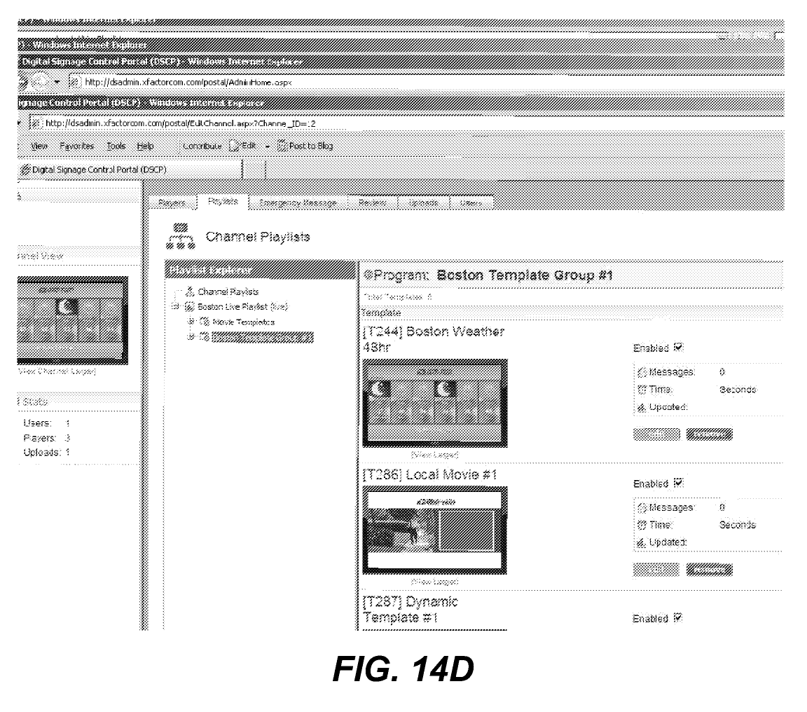

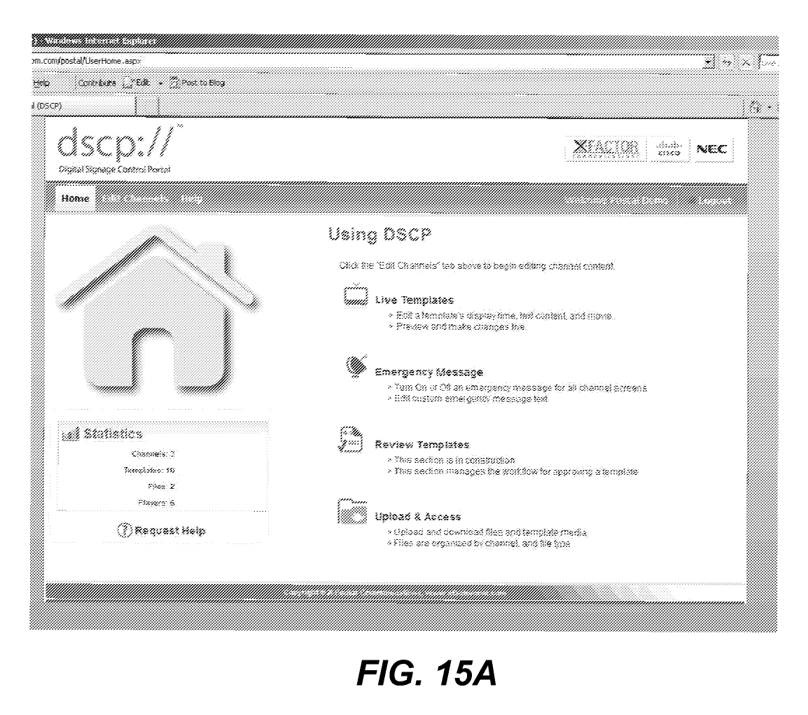

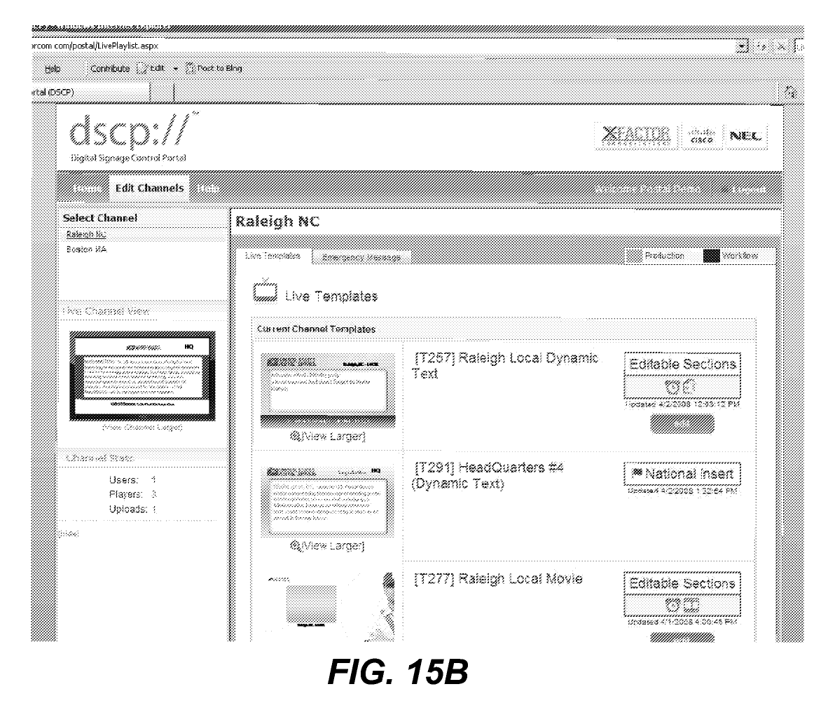

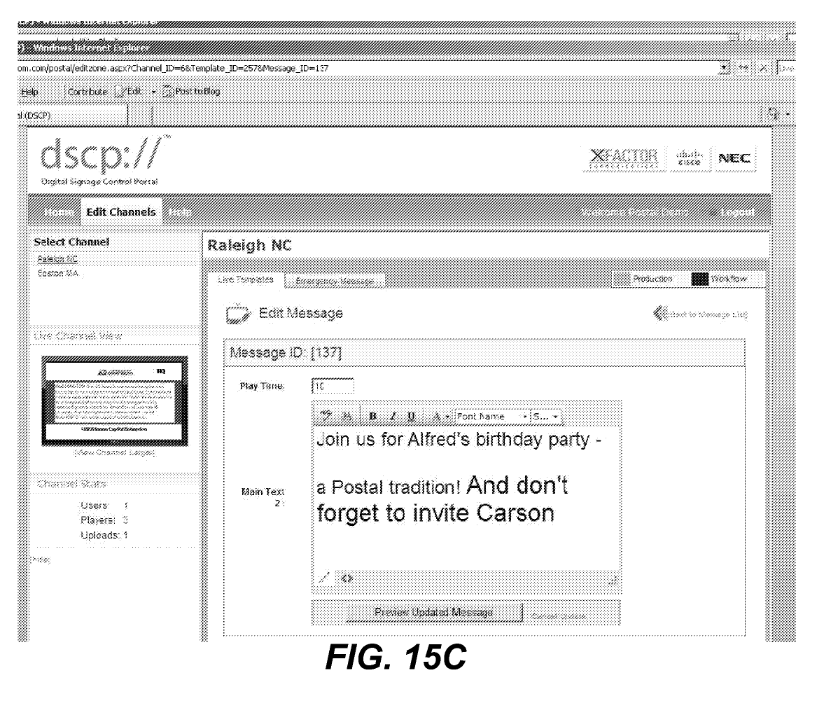

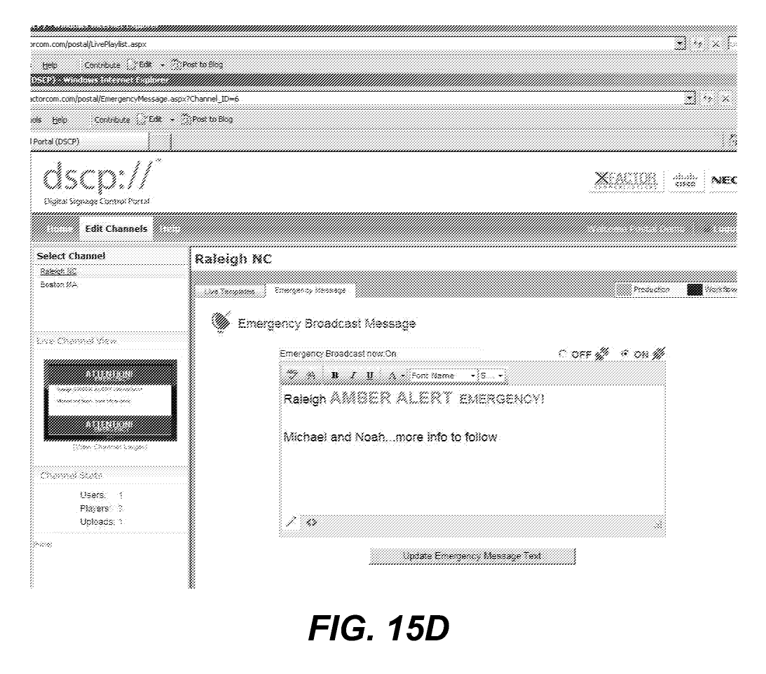

A feature can be included in a user interface such as the administratror interfaces of FIGS. 11A-11G and/or 12A-12L that allows an approval or trusted state for a user, admin, entity, etc. For example, a channel owner may want to be able to approve advertisements but may not want to have approval rights over a security guard who will have permission to set emergency displays (e.g., in real time when an event occurs). Granularity can also be controlled based on geographic region, role, company department or division.

FIG. 7D shows a plurality of types of templates. Template type 720 shows a dynamic data template which pulls data from a live data stream over a network. The live data stream may be an RSS feed for example. The live data stream may be read by a device such as control portal 102, and multimedia data may be generated based on the live data stream. The multimedia data may be combined with the template type 720 and deployed on a DMP. For example, as shown, template type 720 enables adding dynamic weather templates to display weather forecasts. Also, template type 721 shows a template with a video (pre-recorded or even live video) displayed within a dynamic area of the template and/or supporting text and/or subtitles which may be read-only or editable by a user. A new digital signage message based on template type 721 may be displayed on a DMP. Also, template type 722 shows a template with area(s) on the template that is editable by a user. A new digital signage message based on template type 722 may be displayed on a DMP. Using a user interface 723, a user may upload a template 720-722, and/or change the text on the (dynamic) template 720-722 by selecting, for example, an edit button.

FIG. 7E shows an example of a layout for template type 722. As shown, the template may include a read-only area 751 (branded for an organization), and/or a plurality of dynamic editable areas including text area 752 and list area 752.

FIG. 7F shows an example of a layout for template type 721. As shown, the template may include a read-only area 751 (branded for an organization), and/or a plurality of dynamic editable areas including text area 753, and video area 755. The video area 755 may play a video (e.g., streamed media).

FIG. 7G shows an example of a layout for template type 720. As shown, the template may include a read-only area 751 (branded for an organization), and/or a plurality of dynamic editable areas including dynamic data area 756. As shown, the data may be a table retrieved for example for a database. The data may be changed over time, on a periodic basis. The data may be retrieved from a third-party data source, such as from an organization, as an RSS feed, XML feed, or the like. The data may be requested via a database query from a database device. The data is transformed into a renderable form that can be (is) inserted within dynamic area 766 of a message of template type 720.

FIG. 7H shows an example of a layout for template type 720. As shown, the template may include a read-only area 751 (branded for an organization), and/or a plurality of dynamic editable areas including dynamic data area 756. As shown, the data may be a weather forecasts for a plurality of days for a specific geographic location (e.g., the geographic location of where the digital signage is displayed).

FIGS. 8A-8D show a process for managing creation and deployment of new digital signage messages. At FIG. 8A, a template is reviewed. A limited representational view 802 is displayed. The user can choose to approve, revise or reject the template. The user can determine the time for playing the message based on the template. If the user decides to have a template revised, the user may leave a comment in component 804. At FIG. 8B a message is set or changed and/or the play time of the message is set. Section 805 shows the template that is being displayed by a DMP. Section 807 shows an input area for updating the text of the message. Next at FIG. 8C a display of a digital signage is provided to a digital signage client device and/or to a web browser (e.g., over the Internet and/or within a password secured portal access). The rendering format for the digital sign for the client device may be different than the one for the web browser (e.g., MPEG-2 for client device and HTML/Flash for web browser). During any part of the process, at FIG. 8D, a user or automated alert may determine that an emergency has occurred. The user may create a new emergency digital signage message when the emergency occurs, or may have pre-created the message. The message may be dynamically generated based on the type of emergency and the dynamic area of the template may be populated with the dynamically generated emergency type. FIG. 8D shows a user interface for managing an emergency digital signage message. Component 810 is usable to turn on the message 811 (e.g., cause the message to appear on a plurality of channels and take priority over and/or replace the display of other types of message).

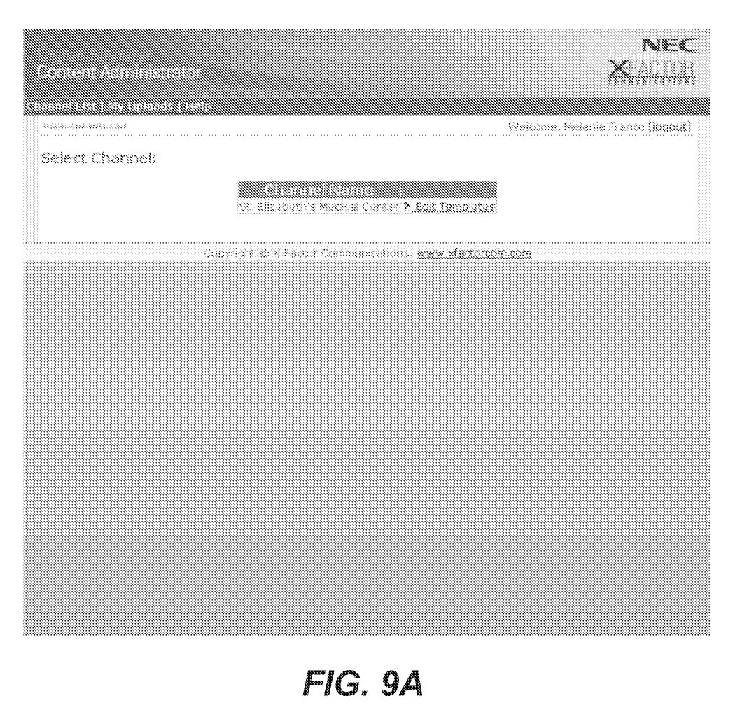

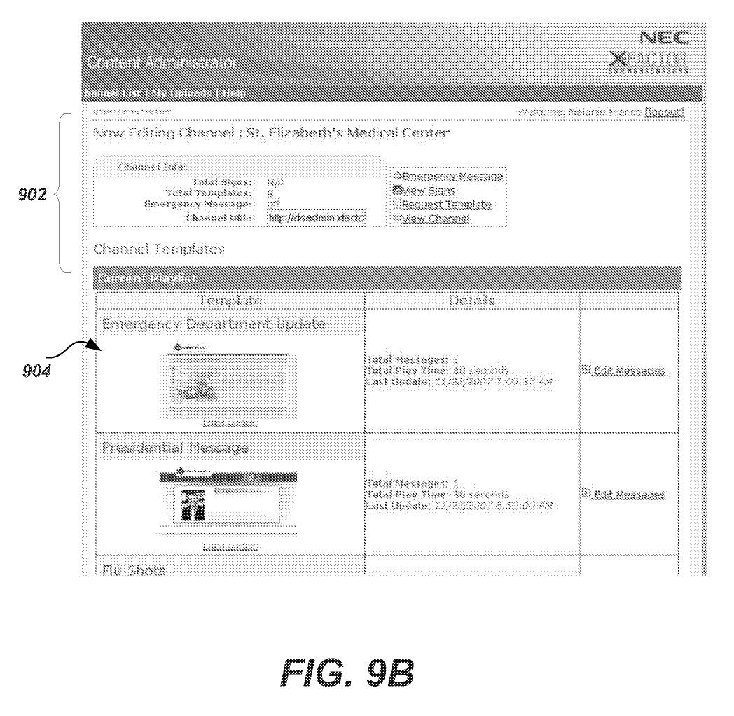

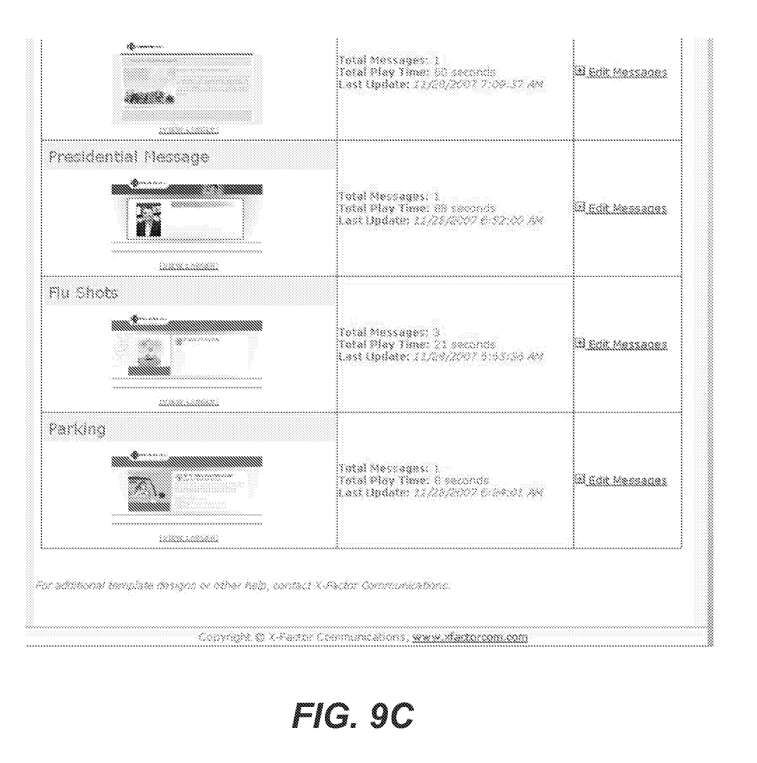

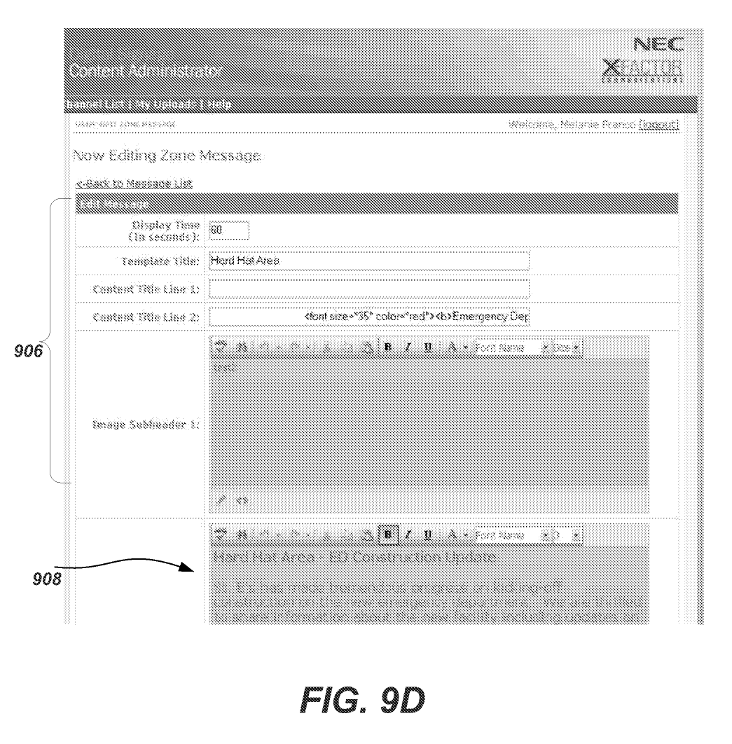

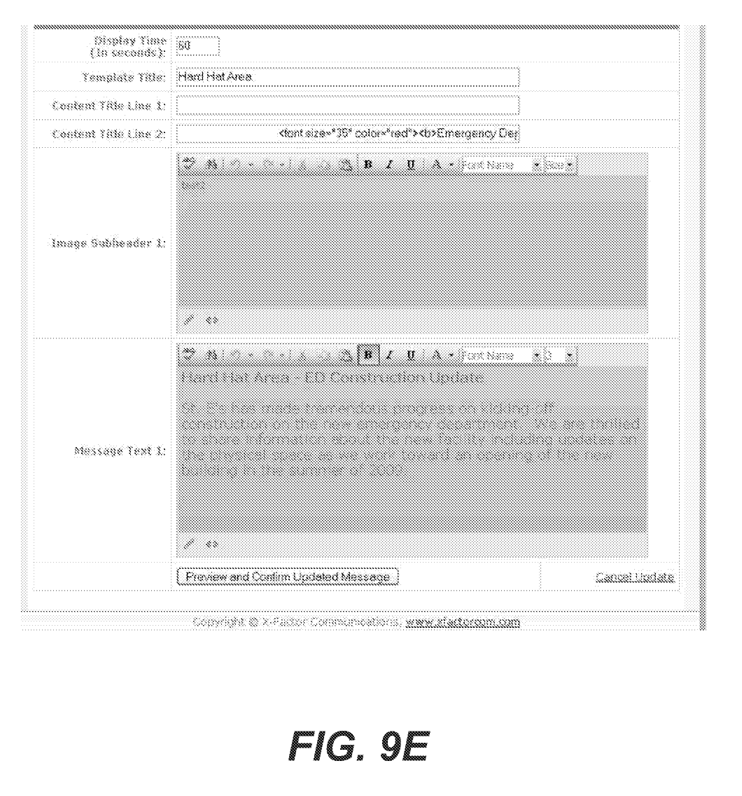

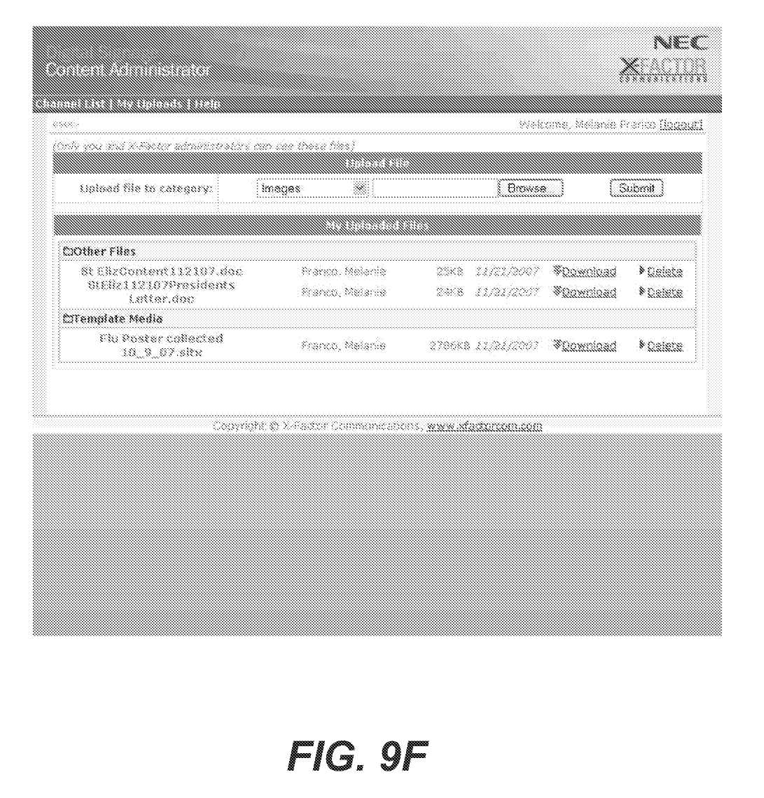

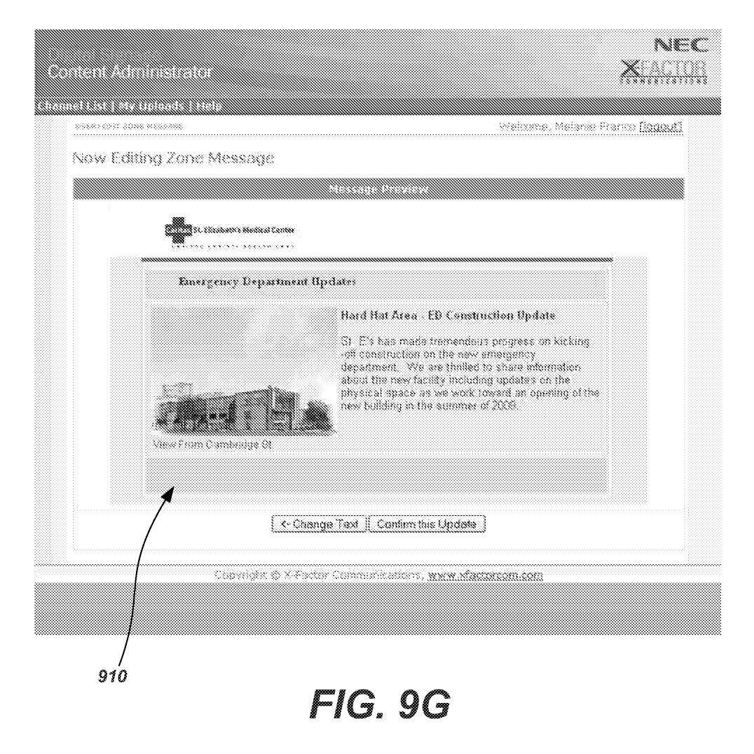

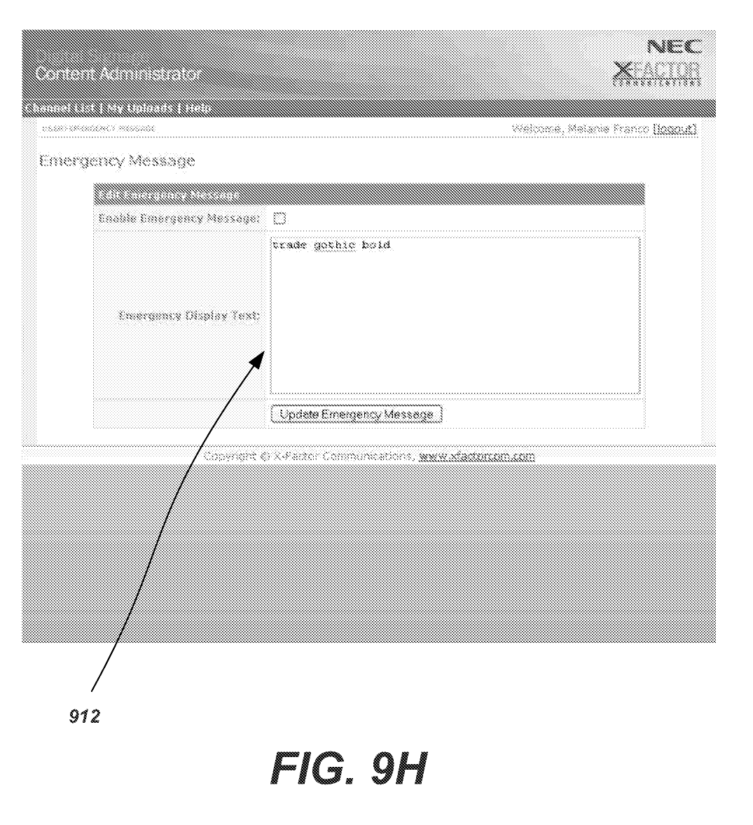

FIGS. 9A-9H show user interfaces embodying or implementing a process for managing a digital signage system for users. Briefly, the functionalities available to the user include:
Edit text on pre-defined templates.
Edit text and publish emergency messages.
Ability to preview templates once text has been changed prior to publishing.
Upload and access content for creation of templates.
Activate and publish video clips.

FIG. 9A shows a user interface for selecting a channel to manage. After selecting a channel, at FIG. 9B-9C a user interface for editing a channel is provided. The user receives statistics 902 about the channel, such as total signage, total templates, whether an emergency message is turned on, the channel' URL, etc and/or a playlist comprising template(s) 904. After selecting a template/message to edit, the message may be edited with the user interface shown at FIG. 9D-9E. The user may edit the message information 906 such as display time of the message, the titles, images, etc., and/or text content 908. At FIG. 9F, media may be uploaded to the system for use in editing the message (text content, images, etc). At FIG. 9G, a preview of the message 910 is provided, and the user can confirm the update. At FIG. 9H, an emergency message 912 may also be edited. The emergency message may also be previewed and confirmed as described above.

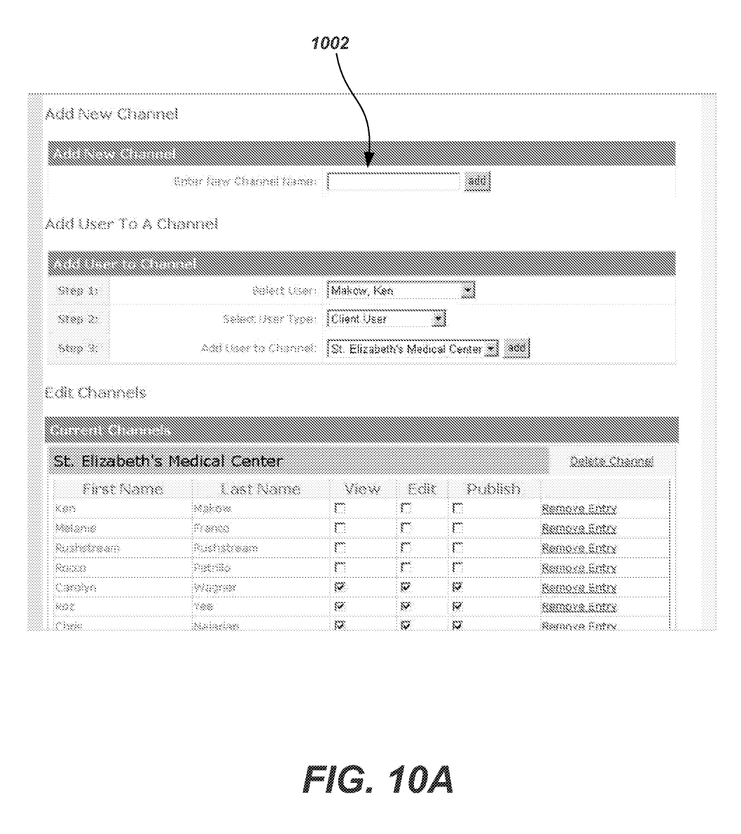

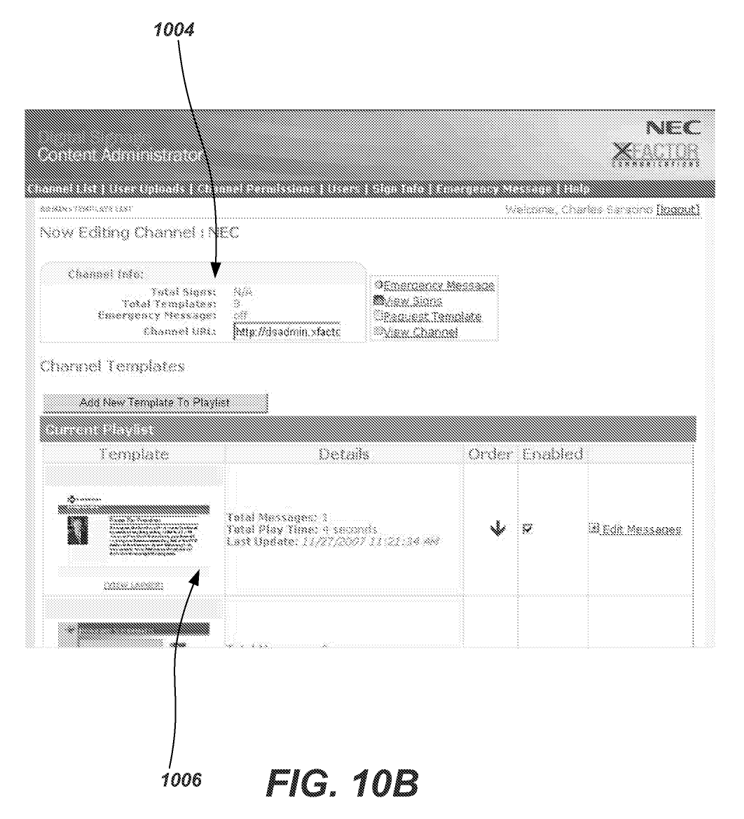

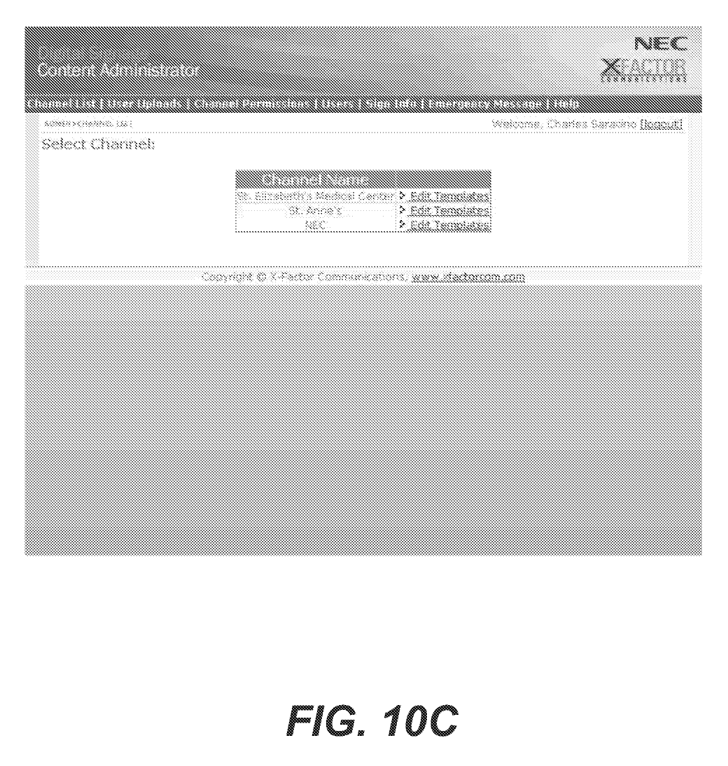

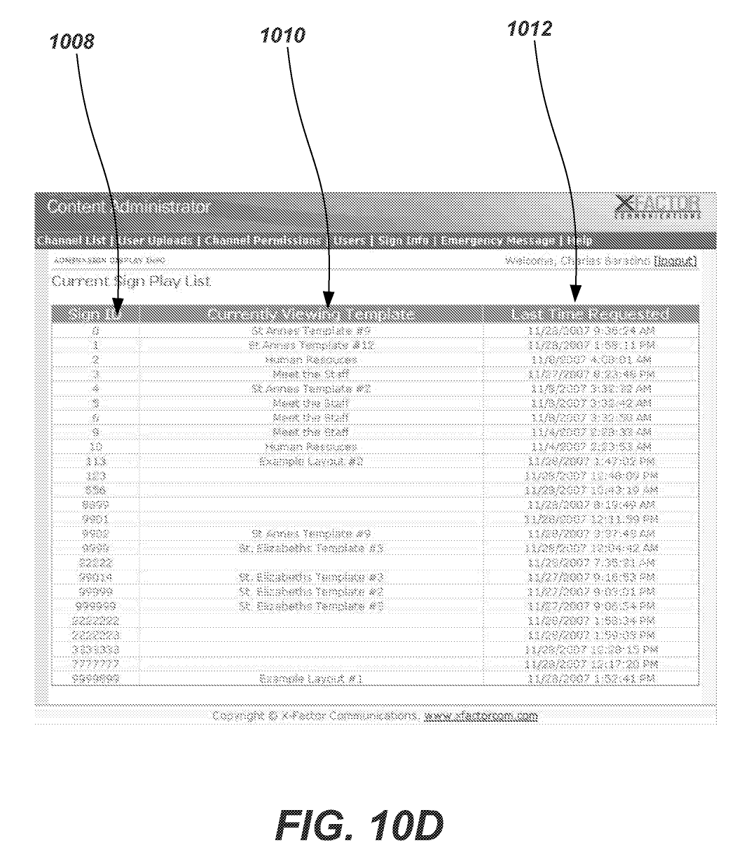

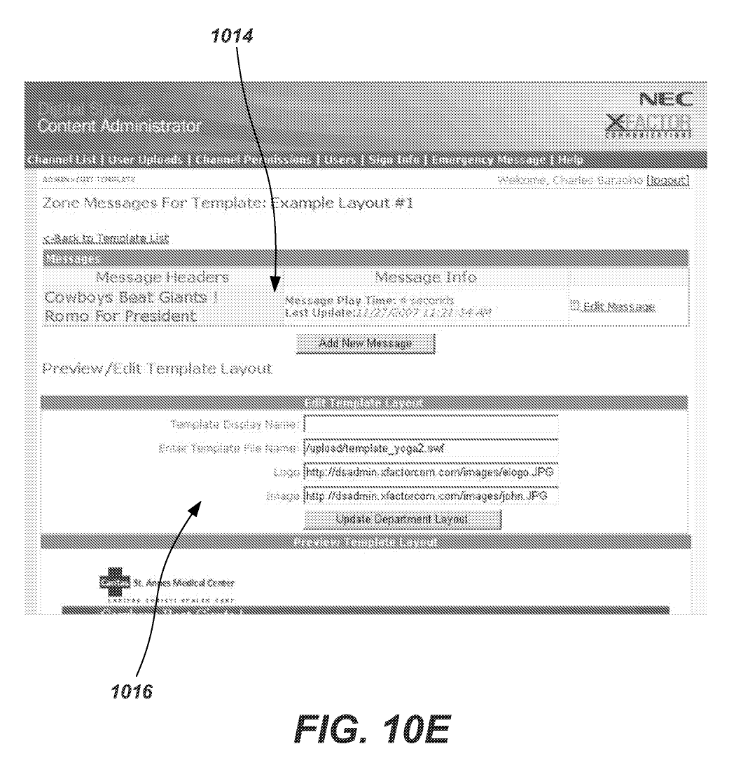

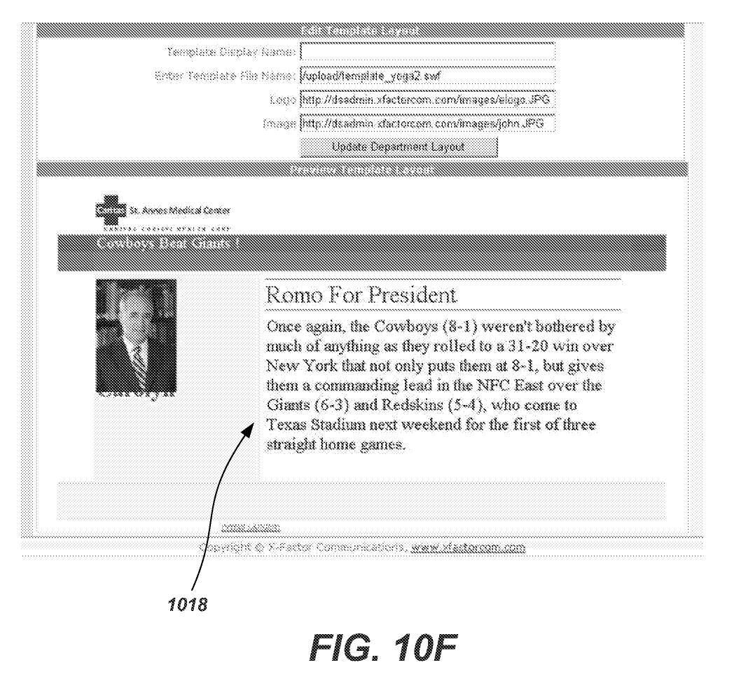

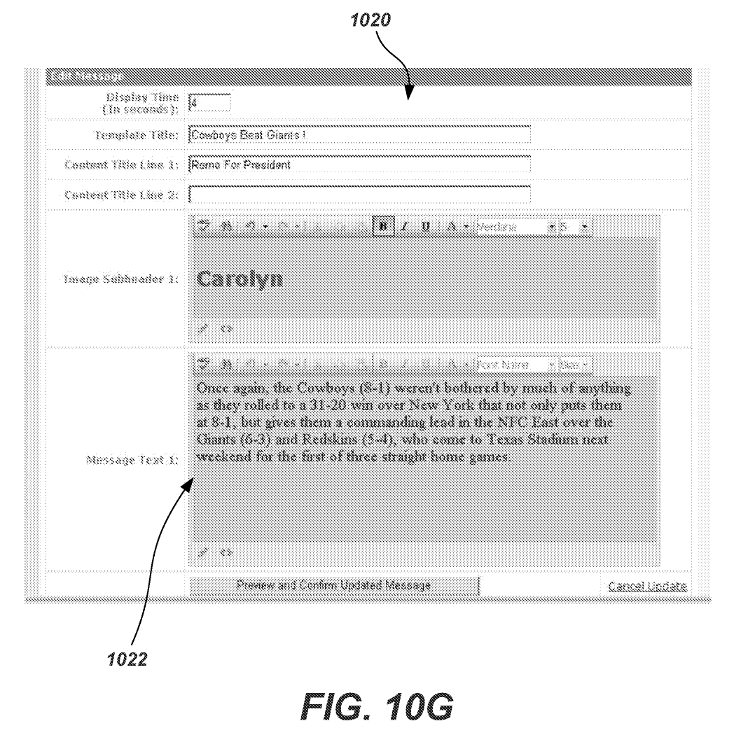

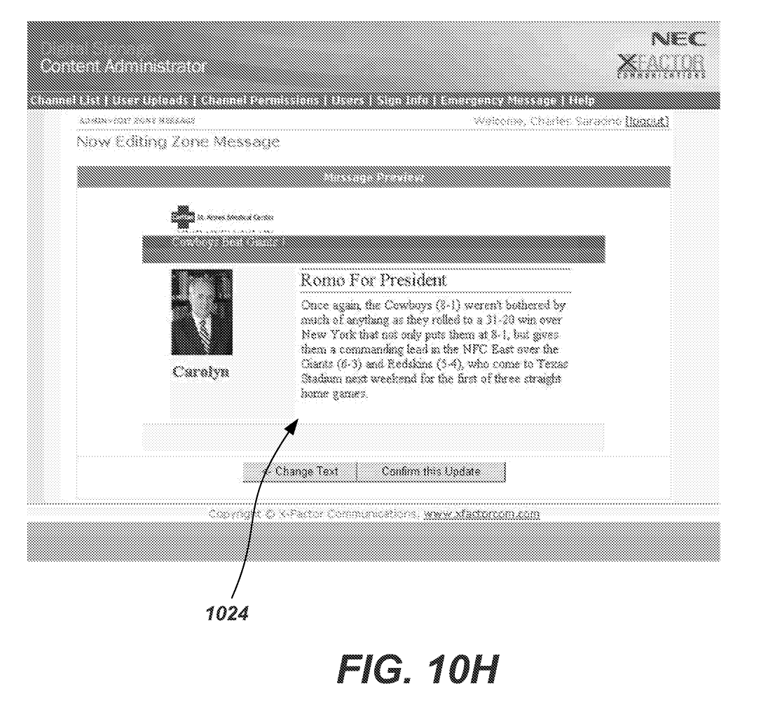

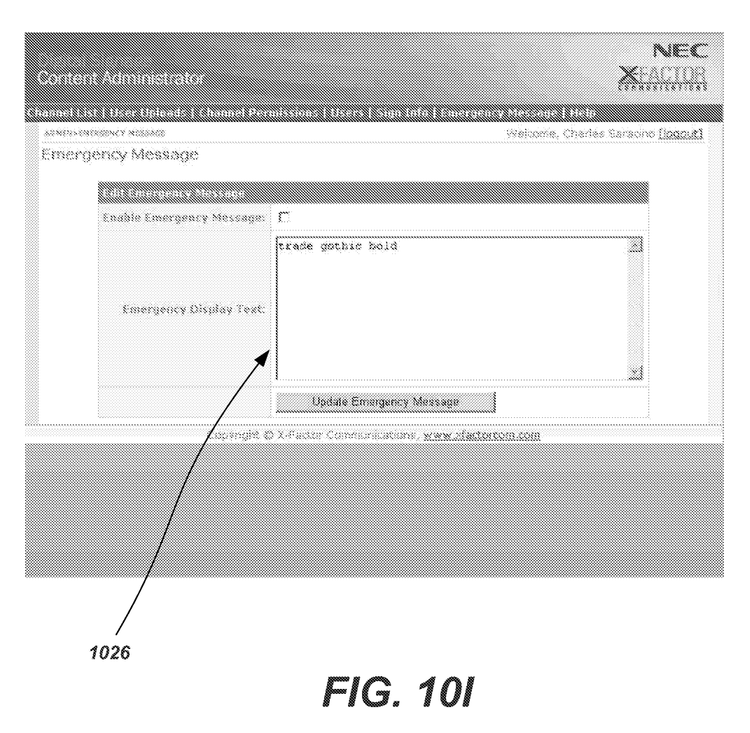

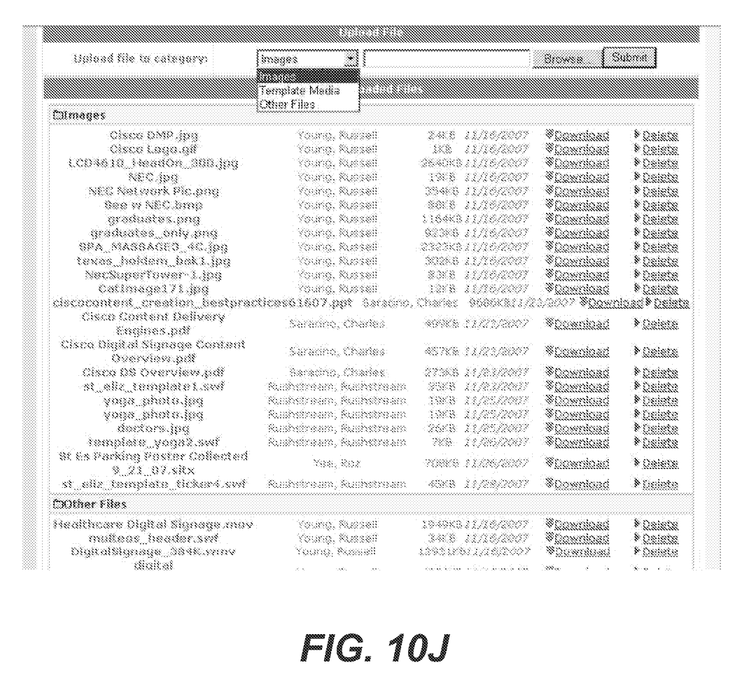

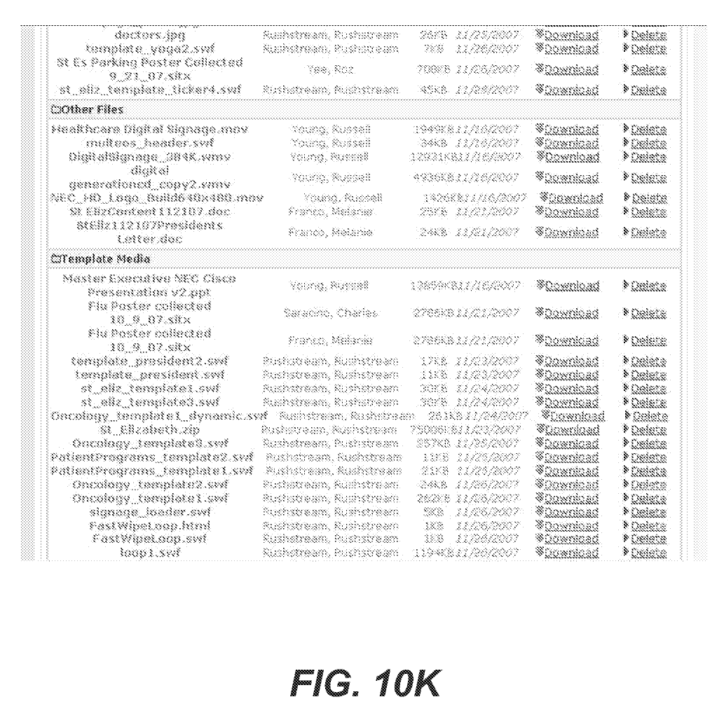

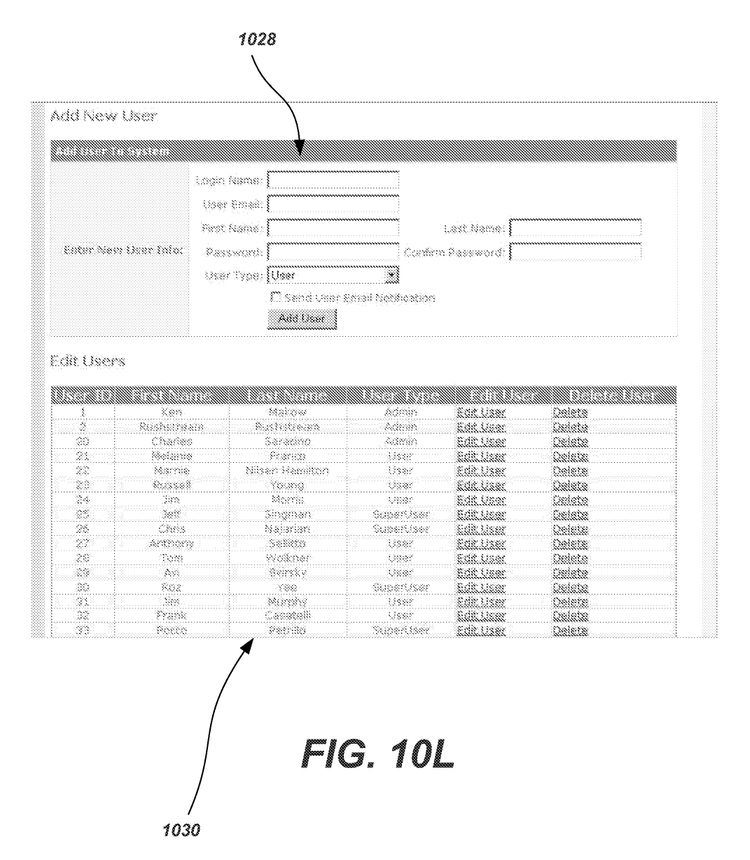

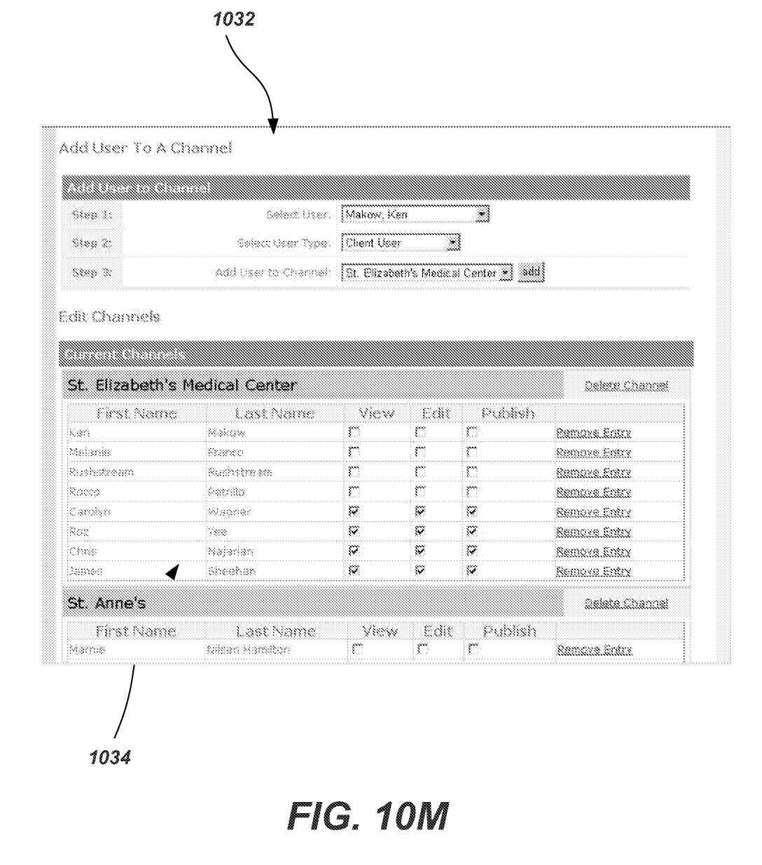

FIGS. 10A-10N show user interfaces embodying or implementing a process for administrating a digital signage system for an administrator. Briefly, the functionalities available to the administrator include:
Assign user access to designated personnel to obtain rights to specific channels and features within those channels.
Manage playlist programs, templates and messages within the channel. For example, turn templates on and off, edit templates, change order of templates, play video through templates, add graphics to templates, create and publish emergency messages.
Monitor status of the Digital Media Player (DMP).
Review Work-in-Progress templates from creative design group.
Assign rights for upload and access for creation of templates.

A customer administrator may designate a primary administrator and sub administrators, and may authorize the sub administrators to have updating authority over certain channels and or certain templates within certain designated channels. A customer may be an organization, association, or the like. The user interface components may be a web based application which provide customers with the functionality to enable the administrator access to the system and enables update of digital signage content over a digital signage platform that can deliver content to digital signage displays. In one embodiment, customer administrators can access the application via an SQL user name & password entry. Customer administrators can designate primary administrators and/or sub administrators, and/or enable allow primary administrators to designate sub administrators. The administrator(s) can be enabled to choose a digital signage channel, templates within a channel, messages within each template, etc. The template may be edited or updated. The administrator(s) can create a new message. An administration console/dashboard can enable different categories of users to create new channels, demonstration channels, new user access, monitor who and when most recent updates were made to a channel along with other related features and capabilities. Customer administrators can access the application console/dashboard, for example via the web.

At FIG. 10A, a user interface is provided for an administrator to select a channel to manage. The administrator may also add a channel 1002 by entering the channel name and clicking add. At FIG. 10B, the administrator may manage a selected channel. For a channel that has already been created, the user may navigate to the channel via the “Channel List” menu item and receiving the interface at FIG. 10C, from which the administrator may choose to edit the templates of a particular channel.

FIG. 10B shows the administrator managing the channel “NEC.” The administrator receives statistics 1004 about the channel, such as total signage, total templates, whether an emergency message is turned on, the channel URL, etc and/or a playlist for the template. Statistics launchable from FIG. 10B includes a history of the proof-of-play for particular messages, for particular templates, and/or for particular channels. FIG. 10D shows an example of a history of the proof-of-play showing Sign ID 1008, currently viewing template 1010 and the last time requested 1012 for which the live template was played. The proof-of-play may be stored in processor readable media, may be displayed in a variety of formats, including graphs, charts, etc, may be useable by a program to calculate a cost of advertisement (e.g., using a function that increases advertisement cost proportionally with an increase in proof-of-play), or the like. Referring back to FIG. 10B, the administrator can add a new template to the playlist, or select a template 1006 within a playlist to further manage.

At FIG. 10E-F, the administrator may edit a template. The administrator may enter template information 1016 such as display name, file name, logo, image, etc. The administrator may also be shown a preview of the template. The administrator may also be provided with a list of current messages 1014 for the template along with associated statistics (play time, last updated). The administrator may be enabled to edit the message 1018 or add a new message for the template.

At FIG. 10G, the administrator can create or update a message for a template. The administrator can enter message information 1020 such as the display time (duration) (e.g., in seconds), the template title, message titles, any images and/or other content 1022 (e.g., text, movie, data stream, etc). The administrator can review and confirm the message at FIG. 10H, where a message 1024 for the template as it would be displayed on a digital signage client device is shown. The administrator can confirm the update and thus save and enable the message to be published (or approved for publication by another user).

The user interface components of FIG. 10G-H may also allow managing an emergency message. FIG. 10I shows an interface for managing an emergency message. The emergency message may be enabled (e.g., with a button click, thus overriding other messages in the channel). The emergency message text 1026 may be updated, and the emergency message may be updated (published). In one embodiment, the emergency message may be published without needing approval by another user.

While updating a message or template, the administrator may wish to select, use and/or upload certain content (text, documents, multimedia) for use with the template/messages. At FIG. 10J-K, a list of content usable within the templates/messages (as images, icons, movies, etc) is provided. The administrator may also upload content of a particular type to the system.

FIG. 10L-M show an user management component that enables an administrator to add a user to the system, to designate a primary administrator and/or sub administrators, and to authorize the sub administrators to have access and updating authority over certain admin functions, channels and or certain templates within certain designated channels. FIG. 10L shows an interface for designating user types for a user. A user's information 1028 such as name, email address, password, and user type may be entered. As shown, current users 1030 may also be edited or the user may be deleted. For example, at least four (4) types of administrators may be designated:
1. Primary Administrators have access to all admin and editing functions including view, edit & publish all channels as well as access to all customer uploads
2. Sub Administrators have access to all admin and editing functions as well as access to all customer uploads except publishing & emergency message, channel creation/access and user creation
3. Sales Administrators have access certain designated channels for sales presentation and demonstration purposes as well as access to designated customer upload. View only designated channels, e.g., a demo channel the user can use to view, edit & publish messages
4. Project Mgt/Design/Developers have access to just the channels designated to that individual as well as access to designated customer uploads

FIG. 10M shows a user interface for administrators to designate certain content management permissions to users. As shown, for a channel, a user may be added (1032) to a channel, and/or current users 1034 may be provided view, edit, publish permissions or may even be removed from the channel. These permissions can for example include:
Customer permission level (e.g., for Customer Users): Users are authorized will administer the set up of who has access to various channels to view and/or edit via the registering of user names and passwords. Once the registration of a user has taken place an automated email notification would be generated.
Channel List Permission: Users enabled to choose a channel from a pull down menu they would like to view or edit.
Channel Access Permission: Users are authorized to administer who has access to various channels to view and/or edit
Sign Info Permission: Users are authorized to retrieve an up to the minute account displayed as to the playing status and most recent edit made on each message
Emergency Message Permissions: Users have the ability to create and publish an emergency message on any channel within the system.
Content Browse Permission: Users will be able to access and browse thru content uploaded from different customers per customer/channel.
Play list Edit Permission: Users can enter info into a form to communicate to XFC instructions on how to update their channel playlists. The form will communicate info on such items as template/message deletions, additions and timing instructions.
Content Review & Approval Permission: Users (e.g., CPA) can review CPA's message updates via an automated email with a screen grab of the pending message update sent to the CPA for approval.

FIGS. 13A-13F show another level of granularity in that permission can be assigned based on the zones or components of a template. A user logs in at user interface 13A. At interface 13B, a user selects a portion of a message to create or edit (e.g., ID 144 of type Advertisements). At interface 13C, the user selects a plurality of channels/templates to edit using the selected portion of the message. As shown, 21 items for “Peter Cooper Village” is selected. At interface 13D, the message portion is created/or edited, including particular fields such as ID, Display Time, Category, and Description. At interface 13D, the message portion is entered. The portion may be a top left zone of a display. Digital signage 13E shows and edited message with the edited message portion. Digital signage 13F is one of a plurality of templates/channels modified with this edited message portion. As shown in this example, the message portion may be exclusively controlled by a particular administrators. Several message portions may be managed by different administrator types, for example the upper left portion may be controlled by a managing agent for a building complex, the lower left can be controlled by a building superintendent, and the right may only be controlled by super admin or platform provider. This way, the upper right can be dynamically update independent of the other zones an the lower left can be locally controlled with affecting or requiring approval from the higher level of authority.

FIGS. 14A-14D and FIGS. 15A-15D illustrate processes for managing digital signage, including providing a syndication of messages across a plurality of different channels or even customers. At FIG. 14A, an administrator logs into the system and may be provided various choices (e.g., managing channel players, channel playlists, emergency messages, templates, and uploading data and managing access to other entities).

At FIG. 14B, the administrator may select to manage a channel (e.g., using a menu bar). The channel management maybe hierarchical, wherein an administrator may chose to manage messages or portions of messages at a national level, regional level, or even at an area level. The national channels may include a plurality of channels for a plurality of regions. Regional channels may include channels for a plurality of areas, or another sub-geographical area (e.g., building). As shown, in a tree menu is provided to an administrator with the proper permission. The administrator is provided a choice to manage “Insert” portions (of a message) for more than one channel at the national level. The administrator is provided a choice to manage messages (e.g., emergency messages) for more than one channel a the national level as well. The tree menu may provide management of a plurality of channels or messages at the regional level in a similar fashion.

As shown in FIG. 14B, an Insert portion may be targeted to certain types of templates, programs, playlists, regions, areas, or channels. Also as shown, an emergency message may be activated at the proper level (national, regional, area, etc).

At FIG. 14C, the Insert portion may be created by an administrator and embedded within particular templates, programs, playlists, or such structures for regions, areas, or channels. These Insert may be edited by the administrator, and reused across templates. These Inserts may be editable by an administrator with proper permissions, but not editable by a user who creates a message based on the template that includes the Inserts. As shown, National Insert may be inserted or targeted into a Movie template and a National Program, which comprises Headquarters template #1-#4. The National Insert may for example, be a common logo on each of the templates, as shown. The “local” editable portions of the template (but not the National Insert) may be editable by users/administrators having permission at the local level.

At FIG. 14D, the administrator may continue to edit various templates (movie, weather, etc). As shown, a thumbnail may provide various resolutions. The administrator may click on the icons to bring up a higher resolution image which shows more legible text, for example. Also, the templates managed may but need not have Inserts.

At FIG. 15A a user logs into the system (e.g., managing live templates (i.e., messages), emergency messages, reviewing templates, and uploading data and managing access to other entities).

At FIG. 15B, the user may manage a live template/message. As shown, the templates may have editable sections (portions), and/or Inserts (non-editable), among other things. The user may edit the editable portion of the live template/message, but may not edit the Inserts, e.g., because the user lacks permission to edit the Inserts.

At FIG. 15C, the user edits a message using a text editor and/or updates the messages causing the message to be queued for approval and publishing. The user may preview the message (e.g., in a thumbnail of various resolutions).

At FIG. 15D, the user may edit an emergency message. In one embodiment, the message may be published immediately without requiring approval, by, for example, clicking on the “Update Emergency Message Text” button shown.

FIGS. 11A-11AG show an example of a process for an administrator of a digital signage system to manage user access and/or digital signage. The process of FIGS. 11A-11AG may be limited to users of a particular user type, such as Primary Administrators.

Admin Login

FIG. 11A shows a login screen 1108 for an administrator. A browser such as either Microsoft's Internet Explorer or Mozilla Firefox, or the like may provide the login screen. The administrator can navigate to the address where the system is located using, for example, a web browser. At this page the administrator can type in the username/password and can click login.

Admin Home

Once the administrator has logged in, the administrator is brought to the admin homepage 1110 as shown in FIG. 11B. The admin homepage gives the administrator an overview of the Digital Signage for an organization. On the upper left of the page is an info box explaining the administrator's account information (Logged in as, Last Login, etc.). Under the “View Channel” bar, is a display showing the administrator their selected channel in the “Current Channel Listing” section below. On the right of the display is a box listing the channel name that is being showed on the display. It also lists the channel description that is given to a channel when the channel is created. By clicking edit channel in this box, it will bring the administrator into the selected channel to edit its properties.

Manage Channels

FIG. 11C show a screen 1112 for managing channels. In one embodiment, an administrator can click on the “Manage Channels” tab 1114 located on the top bar. Under this menu item, the administrator can create channels. Channels can be used to associate content to be viewed in one or multiple locations. Data representation and functionality for the channel may be organized similar to a network television channel, where a number is assigned to all different kinds of TV shows, Commercials & Movies which can also be played out to one or multiple televisions. For example, the administrator can create a channel with the name “Cafeteria,” and all content that is entered in this Cafeteria channel (menu's, hours, etc) will be displayed out to the digital displays that are located in the Cafeteria in one or multiple buildings.

Adding a Channel

FIG. 11D shows a user interface 1116 for adding a channel. To add a channel, the administrator can click the add channel button 1118 located on the left side of the screen. A dialog box will appear. Add a name in the “New Channel Name” field and click “Add Channel.”

Editing a Channel

FIG. 11E shows a user interface 1120 for editing a channel. To edit a channel after the administrator has created the channel, the administrator can click the edit button 1122 under the “Current Channel Listing” bar for that channel. A dialog box will appear where the administrator can view channel name and give it a description in the “Channel Description Box.” The administrator can also give the channel a new name by entering a new name in the “Channel Name” field. Once the administrator has updated the fields, the administrator can click “Update Channel” for the changes to take place.

Deleting a Channel

To delete a channel the administrator can click the “Delete” button located under the “Current Channel Listing” for that channel.

Refresh Button

Icon 1102 shown in the diagram is a refresh button. The refresh button can be used under some menus.

User Accounts

FIG. 11F shows a user interface for managing user accounts. The “User Accounts” menu item is where the administrator can setup user accounts and user types.

Adding a User

FIG. 11G shows a user interface 1124 for adding a user. The administrator can click on “Add User,” and a dialog box 1126 will appear. The administrator can fill in all information and click “Add User.” The administrator can click “Edit” to edit the channels properties. “Delete” will remove the channel from the system. In one embodiment all, or substantially all assets associated with that channel (templates, programs & playlists) will also be removed.

User Types

FIG. 11H shows a user interface 1128 for editing a user type of the user. Under “User Type,” the administrator can select what type the user can be. Such types for example include:
Super Admin: This user type has access to all of the system functions and features.
Admin: This user type has access to all “Edit Channel” features but does not have access to “Manage Channels” or User Accounts.
User: This user type can edit messages, emergency messages, review templates and upload files. Emergency message, review templates and the upload feature can be turned on or off for these users. If all features are turned off, the user may be limited to seeing the playlist of templates for that channel.

Edit and Select Channel

FIG. 11I shows a user interface 1130 for editing channels. The “Select Channel” 1132 section appears on the upper left hand of the screen of FIG. 11I. Once the administrator has created a channel under the “Manage Channels” menu item, the channel will appear in this box. Here is where the administrator can select a channel that the administrator wants to edit. In some cases there will be a need for one channel, and in others, there is a need for multiple channels. For example, the administrator may want to have one set of content being displayed on media players and displays, where one channel is needed. In other cases if the administrator wants different content to be displayed on different media players and displays, the administrator can create multiple channels.

Playlists

Under the “Channel Playlists” section 1104, the administrator can see a dropdown to the left of the playlist bar. Here is where the administrator can select a playlist that the administrator would like to publish for this channel. Every channel is created with a playlist already added. The “Playlist Bar” will display information allowing the user to see if the playlist status is live or not. There is also a section for how many total templates are in the playlist and a total of all the templates display times.

Under the “Playlist Options” dropdown menu shown in FIG. 11J, you can publish the selected playlist, delete a selected playlist or add a new playlist.

Programs

FIG. 11K shows a user interface for managing programs of messages, which is a dropdown box for the screen in FIG. 11I. “Programs” are used for organizing templates within a playlist. In one embodiment a program may be implemented, stored, or represented as a folder on the computer where the administrator can store and separate files.

To add new programs, go to the “Playlist Options” dropdown menu shown in FIG. 11L accessed via the playlist bar and select “Add Program.” A dialog box will appear. Type in a name in the “New Program Name” field and then click “Add Program.”

Using the “Program Options” dropdown menu shown in FIG. 11M located in the programs option bar, the administrator can edit a selected program or delete a selected program. Selecting “Edit Program Info” will allow the administrator to rename the program.

Templates

FIG. 11N shows a user interface for managing templates. This is the section where the administrator views templates within the selected program. Each template thumbnail displays the template name, ID number, whether the template is enabled or disable and the order in which the template lies in the program. The “T” symbol at the bottom of each thumbnail states if the template has an updateable text message zone. If the template has a movie zone then it will display a TV icon.

Adding a Template

FIG. 11O shows a user interface for adding a template. To add a new template, the administrator navigates to the “Playlist Options” dropdown menu shown in FIG. 11O in the playlist bar and select “Add New Template.”

A dialog box shown in FIG. 11P will appear. On top of this dialog box is a “Template Source” dropdown menu. When “Blank Template” is selected, the administrator can type in a template name and template description and click “Add Template.” This will create a blank template area, where the administrator can then fill in all information within the template's edit properties after it has been added. By selecting “Template from Review” in the “Template Source” dropdown menu, the administrator can add a template from the review section of the system. When “Template from Uploads” is selected from the source menu, the administrator can add a template directly from the upload section of the system.

Delete a Template

The administrator can delete a template by clicking on the “Trash Can” icon 1106 located on/under the template thumbnail.

Template Editing

FIG. 11Q shows a user interface for editing a template(s). To start editing a template, the administrator clicks once on a template thumbnail. The administrator can enter the template's editing properties. In the template's properties, the administrator can see a bigger sized preview of the template. To the left of the preview the administrator can notice four tabs. The section on the bottom of the screen is where the administrator edit the properties of a template are listed below:

Template Layout Tab
Template Enabled: Will allow the administrator to enable or disable the template.
Template Name: Give the template a name.
Template URL: The URL that the template is loaded from.
Template Description: Give a description to the template.
Template Dynamic XML: If the template is prepared to receive xml data, here is where the administrator would input the URL for it.
Template Image: If the template is prepared to have image or .swf file inputted into here is where the administrator would input the URL information for that file.

Creating and Updating Messages

FIG. 11R shows a user interface for creating and/or updating messages. Under the message tab 1134 is where the administrator can create and update messages. Each template can for example be allowed up to 5 text areas. These areas can have multiple messages playing back in a playlist fashion. Each message created has its own display time and will rotate through all messages depending on how template is set up. Let's start off by clicking “Add New” in the upper left corner to add a new message. Once the administrator has done this, a red box or boxes should activate in the template. These red boxes are the template's text zones. The administrator can click within the red outlines of the text zone once, and the outline will then change to green. This is letting the administrator know that the zone is ready to be typed in. The administrator can create multiple messages for each text zone or zones, and they will playback in the order they were created. Each message will show an ID number, display time, date it was created & most importantly which user created it. The text box editor tool works similar to MS Word. The administrator can select from a list of fonts, change the size of the font, make text bold, italic and underline it. The administrator can also select how the administrator would like text to be justified. The black and white boxes on the bottom right corner allows the administrator to change the color of the text areas background, so that if administrator is using white text and click the black box the administrator is able to see it. The preview button next to the text box editor tool allows the administrator to preview the template full screen. The message display time allows the administrator to control how long each and every message will be displayed for. All messages when added have a default display time of 10 seconds. The administrator types in how long the administrator wants the message to display for in seconds.

Display Time Tab

FIG. 11S shows a user interface for managing a template's/message's display time. To edit a template's display time the administrator have 3 options to choose from. The first option the administrator can choose is to have the template display for a custom time. If the administrator select this option and the custom time is set shorter then the length of messages, the template will not play all or the full length of messages. The second option is to have the template play for the length of all messages. Once the administrator selects this option the administrator can notice that this feature will automatically add up the length of all messages and display the template for that length of time. The third and final selection is to set the template to play for the length of a movie. This option is calculated from what is set for the movie play time under the “Movie” tab, which is explained in the next section.

Movie Tab

FIG. 11T shows a user interface for managing movies within a message. The “Movie” tab will let the administrator adjust settings for a movie that will play in a template's movie zone. The “Movie Status” section allows the administrator to enable or disable the template's movie. “Playtime” is where the administrator would set the duration of the movie. It cab be important to make sure that the administrator knows the length of a movie before setting it to play in a template. The administrator can set how long to play the movie. Once the administrator has entered a “Playtime” the administrator can set the template to play for the length of a movie under the “Display Time” tab as explained in the previous section. The “Mpeg URL” section is where the administrator can type in a URL that links to the movie file.

DMP Movie URL

In one embodiment, a media player, such as the Cisco Digital Media Player (DMP) can enable playing a local .mpg file from the player's internal or external storage. For example, the administrator can use the command “file:///tmp/ftproot/usb_{—}1/movie_clip_folder/my_movie_file.mpg” for the Cisco DMP. Using usb_1 in this command line will point to the internal directory of a Cisco DMP. If the administrator replaces usb_1 with usb_2, this will point to an external device connected to a Cisco DMP.

Emergency Message

FIG. 11U shows a user interface for managing an emergency message. The “Emergency Message” in the system will allow for certain users to activate an emergency through all digital signage displays that are associated with that particular channel. The administrator can click on the “Emergency” tab located in the “Edit Channels” section. The status section is where the administrator turns the message on and off. The lower part of the screen works just like editing a template's message. First, the administrator clicks the red outline text zone located in the emergency message; the red outline will change from red to green; then the administrator types in a message.

Players

FIG. 11V shows a user interface for managing media players for displaying messages for a channel. In one embodiment, the system's channels send content to a media player by using “Channel Player URLs.” Each channel will have its own unique channel URL that is added to the media player or players, that will output its content. This is what separates all the displays from playing similar content. In order to have different content playing in different areas (lobby, cafeteria, etc.), the administrator can need to create multiple channels.

Adding a Channel Player URL

To add a “Channel Player URL,” simply click on “Add Channel Player.” A dialog box shown in FIG. 11W will appear giving the administrator a link and “Player Type” is set to “CISCO DMP.” Copy this link by clicking the “Copy URL” Button. Once the link is copied, paste the link into a Cisco DMP “Startup Browser URL.” To add a custom player, use the “Player Type” dropdown menu and select “Custom Player.” Then type in a player name and click “Add Player.” Once the player has been added to the list, click that player's “Edit” button. The administrator can click the “Copy URL” button and paste into the Cisco DMP Startup Browser URL. When the administrator select “CISCO DMP” as the player type, the administrator can not see the player in the players list until its associated with a Cisco DMP. Once the link is being used by a DMP, it will then show up in the “Channel Players List” in the system. The administrator can add a custom player. A custom player URL can work on all (or substantially all) types of players, browsers and all Cisco DMP players (4300, 4305 & 4400). The “CISCO DMP” option under “Player Types” will work with a Cisco DMP 4300 & 4305.

Edit a Player

To make changes to the player settings, click the “Edit” button which will bring up an “Edit Player Info” dialog box as shown in FIG. 11X. In here the administrator can change the player type from CISCO DMP to a Custom Player or vise versa. Also, if the administrator ever needs to recopy the URL, the administrator can do so by clicking on the “Copy URL” button to the right side of the box. The administrator can even rename the player by typing in a new name. Once the administrator has finished editing the player, click “Update Player.”

Remove a Player

To remove a player from the “Players List,” click the remove button. A dialog box as shown in FIG. 11Y will appear asking the administrator if the administrator is sure that he/she wants to remove the player. The administrator can click “Yes” to continue removing the player, or click “No” to cancel.

Reviewing Content

FIG. 11Z shows a user interface for managing content. The Review tab is a place for users to add content that needs to be reviewed. After users place content up for review, another user can log in and approve this content message before the content message published and made live.

Adding a Template for Review

FIG. 11AA shows a user interface for managing a template. On the upper right of the Review tab click “Add Template for Review.” The “Add Template for Review” will appear. The administrator can be presented with “Template Name.” The administrator can give the review template a name. The red outlined fields are fields that are required to be typed in. The “Template URL” field will allow the administrator to manually type in a URL for the template. Below that the administrator can click “Select Template from Uploads” and a dialog box will appear. This will allow the administrator to add a template from the upload section of the system. The upload section will be explained later on in this documentation. Once the administrator has the “Template URL” manually typed in or the template is selected from the upload section, the administrator can click the green “Preview Template” icon to preview the template. Underneath the preview, the administrator can give the review template a description. On the bottom of the “Add a Template for Review” screen, there is a section called “Template Options.” These options are similar to the options in adding a template to the system. Below is a list for these options:
Template Dynamic XML: If the template is prepared to receive xml data, here is where the administrator would input the URL for it.
Template Image: If the template is prepared to have image or swf file inputted into here, this is where the administrator would input the URL information for that file.
Enable Movie: This allows the administrator to type in a movie URL or a Cisco DMP command line that will play a file local to the player(s).
Movie Duration: Allows for the administrator to type in a length of the duration the administrator wants the movie to player for. Once the administrator have finished filling in the fields for the template that needs to be reviewed, click the “Add” button.

Reviewing a Template

FIG. 11AB shows a user interface for managing a template(s). Once someone has created a template for review, a user (administrator) that has rights to access the review section can review the template. The administrator can click the Review button on a template that needs to be reviewed. The administrator can enter the Review section for that template. On the left is a preview of the template. On the lower left of the preview is an icon that can be clicked to view a larger preview. Previews in the system can be clicked for a larger preview. The “Approve, Revise & Reject” section is where the administrator can submit the approval on the template. The administrator can also leave a message before pressing submit to leave a brief comment on why the template was approved, rejected or what needs to be revised. On the bottom right of the screen, the administrator can leave comments for users to view by typing a message and click “Add Comment.” On the left of the comment box is were a user can view or delete comments by clicking the trash can located on the right side of the comment line. On the top of the screen, there are four buttons. The first button on the left is the “Review Template” button; this will take the administrator back to the review section of a template. The “Delete This Template” button will delete the template from the “Templates for Review” section. “Edit This Template” will allow the administrator to go into the templates properties just as if the administrator were editing a template under the “Playlist” tab. The “Back to Templates for Review” button will take the administrator back to the “Template for Review” section. The statistic box on the upper right will show the administrator information for the templates display, message and movie duration.

Uploads

FIG. 11AC shows a user interface for uploading template files. The “Upload Section” is where the administrator can upload template files & images. The administrator can also use this section to upload any file type for a place to store and move files between the administrator and the digital signage team to better help workflow and prevent clogging up e-mail boxes.

To add a file, the administrator selects the tab (Templates, Image, Documents or Movies) the administrator would like to upload the file to. Then the administrator clicks “Add New File.” A new screen will appear as shown in FIG. 11AD, where the administrator can click the Browse button and use the File Requester window to select the file. Then the administrator can click the submit button and the file will be uploaded.

Adding Users & Admins to Channels

FIG. 11AE shows a user interface for granting users or administrators access to channels. Under the “Users” and “Admins” tabs is where the administrator can add Users and Admins to a channel. The administrator can also edit what privileges of the system a User can have. The administrator may want a User only to be able to control “Emergency Messages” or only be able to upload content. Under the “Users” tab check off what privileges the administrator want or don't want a User to have. The administrator can click the “Remove Access” to remove the user for the channel. In one embodiment, “Remove Access” will eliminate the user from using or viewing the specific channel.

Adding a User to a Channel

To add a User click “Add User.” The “Select User to Add to Channel” dialog box as shown in FIG. 11AF will appear. On the left, the administrator can select what User the administrator would like to add. Accounts that were setup as a “User” will only show in the box. Admins or Super Admins will not show in this box. On the right side of the box, the administrator can also select what privileges a User will have.

Adding an Admin to a Channel

To add an Admin to a channel, navigate to the Admin tab. The administrator can click “Add Admin” and the “Select Admin to Add to Channel” dialog box as shown in FIG. 11AG will appear. Admins that were setup, as Admins in “User Accounts” will be seen in this box. The administrator can select an Admin User and press “Add Admin” to add the administrator.

FIGS. 12A-12L show an example of a process for a user to manage a digital signage system. The process of FIGS. 12A-12L may be limited to users of a particular user type, such as a sub administrators, sales administrators, Project Mgt/Design/Developers, etc.

User Login

FIG. 12A shows a login screen for a user. A browser such as either Microsoft's Internet Explorer or Mozilla Firefox, or the like may provide the login screen. The user can navigate to the address where the system is located using, for example, a web browser. At this page the user can type in the username/password and can click login.

User Home

Once the user has logged in, the user is brought to the admin homepage as shown in FIG. 12B. The admin homepage gives the user an overview of the Digital Signage in the system. On the upper left of the page is an info box explaining the account information (Logged in as, Last Login, etc.). Under the “View Channel” bar, is a display showing the user the selected channel in the “Current Channel Listing” section below. On the right of the display is a box listing the channel name that is being showed on the display. It also lists the channel description that is given to a channel when it's created. By clicking edit channel in this box, it will bring the user into the selected channel to edit its Properties.

Edit and Select Channels

FIG. 12C shows a screen for editing and selecting a channel. The “Select Channel” section appears on the upper left hand of the screen. Once the user has created a channel under the “Manage Channels” menu item, the channel will appear in this box. Here is where the user can select a channel that the user wants to edit. In some cases there will be a need for one channel, and in others, there is a need for multiple channels. For example, the user may want to have one set of content being displayed to all the media players and displays, where one channel is needed. In other cases if the user wants different content to be displayed on different media players and displays, the user can create multiple channels.

Templates

FIG. 12D shows a user interface for managing a template(s). This is the section where the user views the templates within the selected channel. Each template displays an ID number & name. The “T” symbol in the editable sections states that the template has an updateable text message zone. If the template has a movie zone then it will display a TV icon. The clock lets the user know that there has been a display time set.

Template Editing

FIG. 12E shows a user interface for editing templates. To start editing a template, the user clicks the edit button for that template. The user can enter the template's editing properties. Now that the user is in the template's properties section, the user can see a bigger sized preview of the template. To the left of the preview appears three tabs. The section on the bottom of the screen is where the user edits the properties of a template as described above (see Template Layout Tab above).

Creating and Updating Messages

Under the message tab is where the user can create and update messages. Each template is allowed up to 5 text areas (or more). These areas can have multiple messages playing back in a playlist fashion. Each message created has its own display time and will rotate through all messages depending on how the template is set up. The user can click “Add New” in the upper left corner to add a new message. Once the user has done this, a red box or boxes should activate in the template. These red boxes are the template's text zones. The user can click within the red outlines of the text zone once, and the outline will then change to green. This is letting the user know that the zone is ready to be typed in. The user can have multiple messages for each text zone or zones, and they will playback in the order they were created. Each message will show an ID number, display time, date it was created & most importantly which user created it. The text box editor tool works similar to MS Word. The user can select from a list of fonts, change the size of the font, make the text bold, italic and underline it. The user can also select how the user would like the text to be justified. The black and white boxes on the bottom right corner allow the user to change the color of the text areas background. The preview button next to the text box editor tool allows the user to preview a template in full screen mode. The save button saves the messages. The message display time allows the user to control how long each and every message will be displayed for. All messages when added can have a default display time of 10 seconds (or more). The user can type in how long the user wants the message to display for in seconds.

Display Time Tab

FIG. 12F shows a user interface for managing a template's time. To edit a template's display time the user have 3 options to choose from. The first option the user can choose is to have the template display for a custom time. If the user selects this option and the custom time is set shorter then the length of all the messages, the template will not play all or the full length of the messages. The second option is to have the template play for the length of all the messages. Once the user selects this option, this feature will automatically add up the length of all the messages and display the template for that length of time. The third and final selection is to set the template to play for the length of a movie. This option is calculated from what is set for the movie playtime under the “Movie” tab, which is explained in the next section.

Movie Tab

FIG. 12G shows a user interface for managing movies within a message. The “Movie” tab will let the user adjust settings for a movie that will play in a template's movie zone. The “Movie Status” section allows the user to enable or disable the template's movie. “Playtime” is where the user would set the duration of the movie. It is very important to make sure that the user knows the length of a movie before setting it to play in a template. The user can enter how long to play the movie. Once the user has entered a “Playtime,” the user can set the template to play for the length of a movie under the “Display Time” tab as explained in the previous section. The “Mpeg URL” section is where the user can type in a URL that links to the movie file.

Emergency Message

FIG. 12H shows a user interface for managing an emergency message. The “Emergency Message” in the system will allow for certain users to activate an emergency through all digital signage displays that are associated with that particular channel. The user can click on the “Emergency” tab located in the “Edit Channels” section. The status section is where the user turns the message on and off. The lower part of the screen works just like editing a template's message. First the user clicks the red outline text zone located in the emergency message; the red outline will change from red to green; then the user types in a message.

Reviewing Content

FIG. 121 shows a user interface for managing content. The Review tab is a place for users to add content that needs to be reviewed. After users place content up for review, another user can log in and approve this content message before the content message published and made live.

Reviewing a Template

FIG. 12J shows a user interface for managing a template. Once someone has created a template for review, a user (administrator) that has rights to access the review section can review the template. The user can click the review button on a template that needs to be reviewed. The user can enter the review section for that template. On the left is a preview of the template. On the lower left of the preview is an icon that can be clicked to view a larger preview. Previews in the system can be clicked for a larger preview. The “Approve, Revise & Reject” section is where the user can submit the approval on the template. The user can also leave a message before pressing submit to leave a brief comment on why the template was approved, rejected or what needs to be revised. On the bottom right of the screen, the user can leave comments for users to view by typing a message and click “Add Comment.” On the left of the comment box is were a user can view or delete comments by clicking the trash can located on the right side of the comment line. On the top of the screen the user have three buttons. The first button on the left is the “Review Template” button; this will take the user back to the review section of a template. “Edit This Template” will allow the user to go into the templates properties just as if the user were editing a template under the “Playlist” tab. The “Back to Templates for Review” button will take the user back to the “Template for Review” section. The statistic box on the upper right will show the user information for the templates display, message and movie duration.

Uploads

FIG. 12K shows a user interface for uploading template files. The “Upload Section” is where the user can upload template files & images. The user can also use this section to upload any file type for a place to store and move files between the user and the digital signage team to better help workflow and prevent clogging up e-mail boxes.

FIG. 12L shows a user interface for uploading a template. To add a file, the user selects the tab (Templates, Image, Documents or Movies) the user would like to upload the file to. Then the user clicks “Add New File.” A new screen as shown in FIG. 12L will appear, where the user can click the Browse button and use the File Requester window to select the file. Then the user can click the submit button and the file will be uploaded.

Unless otherwise provided, use of the articles “a” or “an” herein to modify a noun can be understood to include one or more than one of the modified noun.

Features of the illustrative systems, methods, and configurations described herein can combine to provide advantages in the workflow and over known systems. For example, as illustrated herein, a system or method can include an integrated system or software that includes a design interface permitting a channel owner to interact with templates directly or to interact via a design environment to communicate and view signage (e.g., comment on current state of design), to add signage and channel with easy plug and play implementation (e.g., the signage system can be implemented using server software that operates with free software clients and/or easily integrates with different players), includes generic templates (e.g., a base set of templates that are available to all customers to generate their own signage), a hierarchical approach to the signage content, and integrates permissioning to allow distributed control and generation of signage. Such aspects can, for example, simplify highly complex and arduous workflow processes and provides ease of integration into established businesses with little or no information technology support.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims. Accordingly, the systems and methods described herein are not to be limited to the embodiments described herein, can include practices other than those described, and are to be interpreted as broadly as allowed under prevailing law.

What is claimed is:

1. A system for managing a plurality of digital signage over a network comprising:
a computer component configured to group a plurality of digital signage types into at least one of a plurality of digital signage channels;
a computer component configured to generate at least one template for at least one of the digital signage channels, wherein the template comprises a dynamic portion that is editable by the user based on a permission for the user, wherein the permission comprises a portion-level, template-level, playlist-level, channel-level, or customer-level permission;
a computer component configured to create over the network a new digital signage message for a portion of at least a selected one of the templates, wherein the templates provide a separation between a view and a model of the new digital sign, and wherein the view is configured to be in a plurality of rendering formats;
a computer component configured to approve over the network the new digital signage message based on a limited representational view of the new digital signage message; and
a computer component configured to selectively provide, over a network channel, a first renderable instance of the approved new digital signage in a first rendering format to a first digital signage device configured to display the first rendering format, and a second renderable instance in a second rendering format to a second digital signage device configured to display the second rendering format.

2. The system of claim 1, further comprising:
a computer component for overriding a display of a plurality of digital signage messages associated with a different template than the selected one of the templates with the new digital signage message, wherein the new digital signage message comprises an emergency message, and wherein creating the emergency message disables an approval requirement for the emergency message.

3. The system of claim 1, wherein the component for creating is further configured to define the portion of the selected template to deliver a graphical representation of a data stream comprising at least one of a database table, a news feed, or a weather forecast.

4. The system of claim 1, further comprising:
a computer component for providing a statistic of a proof of play of messages over the digital signage channels;
a computer component for receiving a second limited representational view of a playing signage on the digital signage devices; and
a computer component for determining an advertising cost for displaying an advertising message as the new digital signage message based on the proof of play and the second limited representational view.

5. The system of claim 1, wherein the computer component for creating is further
configured to restrict access of a sub-administrator to the channel; and
wherein the computer component for approving is further configured to limit access to the approval interface to a main administrator.

6. A computer implemented method for managing a plurality of digital signage over a network comprising:
receiving a template for a digital signage channel, wherein the template is one of a plurality of digital signage types, wherein the network comprises at least one network channel associated with the digital signage channel;
providing, over the network, a creation interface configured to create a new digital signage message based on the template, wherein the new digital signage message provides a definition for a display of a view of the new digital sign, and wherein the definition is adapted to map elements of the view to a plurality of data structure types for storing the new digital signage message, wherein the message comprises at least one of text content, movie content, or data stream content;
providing, over the network, an approval interface configured to approve the new digital signage message based on a limited representational view of the new digital signage message; and
selectively providing, over the network channel, a renderable instance of the approved new digital signage message for display on a interactivity limited digital signage device, wherein the renderable instance is based on applying the definition to the new digital signage message.

7. The method of claim 6, further comprising:
receiving a play time for the new digital message, wherein the play time determines a slot position in a playlist for the new digital message or a duration of playing the new digital message.

8. The method of claim 6, wherein the template is configured to provide a model-view-control for a message of at least one of the plurality of digital signage types.

9. The method of claim 6, wherein the creation interface comprises at least one of a web interface or an application programming interface, and wherein the approval interface comprises at least one of a web interface or an application programming interface.

10. The method of claim 6, further comprising:
granting access of a sub-administrator to create a message using the creation interface to the channel; and
granting access to the approval interface to the main administrator.

11. The method of claim 10, wherein the sub-administrator is further granted to access to managing messages for at least one of a customer, a template, or a message.

12. The method of claim 6, further comprising:
grouping the plurality of digital signage types into the digital signage channel based on a similarity in an attribute of at least one of the grouped digital signage types, wherein the similarity in the attribute comprises a similarity in at least one of:
a content type of the grouped digital signage types,
an importance of the grouped digital signage types,
a designated geographical location of the grouped digital signage types, or
a company type of the grouped digital signage types.

13. The method of claim 6, wherein the limited representational view of the new digital signage message comprises a thumbnail of the new digital signage message.

14. The method of claim 6, further comprising:
scheduling the display of the approved instance of the new digital signage based on a playlist that specifies the order or length of time of a displayed message.

15. The method of claim 6, wherein the approval interface is configured to perform actions comprising:
providing a plurality of new digital signage messages for the channel, wherein the plurality of new digital signage messages are created by a plurality of sub-administrators; and
receiving an approval for a subset of the plurality of the new digital signage messages.

16. An apparatus for managing a plurality of digital signage comprising a processor configured to perform actions comprising:
determining a template for the digital signage channel comprising a plurality of digital signage types;
creating a new digital signage message based on the template, wherein the new digital signage message provides a definition for a display of a view of the new digital sign, and wherein the definition is independent of a data structure and type of the new digital signage message; and
if the new digital signage message is approved, displaying, over a network channel associated with the digital signage channel, the new digital signage based on the definition.

17. The apparatus of claim 16, wherein the actions further comprises:
providing the new digital signage on a plurality of digital signage client devices.

18. The apparatus of claim 16, wherein the data structure and type comprises at least one of:
a markup language structure and type,
a portable document format (PDF) structure and type, or
a structure and type configured for a text-editing program.

19. The apparatus of claim 16, wherein the network channel comprises at least two of a network protocol, network address, domain name, browser type, operating system type, virtual subnet type, or security protocol.

20. A computer-readable media comprising instructions that are executable by a processor to perform the steps of claim 1.

21. A method for managing content in a digital signage system composed of a plurality of digital signage comprising:
grouping one or more digital signage types into a channel;
creating a plurality of templates for the channel, where each template represents a specific type of digital signage message;
designating a plurality of sub-administrators for the channel;
designating a main administrator for the channel;
allowing the sub-administrators to create a plurality of new digital signage messages by using the templates;
generating an update message for each new digital signage message created and sending said update message to the main administrator;
instructing the main administrator to approve or reject the new digital messages; and
displaying each approved new digital message on the digital signage in the channel.

22. The method of claim 21, wherein the template comprises a read-only portion that is uneditable by at least one of the sub-administrators and a dynamic portion that is editable by the at least one of the sub-administrators based on a permission for the at least one of the sub-administrators.

23. The method of claim 22, wherein the permission comprises a portion-level, template-level, playlist-level, channel-level, or customer-level permission.

24. A digital signage system comprising:
a network connected computer configured to:
present a graphical user interface configured to present options to users that allow users from different companies to take actions to edit or create a digital signage of their respective companies; and
generate digital signage comprising at least a two level structure, where one level forms the basis for another structure, and wherein the graphical user interface includes options for selecting at each level, the actions that an individual user is permitted to take.

25. The method of claim 24, wherein the digital signage is based on a template.

26. The method of claim 25, wherein the template comprises at least a syndicated Insert portion editable by a user having permission at a national level, and uneditable by another user having permission at a regional level.

27. The system of claim 1 wherein the template includes a read-only portion that is uneditable by a user.
